(19) United States
(12) Patent Application Publication
(10) Pub. No.: US 2025/0350533 A1
(43) Pub. Date: Nov. 13, 2025

(54) INFORMATION PROCESSING METHOD AND INFORMATION PROCESSING DEVICE

(71) Applicant: SONY GROUP CORPORATION, TOKYO (JP)

(72) Inventors: RYOTA KIMURA, TOKYO (JP); HIROAKI TAKANO, TOKYO (JP); HIROFUMI KASAI, TOKYO (JP); FUMIO TERAOKA, KANAGAWA (JP)

(21) Appl. No.: 18/868,770

(22) PCT Filed: May 10, 2023
(86) PCT No.: PCT/JP2023/017498

§ 371 Date: Nov. 24, 2024

(30) Foreign Application Priority Data
May 31, 2022 (JP) 2022-088749

(51) Int. Cl. H04L 41/0895; H04W 4/70

(52) U.S. Cl. CPC H04L 41/0895; H04W 4/70

(57) ABSTRACT

An information processing method of the present disclosure is a method in which an information processing device executes an M2M application for performing M2M communication with a physical node. The information processing method includes communicating with at least one of a virtual node and a virtual point by the information processing device. The virtual node is a node in which at least one of a function of the physical node that is a communication partner of M2M communication and a function of reinforcing the physical node is implemented as a software module. The virtual point is a point in which a function of a physical sink that performs wireless communication with the physical node, a function of reinforcing the physical sink, and an installation place of the physical sink are implemented as software modules.

### FIELD

The present disclosure relates to an information processing method and an information processing device.

### BACKGROUND

In recent years, research and development concerning M2M (Machine To Machine) communication have been actively conducted. In the M2M communication, since various devices such as sensor devices are connected to a network and perform communication, implementation of efficient wireless communication is an important technical theme.

As a technology for further improving the efficiency of wireless communication, for example, a technology of arranging network functions such as a P-GW, an S-GW, and an MME in LTE as software modules in an MEC (Mobile Edge Computing, Multi-access Edge Computing) server is known. In this technology, efficient wireless communication is implemented by performing communication between an MEC server having a network function and a terminal.

### CITATION LIST

### Patent Literature

Patent Literature 1: WO 2017/43204 A

### SUMMARY

### Technical Problem

As explained above, when the various devices are connected to the network, security measures for the devices are important issues. In particular, a device that performs M2M communication tends to have high functionality. With the high functionality of the device, the possibility of being attacked by unauthorized access and the like increases.

Therefore, the present disclosure provides a mechanism that can implement more secure communication in the M2M communication.

Note that the problem or the object explained above are merely one of a plurality of problems or objects that can be solved or achieved by a plurality of embodiments disclosed in the present specification.

### Solution to Problem

An information processing method of the present disclosure is a method in which an information processing device executes an M2M application for performing M2M communication with a physical node. The information processing method includes communicating with at least one of a virtual node and a virtual point by the information processing device. The virtual node is a node in which at least one of a function of the physical node that is a communication partner of M2M communication and a function of reinforcing the physical node is implemented as a software module. The virtual point is a point in which a function of a physical sink that performs wireless communication with the physical node, a function of reinforcing the physical sink, and an installation place of the physical sink are implemented as software modules.

### BRIEF DESCRIPTION OF DRAWINGS

FIG. 1 is a diagram illustrating an example of an M2M system according to an embodiment of the present disclosure.

FIG. 2 is a diagram for explaining an example of processing by an M2M application according to the embodiment of the present disclosure.

FIG. 3 is a flowchart illustrating an example of a data resolution procedure by the M2M application according to the embodiment of the present disclosure.

FIG. 4 is a flowchart illustrating another example of the data resolution procedure by the M2M application according to the embodiment of the present disclosure.

FIG. 5 is a diagram illustrating an example of a configuration of the M2M system according to the embodiment of the present disclosure.

FIG. 6 is a block diagram illustrating an example of a configuration of an information processing device according to the embodiment of the present disclosure.

FIG. 7 is a block diagram illustrating an example of a configuration of a communication device according to the embodiment of the present disclosure.

FIG. 8 is a block diagram illustrating an example of a configuration of a wireless communication device according to the embodiment of the present disclosure.

FIG. 9 is a diagram for explaining an example of node-designated type sensor data resolution in which a fixed node is designated according to the embodiment of the present disclosure.

FIG. 10 is a diagram for explaining an example of node-designated type sensor data resolution in which a mobile node is designated according to the embodiment of the present disclosure.

FIG. 11 is a diagram for explaining an example of point-designated type sensor data resolution according to the embodiment of the present disclosure.

FIG. 12 is a diagram illustrating a relation among classes in the M2M system according to the embodiment of the present disclosure.

FIG. 13 is a diagram illustrating a relation among instances in the M2M system according to the embodiment of the present disclosure.

FIG. 14 is a diagram illustrating an example of an architecture of the M2M system according to the embodiment of the present disclosure.

FIG. 15 is a sequence chart illustrating an example of a fixed node installation procedure according to the embodiment of the present disclosure.

FIG. 16 is a sequence chart illustrating an example of a mobile node connection procedure according to the embodiment of the present disclosure.

FIG. 17 is a sequence chart illustrating an example of a mobile node disconnection procedure according to the embodiment of the present disclosure.

FIG. 18 is a sequence chart illustrating another example of the mobile node disconnection procedure according to the embodiment of the present disclosure.

FIG. 19 is a sequence chart illustrating an example of a data registration procedure for registering sensor data from the fixed node according to the embodiment of the present disclosure.

FIG. 20 is a sequence chart illustrating an example of a data registration procedure for registering sensor data from the mobile node according to the embodiment of the present disclosure.

FIG. 21 is a sequence chart illustrating an example of a Global Graph DB update procedure according to the embodiment of the present disclosure.

FIG. 22 is a sequence chart illustrating an example of a Global Sensing DB update procedure according to the embodiment of the present disclosure.

FIG. 23 is a sequence chart illustrating an example of an M2M application start procedure for according to the embodiment of the present disclosure.

FIG. 24 is a sequence chart illustrating another example of the M2M application start procedure according to the embodiment of the present disclosure.

FIG. 25 is a sequence chart illustrating an example of a point resolution procedure according to the embodiment of the present disclosure.

FIG. 26 is a sequence chart illustrating an example of a node resolution procedure according to the embodiment of the present disclosure.

FIG. 27 is a sequence chart illustrating an example of a node-designated type past data resolution procedure according to the embodiment of the present disclosure.

FIG. 28 is a sequence chart illustrating another example of the node-designated type past data resolution procedure according to the embodiment of the present disclosure.

FIG. 29 is a sequence chart illustrating an example of a node-designated type current data resolution procedure according to the embodiment of the present disclosure.

FIG. 30 is a sequence chart illustrating another example of the node-designated type current data resolution procedure according to the embodiment of the present disclosure.

FIG. 31 is a sequence chart illustrating an example of a node-designated type condition satisfaction data resolution procedure according to the embodiment of the present disclosure.

FIG. 32 is a sequence chart illustrating another example of the node-designated type condition satisfaction data resolution procedure according to the embodiment of the present disclosure.

FIG. 33 is a sequence chart illustrating an example of a point-designated type past data resolution procedure according to the embodiment of the present disclosure.

FIG. 34 is a sequence chart illustrating an example of a point-designated type current data resolution procedure according to the embodiment of the present disclosure.

FIG. 35 is a sequence chart illustrating an example of a point-designated type condition satisfaction data resolution procedure according to the embodiment of the present disclosure.

FIG. 36 is a sequence chart illustrating an example of an operation instruction procedure according to the embodiment of the present disclosure.

FIG. 37 is a sequence chart illustrating another example of the operation instruction procedure according to the embodiment of the present disclosure.

### DESCRIPTION OF EMBODIMENTS

An embodiment of the present disclosure is explained in detail below with reference to the accompanying drawings. Note that, in the present specification and the drawings, components having substantially the same functional configurations are denoted by the same reference numerals and signs, whereby redundant explanation of the components is omitted.

In the present specification and the drawings, similar components in the embodiment are sometimes distinguished by adding different alphabets or numbers after the same reference numerals. However, when it is not particularly necessary to distinguish each of similar constituent elements, only the same reference number is added.

In the present specification and the drawings, specific values are sometimes indicated for explanation. However, the values are examples, and other values may be applied.

One or a plurality of embodiments (including examples and modifications) explained below can be respectively independently implemented. On the other hand, at least a part of the plurality of embodiments explained below may be implemented in combination with at least a part of other embodiments as appropriate. These plurality of embodiments can include new characteristics different from one another. Therefore, these plurality of embodiments can contribute to solving objects or problems different from one another and can achieve effects different from one another.

### 1. Introduction

The M2M application is an application that communicates with a terminal device such as a sensor or an actuator without human intervention to execute processing. Examples of the M2M application include crop growth management in agriculture (cooperation between a temperature and humidity sensor and a temperature adjustment device or a watering device), building environment management (cooperation between a human sensor or a temperature and humidity sensor and a lighting device or an air conditioner), and car automatic driving.

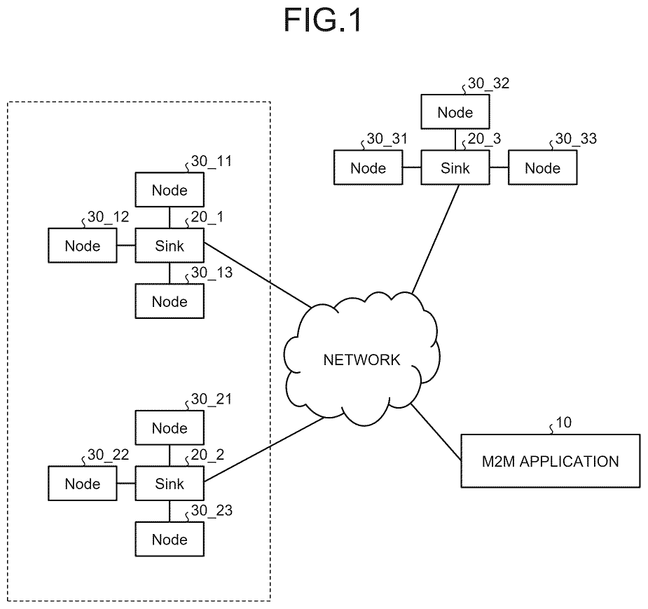

FIG. 1 is a diagram illustrating an example of an M2M system according to the embodiment of the present disclosure. In the present embodiment, terminal devices that perform M2M communication such as sensors and actuators are collectively referred to as node 30. The node 30 can be connected to a network such as a core network of a mobile phone or the Internet by wireless communication. Alternatively, the node 30 can be directly connected to the network by wire. When the node 30 is connected to the network by the wireless communication, equipment (for example, a base station or an access point) serving as a gateway between the wireless communication and the wired network is referred to as sink 20.

Note that FIG. 1 illustrates a case in which there are three sinks 20 connected to the network. However, the number of sinks 20 connected to the network is not limited to three. The number of sinks 20 connected to the network may be two or less or four or more.

FIG. 1 illustrates a case in which there are three nodes 30 connected to the sink 20. However, the number of nodes 30 connected to the sink 20 is not limited to three. The number of nodes 30 connected to the sink 20 may be two or less or four or more. The number of nodes 30 connected to the sink 20 may be different for each sink 20.

In general, an M2M application 10 repeats processing of acquiring sensor data from the node 30 via the network and instructing, based on the content of the sensor data, the node 30 to perform an operation.

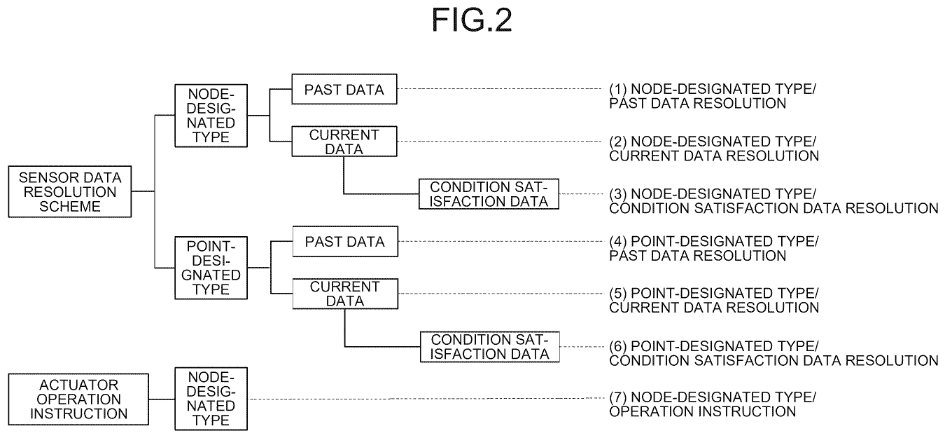

FIG. 2 is a diagram for explaining an example of processing by the M2M application 10 according to the embodiment of the present disclosure. As explained above, two types of the processing performed by the M2M application 10 include the acquisition of sensor data from the node 30 and the operation instruction to the node 30.

As illustrated in FIG. 2, the operation instruction from the M2M application 10 to the node 30 is considered to be sufficient if the node 30 can be designated by an identifier or the like to instruct the operation (a node-designated type).

On the other hand, as a scheme by which the M2M application 10 acquires sensor data from the node 30 (hereinafter also described as data acquisition scheme), two types of schemes are roughly conceivable. For example, as the data acquisition scheme, a method (a node-designated type) in which the M2M application 10 designates the node 30 with an identifier or the like to acquire sensor data is considered. As another data acquisition scheme, a method (a point-designated type) in which the M2M application 10 designates a geographical point and acquires sensor data of the node 30 present near the point is considered. It is considered sufficient if these two types can be implemented as the data acquisition scheme.

When acquiring the sensor data, the M2M application 10 designates a type of sensor data, for example, temperature data. As the sensor data two types of sensor data measured in the past (past data) and currently measured sensor data (current data).

Further, in the case of the current data, it is convenient if the sensor data can be acquired when the sensor data satisfies a condition designated by the M2M application 10 (condition satisfaction data). An operation of the M2M application 10 acquiring sensor data is referred to as data resolution.

To summarize the above, it is considered sufficient if seven types illustrated in FIG. 2 are implemented as the operation instruction and a data resolution scheme for to the node 30.

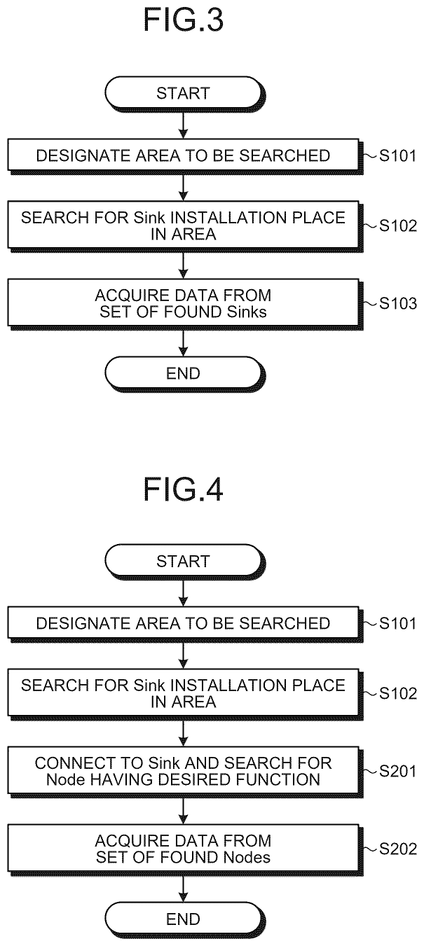

FIG. 3 is a flowchart illustrating an example of a data resolution procedure by the M2M application 10 according to the embodiment of the present disclosure. FIG. 3 illustrates a point-designated type data resolution procedure.

As illustrated in FIG. 3, first, the M2M application 10 designates a geographical area to be searched (step S101). For example, the M2M application 10 designates an area surrounded by a dotted line in FIG. 1.

As illustrated in FIG. 3, subsequently, the M2M application 10 searches through a sink installation place in the designated area (step S102). As a result, the M2M application 10 instructs a set of found sinks 20 (sinks 20_1 and 20_2 in the example illustrated in FIG. 1) to acquire data (step S103).

As explained above, the M2M application 10 can designate a point (an area) and acquire sensor data.

Note that functions of steps S101 and S102 explained above, that is, a function of designating an area and searching for a set of points where the sinks 20 are installed is referred to as point resolution.

FIG. 4 is a flowchart illustrating another example of the data resolution procedure by the M2M application 10 according to the embodiment of the present disclosure. FIG. 4 illustrates a node-designated type data resolution procedure. The same procedures as those in FIG. 3 are denoted by the same reference numerals and explanation thereof is omitted.

The M2M application 10 is connected to (a set of) sinks 20 found as a result of step S102 and searches for the node 30 having a desired function (for example, a temperature measurement function) (step S201).

The M2M application 10 acquires data from the set of nodes 30 found as a result of the search (step S202). For example, the M2M application 10 instructs nodes 30_22 and 30_23 connected to the sink 20_2 illustrated in FIG. 1 to acquire data.

As explained above, the M2M application 10 can designate the node 30 and obtain sensor data.

Note that a function of step S201 explained above, that is, a function of designating a set of sinks 20 and functions that the node 30 can have and searching for a set of nodes 30 is referred to as node resolution.

The nodes 30 can be roughly classified into two types of a fixed node and a mobile node. The fixed node is a node 30 physically fixed and installed like a monitoring camera serving as a sensor or lighting equipment serving as an actuator. The mobile node is the node 30 that has functions of a sensor and an actuator and physically moves like an automobile or a smartphone.

Therefore, a position management method for efficiently implementing point resolution and node resolution for both of the fixed node and the mobile node is desired. Further, a data management method for efficiently implementing the seven types of data resolution and operation instructions explained above (see FIG. 2) for both of the fixed node and the mobile node is desired.

### 2. Overview

There are four major problems to be solved in order to implement the M2M system explained above.

### <2.1. First Problem>

A first problem is a communication delay between the M2M application 10 and the node 30 (the sensor or the actuator) and an increase in a communication amount of the network. The M2M system of the related art has a configuration in which the node 30 is connected to the network and communicates with a cloud server installed in a data center. In such a configuration, a communication delay between the node and the cloud server increases. In addition, when many M2M applications 10 communicate with many nodes 30, a traffic volume of the network increases.

In order to solve this problem, the M2M system according to the present embodiment uses an MEC server group that are geographically distributed and disposed. The M2M system selects an MEC server or a cloud server and disposes the M2M application 10 considering a communication delay with the node 30 communicating with the M2M application 10 and a calculation load of the M2M application 10. For example, the M2M system selects an optimum MEC server or cloud server with a MANO (Management ANd Orchestration) function and disposes the M2M application 10.

### <2.2. Second Problem>

A second challenge is node security. The node 30 serving as the sensor or the actuator tends to have high functionality. That is, the calculation capability of the node 30 is improved and an advanced program can be executed or a program can be dynamically updated. Such high functionality of the node 30 is inseparably associated with an increase in an attack surface (a portion to be attacked) concerning security.

In order to solve this problem, the M2M system of the present embodiment narrows down the functions of the node 30 to a necessary minimum and eliminates vulnerability to security of the node 30 itself as much as possible. For example, in the M2M system, dynamic program update is not allowed. The M2M system according to the present embodiment virtualizes a physical node 30 as software instead of narrowing down hardware functions to a necessary minimum and executes the software on an MEC server or a cloud server.

In the following explanation, the physical node 30 is referred to as physical node (PNode) 30P. A software module obtained by virtualizing the PNode 30P is referred to as virtual node (VNode) 30V. The virtual node 30V implements, as software modules, for example, a function of the physical node 30P and a function of reinforcing the physical node 30P.

The latest security technology is applied to the VNode 30V. Accordingly, the Vnode 30V prevents unauthorized access and the like. Since the security technology advances every day, it is assumed that the VNode 30V performs maintenance such as software update. By virtualizing the PNode 30P, the M2M system can more easily perform maintenance of the node 30. The M2M application 10 can implement more secure communication with the node 30.

Here, the M2M system can reduce the number of VNodes 30V, which are maintenance targets, by, for example, reducing the number of VNodes 30V with respect to the number of PNodes 30P by associating the PNodes 30P and the VNodes 30V in a many to one relation. For example, even if a large number of PNodes 30P, which serve as one product, are installed, one VNode 30V corresponding to the PNodes 30P only has to be implemented.

### <2.3. Third Problem>

A third problem is diversity of specifications and capabilities of the node 30. There are various nodes 30 and specifications and capabilities thereof are also various. Therefore, in designing the M2M application 10, it is necessary to consider characteristics of the nodes 30 and design is complicated.

In order to solve this problem, the M2M system according to the present embodiment causes the M2M application 10 to operate in a virtual space in which a software module having unified specifications operates.

The M2M application of the related art operates in in a physical space targeting a physical node (the PNode 30P). On the other hand, the M2M application 10 in the present embodiment operates in a virtual space targeting the VNode 30V virtualized as a software module.

Therefore, as explained above, in addition to virtualizing the PNode 30P as the VNode 30V, a point where a physical sink (PSink) 20P is installed is virtualized by a software module called virtual point (VPoint) 20V. The virtual point 20V is obtained by implementing, as software modules, for example, a function of the physical sink 20P (hereinafter also described as physical sink 20P), a function of reinforcing the physical sink 20P, and an installation place of the physical sink 20P.

In the physical space, the PNode 30P is connected to the PSink 20P. The PNode 30P transmits sensor data to the M2M application 10 and receives an operation instruction from the M2M application 10 via the PSink 20P.

In the virtual space, the VNode 30V is connected to VSink 20V. The VNode 30V transmits sensor data to the M2M application 10 and receives an operation instruction from the M2M application 10 via the VPoint 20V.

That is, the M2M application 10 communicates with at least one of the VNode 30P and the VPoint 20V to perform M2M communication with the PNode 30P. Note that, as explained below, the M2M application 10 can be executed by an information processing device (not illustrated).

Here, by virtualizing the PSink 20P, the M2M application 10 can implement secure communication like the VNode 30V. As explained above, the M2M system can implement more secure M2M communication by virtualizing at least one of the node 30 and the sink 20.

For example, the M2M system may associate the PSink 20P and the VPoint 20V in a many to one relation. As explained above, the M2M system can reduce the number of VPoints 20V, which is the maintenance target, by reducing the number of VPoints 20V with respect to the number of PSinks 20P. For example, even if a large number of PSinks 20P, which serves as one product, are installed, one VPoint 20V corresponding to the PSinks 20P only has to be implemented.

The M2M system can virtualize the PSink 20P and the PNode 30P connected thereto together as the VPoint 20V. Accordingly, the VPoint 20V can be regarded as a virtual point for transmitting sensor data or instructing an operation to the actuator.

Further, by enhancing the function of the VNode 30V or by combining a plurality of types of PNodes 30P to define one VNode 30V, the node 30 that is physically absent can be virtually defined. For example, the VNode 30 serving as a license plate recognition sensor can be defined by adding an automobile license plate recognition function to the VNode 30V corresponding to a monitoring camera that captures a still image. As explained above, a plurality of PNodes 30P are virtualized by one VNode 30V, whereby the node 30 that is physically absent can be virtually defined.

In the present embodiment, three-level APIs (Application Programming Interfaces) can be defined for the M2M application 10 operating in the virtual space.

As a top level API, an M2M API can be defined. The M2M API is, for example, a function group of high functions provided to the M2M application 10. Specifically, the functions of the M2M API can include, for example, the point resolution and the node resolution explained above and functions of seven types of classifications (see FIG. 2).

As a low level of the M2M APIs, for example, a primitive API (Prim API) can be defined. Functions of the Prim API is obtained by decomposing functions defined by the M2M API into basic functions. For example, access to the VNode 30V or the VPoint 20V is defined as a function of the Prim API.

A bottom level API is a device-specific API (Dev API). Here, the PNodes 30P of different types respectively have their own APIs. This API unique to the PNode 30P is defined as the Dev API.

In other words, an access function to the VNode 30V serving as the function of the Prim API is converted into an access function (a function of the Dev API) unique to the PNode 30P that actually accesses in the VNode 30V and is executed. Accordingly, a difference in the specifications of the PNode 30P is concealed from the Prim API.

### <2.4. Fourth Problem>

A fourth problem is a management method for efficiently implementing point resolution and node resolution for both the fixed node and the mobile node. For example, the mobile node can be a smartphone or an automobile. The mobile node such as the automobile or the smartphone has a function of a sensor or an actuator and, at the same time, has a calculation capability of a computer. For that reason, these mobile nodes can execute the M2M application 10. That is, the mobile node can be treated equivalently to the MEC server.

In order to solve this problem, in the present invention, the VNode 30V corresponding to the mobile node is defined separately from the VNode 30V corresponding to the fixed node. A physical mobile node is referred to as physical mobile node (PMNode) 30PM. A VNode 30V corresponding to the PMNode 30PM is referred to as virtual mobile node (VMNode) 30VM.

The VMNode 30VM always grasps the physical position of the PMNode 30PM. Irrespective of a physical position of the PMNode 30PM, the VMNode 30VM is fixedly disposed in an MEC server determined in advance. Such an MEC server is referred to as Home MEC Server concerning the PMNode 30PM.

The VMNode 30VM is always operating on the same MEC server (the Home MEC Server). For that reason, the M2M application can perform node-designated type data resolution for the PMNode 30PM irrespective of the physical position of the PMNode 30PM by accessing the VMNode 30VM.

On the other hand, the M2M application can receive the sensor data from the PMNode 30PM when the PMNode 30PM is present in the communication range of the PSink 20P but cannot receive the sensor data when the PMNode 30PM is present outside a communication range of the PSink 20P. The PSink 20P to which the PMNode 30PM is connected changes from moment to moment.

Thus, in the M2M system according to the present embodiment, the VPoint 20V obtained by virtualizing the installation place of the PSink 20P has a function of managing the PMNode 30PM temporarily entering the communication range of the PSink 20P. Accordingly, the M2M application 10 is also capable of acquiring sensor data from the PMNode 30PM through the point-designated type data resolution.

Further, the PNode 30P, the VNode 30V, the PSink 20P, the VPoint 20V, the PMNode 30PM, the VMNode 30VM, and the like are correlated with position information and expressed in an ontology.

In the ontology, in a physical space, an Area class is defined as a class representing a geographical area and a PNode class, a PMNode class, and a PSink class are defined as classes representing physical equipment. On the other hand, in the virtual space, a VNode class, a VMNode class, and a VPoint class are defined as classes obtained by virtualizing physical equipment.

Further, a System class, a Server class, an App class, and an API class are defined as classes representing calculation resources and software modules. The System class is a class representing the M2M system according to the embodiment. The App class is a class representing the M2M application 10. The API class is a class representing a software module that provides the M2M API. The Server class is a class representing a Cloud Server or an MEC server.

Since the M2M application 10 or the API is operating on the Cloud Server or the MEC Server, the Server class, the App class, and the API class are correlated with one another. The PMNode class is correlated with the PNode class from an aspect of the node 30 and, at the same time, is correlated with the Server class from the aspect of a computer. Further, the class of the physical space is correlated with the class of the virtual space.

### 3. System Configuration Example

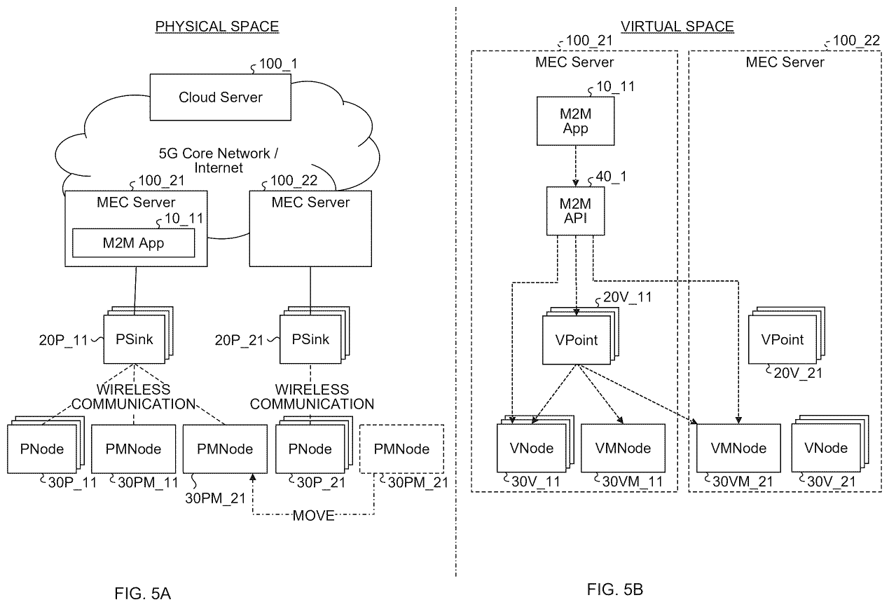

A physical module and a virtual module of the M2M system explained above are explained. FIG. 5 is a diagram illustrating an example of a configuration of an M2M system according to the embodiment of the present disclosure. Note that FIG. 5 (a) is a diagram illustrating a configuration example of the M2M system in the physical space and FIG. 5 (b) is a diagram illustrating a configuration example of the M2M system in the virtual space.

### <3.1. System Configuration Example in the Physical Space>

As illustrated in FIG. 5 (a), in the physical space, the M2M system includes a Cloud Server 100_1, MEC Servers 100_21 and 100_22, PSinks 20P_11 and 20P_21, PNodes 30P_11 and 30P_21, and PMNodes 30PM_11 and 30PM_21.

In the physical space, the Cloud Server 100_1, the MEC Server 100_21, and the MEC Server 100_22 are connected to a 5G core network/the Internet. The PSink 20P_11 or the like, which is a physical sink, is connected under the MEC Server 100_21. The PNode 30P_11 or the like, which is a physical node, is connected to the PSink 20P_11.

Further, the PMNode 30PM_11, which is a physical mobile node with the MEC Server 100_21 set as the Home MEC Server, is also temporarily present in a communication range of the PSink 20P_11.

Similarly, the PSink 20P_21 or the like, which is a physical sink, is connected under the MEC Server 100_22. The PNode 30P_21 or the like, which is a physical node, is connected to the PSink 20P_21.

In the example illustrated in FIG. 5 (a), the PMNode 30PM_21, which is a physical mobile node with the MEC Server 100_22 set as the Home MEC Server, is temporarily present in the communication range of the PSink 20P_11. It is assumed that a communication range of the PMNode 30PM_21 is changed from the PSink 20P_21 to the PSink 20P_11 by movement. As explained above, the PSink 20P connected to the PMNode 30PM, which is a mobile node, is changed by movement.

Here, configuration examples of the devices in the physical space are explained

### (Information Processing Device 100)

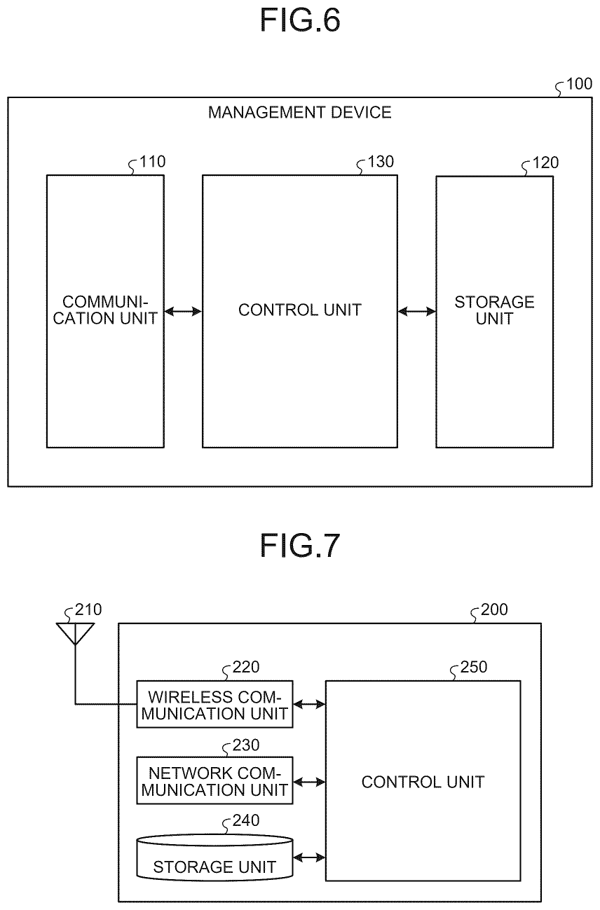

FIG. 6 is a block diagram illustrating an example of a configuration of an information processing device 100 according to the embodiment of the present disclosure. The information processing device 100 illustrated in FIG. 6 functions as, for example, the Cloud Server 100_1 and the MEC Servers 100_21 and 100_22 explained above.

The information processing device 100 includes a communication unit 110, a storage unit 120, and a control unit 130. Note that the configuration illustrated in FIG. 6 is a functional configuration. A hardware configuration may be different from this configuration. Functions of the information processing device 100 may be statically or dynamically distributed and implemented in a plurality of physically separated components. For example, the information processing device 100 may be configured by a plurality of server devices.

The communication unit 110 is a communication interface for communicating with other devices. The communication unit 110 may be a network interface or may be an equipment connection interface. For example, the communication unit 110 may be a LAN (Local Area Network) interface such as an NIC (Network Interface Card) or may be a USB interface configured by a USB (Universal Serial Bus) host controller, a USB port, and the like. The communication unit 110 may be a wired interface or a wireless interface. The communication unit 110 functions as communication means of the information processing device 100. The communication unit 110 communicates with the other information processing devices 100, the PSink 20P, and the like according to the control of the control unit 130.

The storage unit 120 is a data readable/writable storage device such as a DRAM (Dynamic Random Access Memory), an SRAM (Static Random Access Memory), a flash memory, or a hard disk. The storage unit 120 functions as storage means of the information processing device 100.

The control unit 130 is a controller that controls the units of the information processing device 100. The control unit 130 is implemented by a processor such as a CPU (Central Processing Unit), an MPU (Micro Processing Unit), or a GPU (Graphics Processing Unit) For example, the control unit 130 is implemented by the processor executing various programs stored in a storage device inside the information processing device 100 using a RAM (Random Access Memory) or the like as a work area. Note that the control unit 130 may be implemented by an integrated circuit such as an ASIC (Application Specific Integrated Circuit) or an FPGA (Field Programmable Gate Array). All of the CPU, the MPU, the GPU, the ASIC, and the FPGA can be regarded as the controller.

### (Communication Device 200)

FIG. 7 is a block diagram illustrating an example of a configuration of a communication device 200 according to the embodiment of the present disclosure. The communication device 200 illustrated in FIG. 7 functions as, for example, the PSink 20P explained above.

The communication device 200 includes an antenna unit 210, a wireless communication unit 220, a network communication unit 230, a storage unit 240, and a control unit 250. The configuration illustrated in FIG. 7 is a functional configuration and a hardware configuration may be different from the functional configuration. Functions of the communication device 200 may be statically or dynamically distributed and implemented in a plurality of physically separated components. For example, the communication device 200 may be configured by a plurality of server devices.

The antenna unit 210 radiates a signal output from the wireless communication unit 220 into a space as a radio wave. The antenna unit 210 converts a radio wave in the space into a signal and outputs the signal to the wireless communication unit 220. Note that the antenna unit 210 in the present embodiment includes a plurality of antenna elements and can form a beam.

The wireless communication unit 220 transmits and receives signals. For example, the wireless communication unit 220 transmits a signal to the PNode 30P and receives a signal from the PNode 30P. The wireless communication unit 220 operates according to the control of the control unit 250. Note that the wireless communication unit 220 in the present embodiment can form a plurality of beams with the antenna unit 210 and communicate with the PNode 30P.

The network communication unit 230 transmits and receives information. For example, the network communication unit 230 transmits information to the information processing device 100 and receives information from the information processing device 100. The network communication unit 230 can communicate with, for example, the other communication devices 200 and a core network node in addition to the information processing device 100. The network communication unit 230 communicates with other devices according to the control of the control unit 250.

The storage unit 240 is a data readable/writable storage device such as a DRAM (Dynamic Random Access Memory), an SRAM (Static Random Access Memory), a flash memory, or a hard disk. The storage unit 240 functions as storage means of the communication device 200.

The control unit 250 is a controller that controls the units of the communication device 200. The control unit 250 is implemented by a processor such as a CPU (Central Processing Unit) or an MPU (Micro Processing Unit). For example, the control unit 250 is implemented by the processor executing various programs stored in a storage device inside the communication device 200 using a RAM (Random Access Memory) or the like as a work area. Note that the control unit 250 may be implemented by an integrated circuit such as an ASIC (Application Specific Integrated Circuit) or an FPGA (Field Programmable Gate Array). All of the CPU, the MPU, the ASIC, and the FPGA can be regarded as the controller.

### (Wireless Communication Device 300)

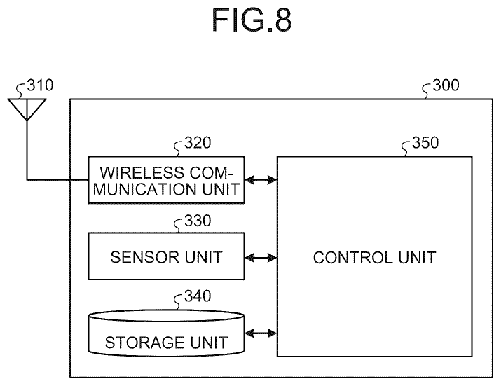

FIG. 8 is a block diagram illustrating an example of a configuration of a wireless communication device 300 according to the embodiment of the present disclosure. The wireless communication device 300 illustrated in FIG. 8 functions as, for example, the PNode 30P and the PMNode 30PM explained above.

The wireless communication device 300 includes an antenna unit 310, a wireless communication unit 320, a sensor unit 330, a storage unit 340, and a control unit 350. The configuration illustrated in FIG. 8 is a functional configuration and a hardware configuration may be different from the functional configuration.

The antenna unit 310 radiates a signal output from the wireless communication unit 320 into the space as a radio wave. The antenna unit 310 converts a radio wave in the space into a signal and outputs the signal to the wireless communication unit 320. Note that the antenna unit 310 in the present embodiment includes a plurality of antenna elements and can form a beam.

The wireless communication unit 320 transmits and receives signals. For example, the wireless communication unit 320 transmits a signal to the PSink 20P and receives a signal from the PSink 20P. The wireless communication unit 320 operates according to the control of the control unit 350. Note that the wireless communication unit 320 in the present embodiment can form a plurality of beams with the antenna unit 310 and communicate with the PSink 20P.

The sensor unit 330 senses the periphery of the wireless communication device 300 and generates sensing information. For example, the sensor unit 330 can be an imaging device that captures a peripheral image or a measurement device that measures temperature and the like. Note that, here, the wireless communication device 300 includes the sensor unit 330. However, the wireless communication device 300 may further include an actuator in addition to or instead of the sensor unit 330.

The storage unit 340 is a data readable/writable storage device such as a DRAM (Dynamic Random Access Memory), an SRAM (Static Random Access Memory), a flash memory, or a hard disk. The storage unit 340 functions as storage means of the wireless communication device 300.

The control unit 350 is a controller that controls the units of the wireless communication device 300. The control unit 350 is implemented by a processor such as a CPU (Central Processing Unit) or an MPU (Micro Processing Unit). For example, the control unit 350 is implemented by a processor executing various programs stored in a storage device inside the wireless communication device 300 using a RAM (Random Access Memory) or the like as a work area. Note that the control unit 350 may be implemented by an integrated circuit such as an ASIC (Application Specific Integrated Circuit) or an FPGA (Field Programmable Gate Array). All of the CPU, the MPU, the ASIC, and the FPGA can be regarded as the controller.

### <3.2. System Configuration Example in the Virtual Space>

Returning back to FIG. 5, an example of the configuration of the M2M system in the virtual space is explained. As illustrated in FIG. 5 (b), in the virtual space, the M2M system includes an M2M application (M2M App) 10_11, an M2M API 40_1, VPoints 20V_11 and 20V_21, VNodes 30V_11 and 30V_21, and VMNodes 30VM_11 and 30VM_21.

In the virtual space, the M2M App 10_11, which is an M2M application, is operating on the MEC Server 100_21. The M2M API 40_1 is operating on the MEC Server 100_21. The M2M API 40_1 connects the M2M App 10_11 and the VPoints 20V_11 and 20V_21, the VNodes 30V_11 and 30V_21, and the VMNodes 30VM_11 and 30VM_21 using the M2M API function and the Prim API function.

The VPoint 20V_11 or the like, which is a virtual module corresponding to the PSink 20P_11 or the like and the PNode 30P_11 or the like, is operating on the MEC Server 100_21. The VNode 30V_11 or the like, which is a virtual module corresponding to the PNode 30P_11 or the like, is operating on the MEC Server 100_21.

Since the MEC Server 100_21 is the Home MEC Server of the PMNode 30PM_11, the VMNode 30VM_11, which is a virtual module corresponding to the PMNode 30PM_11, is also operating on the MEC Server 100_21.

Similarly, the VMNode 30VM_21 is also operating on the MEC Server 100_22 in addition to the VPoint 20V_21 and the like and the Vnode 30V_21 and the like.

The VNodes 30V_11 and 30V_21 and the VMNodes 30VM_11 and 30VM_21, which are virtual nodes, may store sensor data received from the PNodes 30P_11 and 30P_21 and the PMNodes 30PM_11 and 30PM_21 corresponding thereto on the inside or may store the sensor data in an external database.

Note that the configuration of the M2M system illustrated in FIG. 5 is an example and the numbers of the components are not limited to the example illustrated in FIG. 5. For example, there may be two or more cloud servers, M2M apps, and M2M APIs and there may be one MEC server or three or more MEC servers. The number of PSinks and VSinks may be one or may be three or more. The number of PNodes, PMNodes, VNodes, and VMNodes may be two or more. A plurality of PSinks and a plurality of VPoints may be disposed in one MEC Server.

### 4. Processing Example

An overview of data acquisition processing (sensor data resolution) performed in the M2M system explained above is explained.

### <4.1. Node-Designated Type Sensor Data Resolution>

First, an overview of node-designated type sensor data resolution is explained. The M2M application 10 designates one of the fixed node or the mobile node and acquires data from the designated node.

### <4.1.1. Fixed Node>

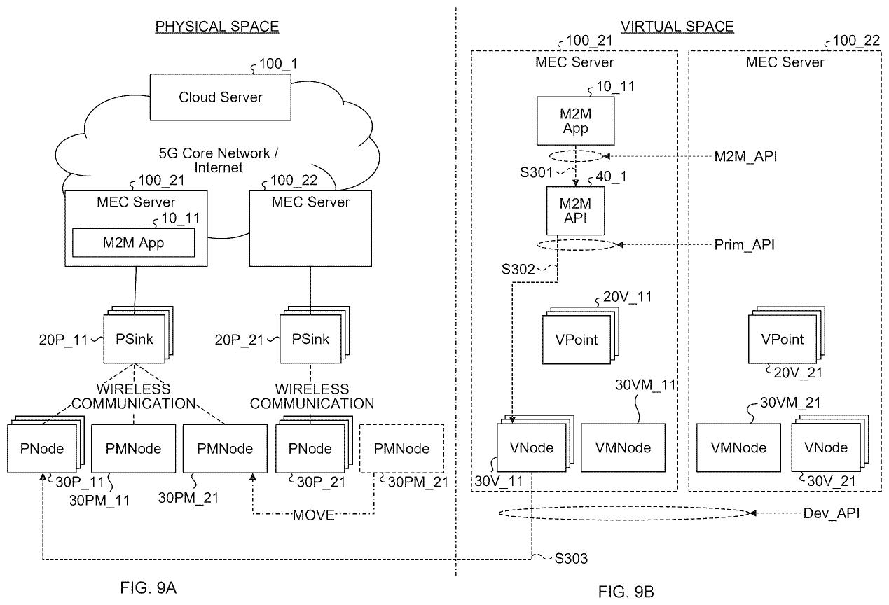

FIG. 9 is a diagram for explaining an example of the node-designated type sensor data resolution in which the fixed node is designated according to the embodiment of the present disclosure. Here, it is assumed that the M2M App 10_11 designates the VNode 30V_11 and acquires data.

First, the M2M App 10_11 designates the VNode 30V_11 using the function of the M2M API 40_1 and requests the M2M API 40_1 to perform the node-designated type sensor data resolution (step S301). The M2M API 40_1 uses the function of the Prim API to acquire sensor data from the VNode 30V_11 (step S302).

The VNode 30V_11 acquires sensor data from the PNode 30P_11 using the function of the Dev API (step S303). The VNode 30V_11 returns the acquired sensor data to the M2M App 10_11 via the M2M API 40_1. Alternatively, the VNode 30V_11 can return the sensor data stored therein to the M2M App 10_11.

### <4.1.2. Mobile Node>

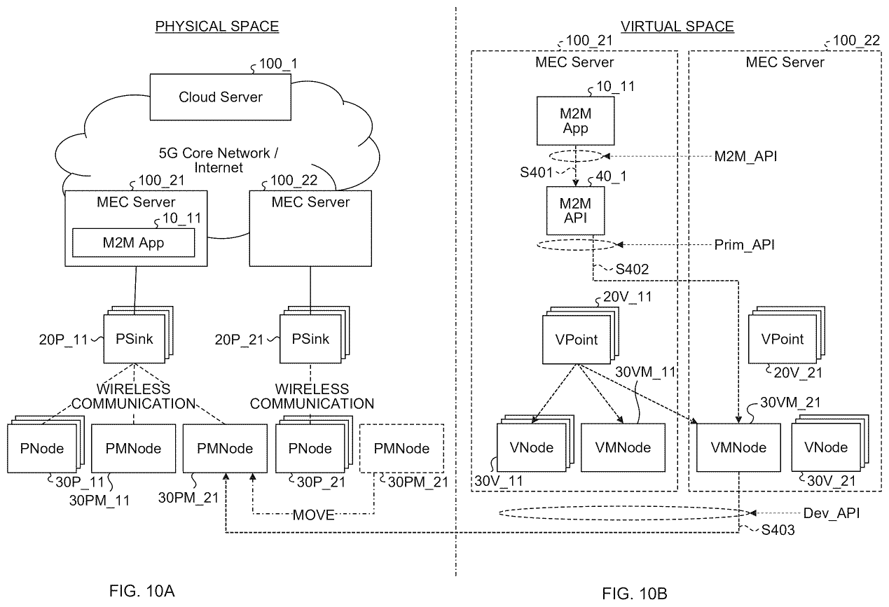

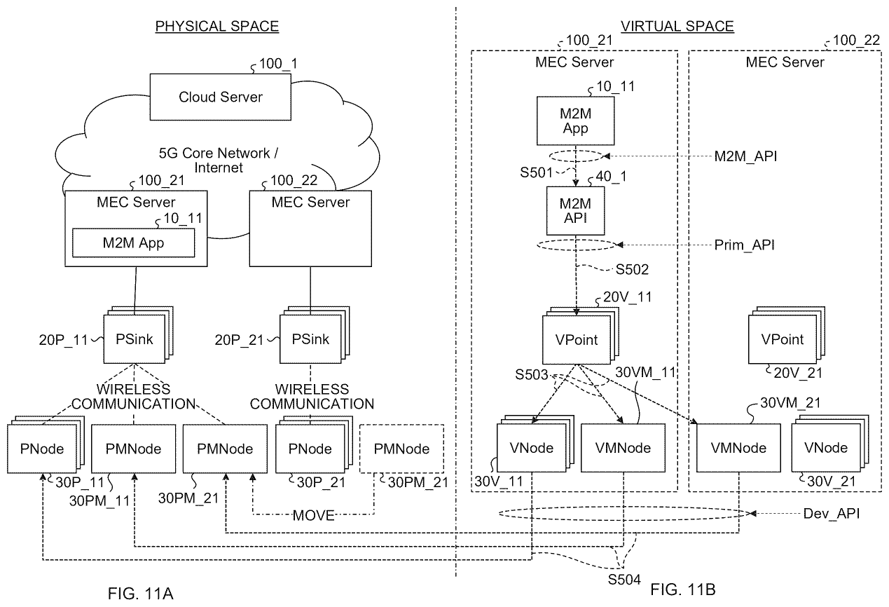

FIG. 10 is a diagram for explaining an example of the node-designated type sensor data resolution in which the mobile node is designated according to the embodiment of the present disclosure. Here, it is assumed that the M2M App 10_11 designates the VMNode 30VM_21 and acquires data.

First, the M2M App 10_11 designates the VMNode 30VM_21 using the function of the M2M API 40_1 and requests the M2M API 40_1 to perform the node-designated type sensor data resolution (step S401). The M2M API 40_1 uses the function of the Prim API to acquire sensor data from the VNode 30V_21 irrespective of a physical position of the PMNode 30PM_11 (step S402).

The VMNode 30VM_21 acquires sensor data from the PMNode 30PM_21 using the function of the Dev API (step S403). The VMNode 30VM_21 returns the acquired sensor data to the M2M App 10_11 via the M2M API 40_1. Alternatively, the VMNode 30VM_21 can return the sensor data stored therein to the M2M App 10_11.

### <4.2. Point-Designated Type Sensor Data Resolution>

Subsequently, an overview of point-designated type sensor data resolution is explained. FIG. 11 is a diagram for explaining an example of the point-designated type sensor data resolution according to the embodiment of the present disclosure. Here, it is assumed that the M2M App 10_11 designates the VPoint 20V_11 and acquires data.

First, the M2M App 10_11 designates the VPoint 20V_11 using the function of the M2M API 40_1 and requests the M2M API 40_1 to perform the point-designated type sensor data resolution (step S501). The M2M API 40_1 makes an inquiry to the VPoint 20V_11 using the function of the Prim API (step S502).

Then, the VPoint 20V_11 uses the function of the Prim API to communicate with the VNode 30V_11, the VMNode 30VM_11, the VMNode 30VM_21, and the like (step S503).

The VNode 30V_11, the VMNode 30VM_11, and the VMNode 30VM_21 use the function of the Dev API to communicate with the PNode 30P_11, the PMNode 30PM_11, and the PMNode 30PM_21 corresponding thereto and obtain sensor data (step S504).

It is assumed that the PMNode 30PM_11 with the MEC Server 100_21, in which the VPoint 20V_11 is operating, set as the Home MEC Server is present in the communication range of the PSink 20P_11 corresponding to the VPoint 20V_11. In this case, the VPoint 20V_11 can acquire sensor data from the VMNode 30VM_11 or the PMNode 30PM_11 using the functions of the Prim API and the Dev API.

It is assumed that the PMNode 30PM_21 with the MEC Server 100_22 other than the MEC Server 100_21, in which the VPoint 20V_11 is operating, set as the Home MEC Server is temporarily present in the communication range of PSink 20P_11 corresponding to the VPoint 20V_11. In this case, the VPoint 20V_11 recognizes that the PMNode 30PM_21 is present in the communication range of the PSink 20P_11. For that reason, the VPoint 20V_11 can acquire sensor data from the VMNode 30VM_21 or the PMNode 30PM_21 using the functions of the Prim API and the Dev API.

As explained above, the M2M application 10 according to the present embodiment communicates with at least one of the virtual node (for example, the VNode 30V_11 or the VMNodes 30VM_11 and 30VM_21) and the virtual point (for example, the VPoint 20V_11). Accordingly, the M2M application 10 can more securely perform M2M communication with the physical node (for example, the PNode 30P_11 or the PMNode 30PM_11 and 30PM_21).

Note that steps S301, S401, and S501 illustrated in FIG. 9 to FIG. 11 indicate execution of the function of the M2M API. Steps S302, S402, S502, and S503 indicate execution of the function of the Prim API (an example of the low level API) of a level lower than the M2M API. Steps S303, S403, and S504 indicate execution of the function of the Dev API (an example of the device API) of a level lower than the Prim API.

### 5. Details of a Proposed Technology

### <5.1. Representation Method for Geographic Information: Class Definition>

In the present proposed technology, a relation between geographic information and physical equipment or a software module is expressed by ontology. In the ontology, as the relation, a relation among matters is expressed by a triplet of a subject, a property, and an object. Since the object can be a subject of another triplet, the relation among matters spreads in a mesh. A type of a matter is called class and a specific matter is expressed as an instance of a class corresponding thereto. A property representing a relation between classes or instances is referred to as object property and a property representing a relation between a class or an instance and an attribute thereof is referred to as data property.

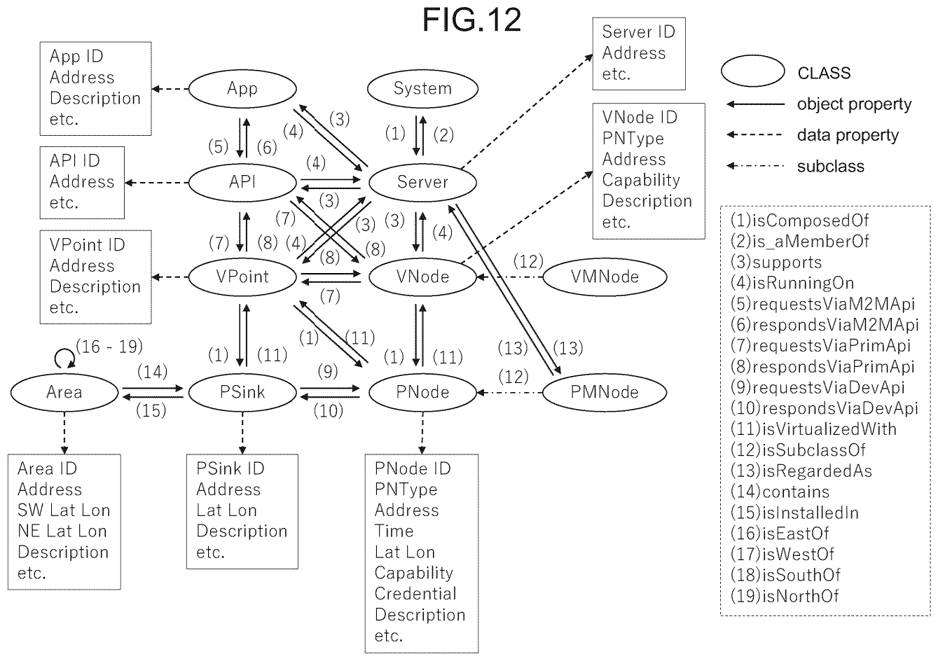

FIG. 12 is a diagram illustrating a relation among classes in an M2M system according to the embodiment of the present disclosure. In the M2M system according to embodiment of the present disclosure, eleven classes described below are defined.
A System class representing a proposed M2M system
A Server class representing the Cloud Server 100_1 and the MEC Servers 100_21 and 100_22 configuring the M2M system
An App class representing the M2M application 10 as serving as a software module
An API class representing a software module that provides the M2M API to the M2M application 10
An Area class representing a geographical area
A PNode class representing a fixedly installed physical node 30 (a sensor or an actuator)
A VNode class representing software module obtained by virtualizing the node 30
A PMNode class representing the physical mobile node 30M such as an automobile or smartphone
A VMNode class representing a software module obtained by virtualizing the mobile node 30M
A PSink class representing physical equipment serving as a gateway (the sink 20) between the node 30 that performs wireless communication and the network
A VPoint class representing a software module obtained by virtualizing the sink 20, the node 30 connected thereto, and the mobile node 30M

### (System Class)

The System class is a class located at the root in the class relation. The System class represents a relation between a System instance and a Server instance using an object property of isComposedOf (is composed of . . . ).

(Server class)

The Server class represents a relation between a Server instance and a System instance using an object property of is aMemberOf (is a member of . . . ). Further, the Server class represents a relation between a Server instance and an App instance, an API instance, a VPoint instance, or a VNode instance using an object property of supports (supports . . . ). Further, the Server class represents a relation between a Server instance and a PMNode instance using an object property isRegardedAs (is regard as . . . ).

By defining this relation, the mobile node 30M such as an automobile or a smartphone can be treated in the same manner as the node 30 serving as a sensor or an actuator and, at the same time, treated as an MEC server.

The Server class has a data property such as a Server ID (an identifier of a Server instance) and an Address (an address designated for access via a network).

### (App Class)

The App class represents a relation between an App instance and a Server instance using an object property of isRunningOn (is running on . . . ). Further, the App class indicates a relation between an App instance and an API instance using an object property of requestsViaM2MApi (requests with the M2M API).

The App class has a data property such as an App ID (application identifier), an Address, and a Description (annotation).

### (API Class)

The API class represents a relation between an API instance and an App instance using an object property of respondsViaM2MApi (responds to a request of the M2M API). Further, the API class represents a relation between an API class and a VPoint class or a VNode class using an object property of requestsViaPrimAPI (requests with the Primitive API). Further, the API class represents a relation between an API instance and a Server instance using an object property of isRunningOn.

The API class has a data property such as an API ID (an identifier of an API instance) and an Address.

(Area class)

An area is defined as a rectangle in which a geographical area is surrounded by a weft line and a meridian line of 0.1 minutes (6 seconds). 0.1 minute of the latitude and the longitude is approximately 185 m near Japan. Note that the length of one side of the Area may be any length. The shape of the Area is not limited to the rectangle and may be optional.

The Area class has object properties of isEastOf (adjacent to the east), isWestOf (adjacent to the west), isSouthOf (adjacent to the south), and isNorthOf (adjacent to the north) and expresses an adjacency relation of east, west, south, and north among Area instances. Further, the Area class represents a relation between an Area instance and a PSink instance using an object property of contains (contains . . . ).

The Area class has data properties such as Area ID (Area Identifier), Address, SW Lat Lon (latitude and longitude of the southwest corner), NW Lat Lon (latitude and longitude of the northeast corner), and Description.

### (PSink Class)

The PSink class represents relations between a PSink instance and an Area instance, a PNode instance, and a VPoint instance respectively using object properties of isInstalledIn (installed in . . . ), requestsViaDevApi (requests with the Device API), and isVirtualizedWtih (virtualized by . . . ).

The PSink class has data properties such as PSink ID (Physical Sink identifier), Address, Lat Lon (latitude and longitude), and Description.

### (PNode Class)

The PNode class represents a relation between a PNode instance and a PSink instance using an object property of respondsViaDevAPI (responds to a request of the Device API). Further, the PNode class represents a relation between a PNode instance and a VNode instance or a VPoint instance using an object property of isVirtualizedWith.

The PNode class has data properties such as PNode ID (Physical Node Identifier), PNType (PNode type), Address, Lat Lon, Capabilities (function), Credential (credit information), and Description.

### (PMNode Class)

A PMNode class is defined as a subclass of the PNode class. The PMNode class represents a relation between a PMNode instance and a Server instance using an object property isRegardedAs (is regarded as . . . ). By defining this relation, the mobile node 30M such as an automobile or a smartphone can be treated as the node 30 serving as a sensor or an actuator and, at the same time, can be treated as an MEC Server. The PMNode class has data properties such as a Home MEC ID (an identifier of the Home MEC Server of the PMNode 30PM), Time (date and time), and Lat Lon in addition to the data properties of the PNode class.

### (VPoint Class)

The VPoint class represents a relation between a VPoint instance and a PSink instance or a PNode instance using an object property of isComposedOf. Further, the VPoint class represents a relation between a VPoint instance and a VNode instance or an API instance using an object property of respondsViaPrim API (responds to a primitive API request). Further, the VPoint class represents a relation between a VPoint instance and a Server instance using an object property of isRunningOn.

The VPoint class has data properties such as VPoint ID (Virtual Point Identifier), Address, Lat Lon, and Description.

### (VNode Class)

The VNode class represents a relation between a VNode instance and a VPoint instance using an object property of requestsViaPrimAPI. Further, the VNode class represent a relation between a VNode instance and an API instance using an object property of respondsViaPrimAPI. Further, the VNode class represents a relation between a VNode instance and a PNode instance using an object property of isComposedOf.

The VNode class has data properties such as VNode ID (Virtual Node Identifier), PNType (a type of corresponding PNode), Address, Capabilities, and Description.

The VMNode class is defined as a subclass of the VNode class.

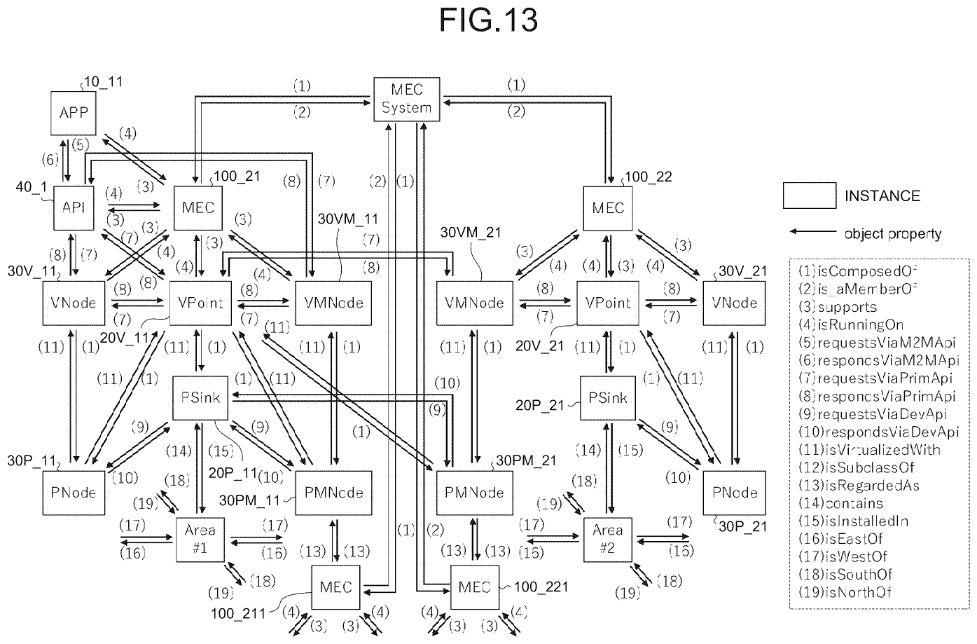

FIG. 13 is a diagram illustrating a relation among instances in an M2M system according to the embodiment of the present disclosure. Although detailed explanation is omitted, as an example, since the PMNode 30PM_21, which is the mobile node 30M, also has an aspect of the MEC Server, the PMNode 30PM_21 and the MEC100_21 are bidirectionally connected by an object property of isRegardedAs. A connection destination from the MEC100_21 by object properties of supports or isRunningOn is omitted. However, the M2M application 10 or the like that operates inside the PMNode 30PM_21 serving as the MEC Server is present ahead.

### <5.2. M2M System Architecture>

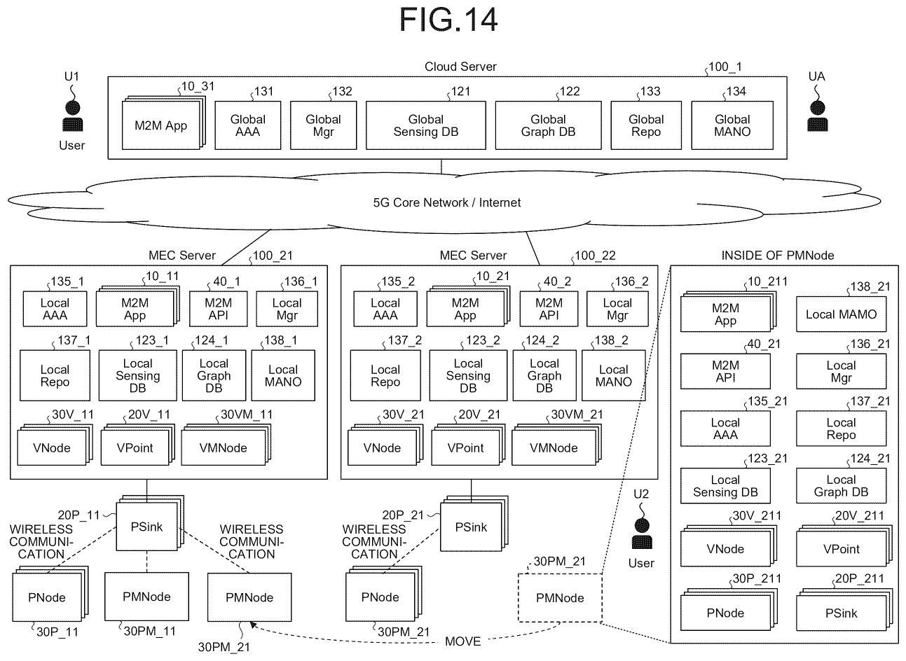

FIG. 14 is a diagram illustrating an example of an architecture of the M2M system according to the embodiment of the present disclosure. Note that modules included in servers illustrated in FIG. 14 may be implemented as functional blocks included in, for example, the control unit 130 of the information processing device 100 illustrated in FIG. 6 or may be implemented as applications executed by the information processing device 100. Similarly, modules included in the PMNode 30PM_21 may be implemented as functional blocks included in, for example, the control unit 350 of the wireless communication device 300 illustrated in FIG. 8 or may be implemented as an application executed by the wireless communication device 300.

As illustrated in FIG. 14, the M2M system can include a network configured by a core network of a mobile phone, the Internet, and the like. In the present embodiment, an environment in which a data center (not illustrated) and an MEC base are connected to this network is assumed. It is assumed that Cloud Server 100_1 is installed in the data center. It is assumed that the MEC Servers 100_21 and 100_22 are installed in the MEC base.

In the following explanation, the Cloud Server 100_1 is a generic term for servers installed in the data center. It is assumed that the MEC Servers 100_21 and 100_22 are servers installed in the MEC base. When the MEC servers 100_21 and 100_22 are not distinguished, the MEC servers 100_21 and 100_22 are simply referred to as MEC server 100_20. The MEC Server 100_20 is a generic term for servers installed in the MEC base.

Note that the PSink 20P, the PNode 30P, the PMNode 30PM, the VPoint 20V, the VNode 30V, the VMNode 30VM, the M2M App (M2M application) 10, and the M2M API 40 are as explained above. The M2M App 10 can be disposed in at least one of the Cloud Server 100_1 and the MEC Server 100_20. The PNode 30P and the VNode 30V may be associated in a one to one relation or may be associated in a many to one relation. The PMNode 30PM and the VMNode 30VM may be associated in a one to one relation or may be associated in a many to one relation. The PSink 20P and the VPoint 20V may be associated in a one to one relation or may be associated in a many to one relation.

The graph DB is a database that stores, as graphs, a geographical disposition relation among pieces of physical equipment and a relation between physical equipment and a module obtained by virtualizing the physical equipment. A Local Graph DB 124 is installed in the MEC Server 100_20. The Local Graph DB 124 stores information concerning the nodes 30 and the virtual modules disposed in geographical areas controlled by the MEC Servers 100_20. A Global Graph DB 122 is installed in the Cloud Server 100_1 and stores information concerning the nodes 30 and virtual modules of the entire system.

The sensing DB is a database that stores sensor data measured by a sensor. A Local Sensing DB 123 is installed in the MEC Server 100_20. A Global Sensing DB 121 is installed in the Cloud Server 100_1.

The Local Sensing DB 123 in the MEC Server 100_20 stores sensor data measured by a sensor installed near the MEC base. Further, the sensor data stored in the Local Sensing DB 123 in the MEC Server 100_20 is stored as a backup in the Global Sensing DB 121 in the Cloud Server 100_1 as well.

A user U is a user who activates and uses the M2M App 10. In FIG. 14, a user U1 uses an M2M App 10_31 via Cloud Server 100_1 and a user U2 uses an M2M App 10_211 via PMNode 30PM_21.

The Manager (Mgr) is a module that manages and controls the M2M system. In the MEC Server 100_20, a Local Manager (Local Mgr) 136 operates. In the Cloud Server 100_1, a Global Manager (Global Mgr) 132 operates.

The user U1 requests the Global Mgr 132 to activate the M2M App 10. Alternatively, when the user U2 uses the mobile node 30M (for example, when the user U2 rides on an automobile or uses a smartphone), the user U2 sometimes requests a Local Mgr 136_21 operating on the mobile node 30M to start the M2M App 10. A user UA is an administrator of the M2M system and manages the M2M system via the Global Mgr 132.

An AAA (Authentication, Authorization, and Accounting) is a module that manages authentication, authorization, and use histories of the user U, the node 30, and the like. A Local AAA 135 operates on the MEC Server 100_20. A Global AAA 131 operates on the Cloud Server 100_1.

A Repository (Repo) is a database that stores a program image of the M2M App 10. A Global Repository (Global Repo) 133 is installed in the Cloud Server 100_1. A Local Repository (Local Repo) 137 is installed in the MEC Server 100_20 or the mobile node 30M.

MANO (Management and Orchestration) is a module that calculates, when the user U starts the M2M App 10, in which MEC Server 100_20 or Cloud Server 100_1 the M2M App 10 is optimally disposed. A Global MANO 134 is installed in the Cloud Server 100_1 and a Local MANO 138 is installed in the mobile node 30M.

Since the mobile node 30M also has an aspect of the MEC Server 100_20, the same software module as the software module of the MEC Server 100_20 operates inside the mobile node 30M and the Local MANO 138 also operates inside the mobile node 30M. Further, since the mobile node 30M also has an aspect of the node 30, a PNode 30P_211 and a PSink 20P_211 are also present.

### <5.3. Definition of a Message Type>

In the following explanation of the M2M system, message types explained below are used.

Examples of message types concerning the M2M application 10 include an App start request, an App start response, an App configuration information request, an App configuration information response, an App activation request, an App activation response, an App acquisition request, and an App acquisition response.

Examples of message types concerning the MANO include a MANO request and a MANO response.

Examples of message types concerning the PNode 30P include a PN registration request, a PN registration response, a PN disconnection report, a PN deletion request, and a PN deletion response.

Examples of message types concerning a graph indicating a relation among modules include a graph search request, a graph search response, a graph update request, and a graph update response.

Examples of message types concerning connection include a connection request and a connection response.

Examples of message types concerning data include a data resolution request, a data resolution response, data writing, a data search request, a data search response, a data update request, a data update response, a data acquisition request, a data acquisition response, data notification, a data read request, and a data reading response.

Examples of message types concerning an operation of the M2M system include an operation request, an operation response, an operation instruction request, and an operation instruction response.

Examples of message types concerning authentication include an authentication request, an authentication response, an authentication authorization request, and an authentication authorization response.

Examples of other message types include a load report, a point resolution request, and a point resolution response.

### <5.4. Definition of a Field>

A message, entries of the Global Graph DB 122 and the Local Graph DB 124, and management tables (not illustrated) retained by the VPoint 20V and the VMNode20VM include, for example, fields explained below. Note that the fields included in the management tables are an example. Fields other than the fields explained below can be included in the management tables.
An Action field: representing an action instructed to an actuator.
An Address field: representing a network address.
An AppImage field: representing image data of an application program.
An AppName field: representing a name of an M2M application program.
A Capability field: representing a function.
A CompLoad field: representing load information of a calculation resource.
A Condition field: representing a condition in condition satisfaction data resolution.
A ConfInfo field: representing configuration information (a size of a program, a requested calculation resource, a network band, and the like) concerning an application program.
A Credential field: representing credit information.
Data field: sensor data is stored.
A Description field: representing an annotation.
An End Time field: representing end time.
A Home MEC ID field: representing an identifier of the Home MEC Server of the PMNode.
An isComposedOf field: representing an identifier of an instance correlated by a property isComposedOf.
An isInstalledIn field: representing an identifier of an instance correlated by a property isInstalledIn.
An isRegardedAs field: representing an identifier of an instance correlated by a property isRegardedAs.
An isRunningOn field: representing an identifier of an instance correlated by a property isRunningOn.
An isVirtualizedWith field: representing an identifier of an instance correlated by a property isVirtualizedWith.
A Lat Lon field: representing latitude and longitude.
An MECID field: representing an identifier of the MEC Server 100_20.
An NE Lat Lon field: representing the latitude and the longitude of a North-east corner of a geographical area.
A NetLoad field: representing load information of a network.
A No Values field: representing the number of pieces of sensor data.
A No VNs field: representing the number of the VNode 30V.
A No VPs field: representing the number of the VPoints 20V.
A Param field: representing a parameter at an activation time of the M2M application 10.
A PNID field: representing an identifier of the PNode 30P.
A PNType field: representing a type of the PNode 30P.
A PSID field: representing an identifier of the PSink 20P.
A Query Type field: representing a type of a data resolution request.
A requestsViaDevApi field: representing an identifier of an instance correlated by a property requestsViaDevApi.
A requestsViaPrimApi field: representing an identifier of an instance correlated by a property requestsViaPrimApi.
A respondsViaDevApi field: representing an identifier of an instance correlated by a property respondsViaDevApi.
A respondsViaPrimApi field: representing an identifier of an instance correlated by a property respondsViaPriimApi.
A Session Key field: representing a session key that means authenticated.
A Start Time field: representing start time.
A Status field: representing a result of processing. OK indicates that processing is successful.
An SW Lat Lon field: representing the latitude and the longitude of a southwest corner of a geographical area.
A Time field: representing date and time.
A Type field: representing a type of a packet.
A UserID field: representing an identifier of the user U.
A VNAddress field: representing an address of the VNode 30V.
A VNID field: represents an identifier of the VNode 30V.
A VPAddress field: representing an address of the VPoint 20V
A VPID field: representing an identifier of the VPoint 20V.

Values of the Query Type field are, for example, as explained below. Note that the values of the Query Type field explained below are examples and may be values other than the values explained below.
Node search #1
Node search #2
POINT SEARCH
Node Condition
Node Current
Node Past
Point Condition
Point Current
Point Past

### <5.5. Other Definitions>

Here, besides the definitions explained above, definitions used in the following explanation are explained. Note that the following definitions are examples and definitions other than the definitions explained below may be used as embodiments of the present disclosure.

### (Actuator)

An Act Name is an example of an action instructed to an actuator. An Act Param is an example of a parameter in the instruction to the actuator.

### (Network Address)

An Addr PMN #n is a network address of a PMNode 30PM_n (n is a natural number of 1 or more). An Addr PN #n is a network address of a PNode 30P_n. An Addr PS #n is a network address of a PSink 20P_n. An Addr VMN #n is a network address of a VMNode 30VM_n.

An Addr VN is an example of a network address of the VNode 30V. An Addr VN #n is a network address of a VNode 30V_n (n is a natural number of 1 or more). An Addr VP is an example of a network address of a VPoint. An Addr VP #n is a network address of a VPoint 20V_n.

### (Application)

An App Image is an example of a program image of an application. An App Info is an example of configuration information of the application. An App Name is an example of a name of the application. An App Param is an example of a parameter at the time of application activation.

### (Functions)

A Caps PMN #n is a function of the PMNode 30PM_n. A Caps PN #n is a function of the PNode 30P_n. A Caps VMN #n is a function of the VMNode 30VM_n.

A CapType is an example of a function. A CondType is an example of a condition. A Cred PMN #n is credit information of the PMNode 30PM_n. A Cred PN #n is credit information of the PNode 30P_n. A Cred User #n is credit information of the user Un.

(Update information)

Data Update is an example of update information transmitted to the Global Sesing DB 121 by the Local Sensing DB 123. Data GraphUpdate is an example of update information transmitted to the Global Graph DB 122 by the Local Graph DB 124.

(Sensor data)

Data PMN #n is an example of sensor data transmitted by the PMNode 30PM_n. Data PN #n is an example of sensor data transmitted by the PNode 30P_n. Data Sensed is an example of sensor data.

### (Annotations)

A Desc PN #n is an annotation of the PNode 30P_n. A Desc PS #n is an annotation of the PSink 20P_n. A Desc PMN #n is an annotation of the PMNode 30PM_n. A Desc VMN #n is an annotation of the VMNode 30VM_n. A Desc VN #n is an annotation of the VNode 30V_n. A Desc VP #n is an annotation of the VPoint 20V_n.

### (Identifiers)

An Id Area #n is an identifier of an Area n. An Id MEC #n is an identifier of an MEC Server 100_n. An Id PMN #n is an identifier of the PMNode 30PM_n. An Id PN #n is an identifier of the PNode 30P_n. An Id PS #n is an identifier of the PSink 20P_n. An Id User #n is an identifier of the user Un.

An Id VMN #n is an identifier of the VMNode 30VM_n. An Id VN is an example of an identifier of the VNode 30V. An Id VN #n is an identifier of the VNode 30V_n. An Id VP is an example of an identifier of the VPoint 20V. An Id VP #n is an identifier of the VPoint 20V_n.

### (Latitude and Longitude)

A LatLon NE is an example of the latitude and the longitude of a northeast corner of an area. A LatLon PMN #n is the latitude and the longitude of the PMNode 30PM_n. A LatLon PN #n is the latitude and the longitude of the PNode 30P_n. A LatLon PS #n is the latitude and the longitude of the PSink 20P_n. A LatLon SW is an example of the latitude and the longitude of a southwest corner of the area.

### (Load Information)

A Load Comp is an example of load information of a calculation resource. A Load Net is an example of load information of a network resource.

### (Numbers)

A Num VNs is an example of the number of VNodes 30V. A Num VPs is an example of the number of VPoints 20V.

### (Type)

A PNType PMN #n is a type of the PMNode 30PM_n. A PNType PN #n is a type of the PNode 30P_n. A PNType VMN #n is a type of the PNode 30PM to which the VMNode 30VM_n corresponds. A PNType VN #n is a type of the PNode 30P to which the VNode 30V_n corresponds.

### (Session Keys)

An SKey PMN #n is a session key shared between the PMNode 30PM_n and the VPoint 20V_n. An SKey PN #n is a session key shared between the PNode 30P_n and the VPoint 20V_n.

### (Date and Time)

A Time End is an example of end time of a designated date and time. A Time PMN #n is an example of a date and time when the PMNode 30PM_n was connected to the PSink 20P. A Time PMN #n_D is an example of a date and time when the PMNode 30PM_n transmitted sensor data.

A Time PN #n is an example of a date and time when the PNode 30P_n was installed. A Time PN #n_D is an example of a date and time when the PNode 30P_n transmitted sensor data.

A Time DataUpdate is an example of a date and time when the Local Sensing DB 123 transmits update data to the Global Sensing DB 121. A Time GraphUpdate is an example of a date and time when the Local Graph DB 124 transmits update data to the Global Graph DB 122. A Time LoadUpdate is an example of a date and time when the Local Mgr 136 transmits load information to the Global Mgr 132.

A Time Sensed is an example of a date and time when sensor data was measured. A Time Start is an example of start time of a designated date and time.

### <5.6. Initial State>

An initial state of the M2M system (see FIG. 14) is as explained below.

All software modules in the MEC Server 100_20 have already been activated. Instance information of the MEC Server 100_20 has already been registered in the Local Graph DB 124. The PSink 20P has already been installed. Instance information of PSink 20 has already been registered in the Local Graph DB 124.

The PMNode 30PM operates as an MEC Server. For that reason, the instance information of the PMNode 30PM has already been registered in the Local Graph DB 124 in the initial state. However, in the initial state, the PMNode 30PM has not been physically connected to the PSink 20P yet. The PNode20P and the like have not been connected to the PSink 20P yet.

### (Instance Information of the PSink 20P_11)

Table 1 is a table illustrating entries of PSink 20P_11 in an initial state in a Local Graph DB 124_1. Table 1 illustrates an example of instance information of PSink 20P_11 according to the embodiment of the present disclosure. The instance information illustrated in Table 1 is registered (entered) in the Local Graph DB 124_1, for example, in the initial state.

TABLE 1
Entries of PSink 20P_11 in initial state in Local Graph DB 124_1

PSID = Id_PS#11
isVirtualizedWtih = Id_VP#11
isInstalledIn = Id_Area#1
requestsViaDevApi = [null]
Address = Addr_PS#11
Lat Lon = LatLon_PS#11
Description = Desc_PS#11

In the example illustrated in Table 1, the Local Graph DB 124_1 retains, as the instance information of the PSink 20P_11, an ID (PSID=Id_PS #11) of the PSink 20P_11, information concerning a corresponding virtual point (isVirtualizedWtih=Id_VP #11), and the like.

Note that the instance information illustrated in Table 1 is an example. The Local Graph DB 124_1 can retain information other than the information illustrated in Table 1 as the instance information of PSink 20P_11.

### (Instance Information of the VPoint 20V_11)

Table 2 is a table illustrating entries of the VPoint 20V_11 in the initial state in the Local Graph DB 124_1. Table 2 illustrates an example of instance information of the VPoint 20V_11 according to the embodiment of the present disclosure. The instance information illustrated in Table 2 is registered (entered) in the Local Graph DB 124_1, for example, in the initial state.

TABLE 2
Entries of VPoint 20V_11 in initial
state in Local Graph DB 124_1

VPID = Id_VP#11
isRunningOn = Id_MEC#1
isComposedOf = Id_PS#11
Address = Addr_VP#11
Lat Lon = LatLon_PS#11
Description = Desc_VP#11

In the example illustrated in Table 2, the Local Graph DB 124_1 retains, as the instance information of the VPoint 20V_11, an ID (VPID=Id_VP #11) of the VPoint 20V_11, information concerning an operating MEC Server (isRunningOn=Id_MEC #1), and the like. Note that Id_MEC #1 is an identifier for identifying the MEC Server 100_21.

Note that the instance information illustrated in Table 2 is an example. The Local Graph DB 124_1 can retain information other than the information illustrated in Table 2 as the instance information of the VPoint 20V_11.

### (Instance Information of the VNode 30V_11)

Table 3 is a table illustrating entries of the VNode 30V_11 in the initial state in the Local Graph DB 124_1. Table 3 illustrates an example of instance information of the VNode 30V_11 according to the embodiment of the present disclosure. The instance information illustrated in Table 3 is registered (entered) in the Local Graph DB 124_1, for example, in the initial state.

TABLE 3
Entries of VNode 30V_11 in initial
state in Local Graph DB 124_1

VNID = Id_VN#11
isRunningOn = Id_MEC#1
requestsViaPrimApi = Id_VP#11
isComposedOf = [null]
PNType = PNType_VN#11
Address = Addr_VN#11
Capability = [null]
Description = Desc_VN#11

In the example illustrated in Table 3, the Local Graph DB 124_1 retains, as the instance information of the VNode 30V_11, an ID (VNID=Id_VN #11) of the VNode 30V_11, information concerning an operating MEC Server (isRunningOn=Id_MEC #1), and the like.

Note that the instance information illustrated in Table 3 is an example. The Local Graph DB 124_1 can retain information other than the information illustrated in Table 3 as the instance information of the VNode 30V_11.

### (Instance Information of the VMNode 30VM_11)

Table 4 is a table illustrating entries of the VMNode 30VM_11 in the initial state in the Local Graph DB 124_1. Table 4 illustrates an example of instance information of the VMNode 30VM_11 according to the embodiment of the present disclosure. The instance information illustrated in Table 4 is registered (entered) in the Local Graph DB 124_1, for example, in the initial state.

TABLE 4
Entries of VMNode 30VM_11 in initial
state in Local Graph DB 124_1

VNID = Id_VMN#11
isRunningOn = Id_MEC#1
isComposedOf = Id_PMN#11
PNType = PNType_VMN#11
Address = Addr_VMN#11
Capability = Caps_VMN#11
Description = Desc_VMN#11

In the example illustrated in Table 4, the Local Graph DB 124_1 retains, as the instance information of the VMNode 30VM_11, an ID (VNID=Id_VMN #11) of the VMNode 30VM_11, information concerning an operating MEC Server (isRunningOn=Id_MEC #1), and the like.

Note that the instance information illustrated in Table 4 is an example. The Local Graph DB 124_1 can retain information other than the information illustrated in Table 4 as the instance information of the VMNode 30VM_11.

### (Instance Information of the VMNode 30VM_21)

Table 5 is a table illustrating entries of the VMNode 30VM_21 in the initial state in a Local Graph DB 124_2. Table 5 illustrates an example of instance information of the VMNode 30VM_21 according to the embodiment of the present disclosure. The instance information illustrated in Table 5 is registered (entered) in the Local Graph DB 124_2, for example, in the initial state.

TABLE 5
Entries of VMNode 30VM_21 in initial
state in Local Graph DB 124_2

VNID = Id_VMN#21
isRunningOn = Id_MEC#2
isComposedOf = Id_PMN#21
PNType = PNType_VMN#21
Address = Addr_VMN#21
Capability = Caps_VMN#21
Description = Desc_VMN#21

In the example illustrated in Table 5, the Local Graph DB 124_2 retains, as the instance information of the VMNode 30VM_21, an ID (VNID=Id_VMN #21) of the VMNode 30VM_21, information concerning an operating MEC Server (isRunningOn=Id_MEC #2), and the like. Note that Id_MEC #2 is an identifier for identifying the MEC Server 100_22.

Note that the instance information illustrated in Table 5 is an example. The Local Graph DB 124_2 can retain information other than the information illustrated in Table 5 as the instance information of the VMNode 30VM_21.

### (Instance Information of the PMNode 30PM_11)

Table 6 is a table illustrating entries of the PMNode 30PM_11 in the initial state in the Local Graph DB 124_1. Table 6 illustrates an example of instance information of the PMNode 30PM_11 according to the embodiment of the present disclosure. The instance information illustrated in Table 6 is registered (entered) in the Local Graph DB 124_1, for example, in the initial state.

TABLE 6
Entries of PMNode 30PM_11 in initial
state in Local Graph DB 124_1

VNID = Id_PMN#11
isRegardedAs = Id_MEC#11
isVirtualizedWith = Id_VMN#11
PNType = PNType_PMN#11
Address = [null]
Time = [null]
Lat Lon = [null]
Capability = Caps_PMN#11
Credential = Cred_PMN#11
Description = Desc_PMN#11

In the example illustrated in Table 6, the Local Graph DB 124_1 retains an ID (VNID=Id_PMN #11) of the PMNode 30PM_11 as the instance information of the PMNode 30PM_11. When the PMNode 30PM_11 operates as the MEC Server, the Local Graph DB 124_1 retains information concerning the Mec Server (isRegardedAs=Id_MEC #11) and the like. Note that Id_MEC #11 is an identifier for identifying an MEC Server 100_211.

Note that the instance information illustrated in Table 6 is an example. The Local Graph DB 124_1 can retain information other than the information illustrated in Table 6 as the instance information of the PMNode 30PM_11.

### (Instance Information of the PMNode 30PM_21)

Table 7 is a table illustrating entries of the PMNode 30PM_21 in the initial state in the Local Graph DB 124_2. Table 7 illustrates an example of instance information of the PMNode 30PM_21 according to the embodiment of the present disclosure. The instance information illustrated in Table 7 is registered (entered) in the Local Graph DB 124_2, for example, in the initial state.

TABLE 7
Entries of PMNode 30PM_21 in initial
state in Local Graph DB 124_2

VNID = Id_PMN#21
isRegardedAs = Id_MEC#21
isVirtualizedWith = Id_VMN#21
PNType = PNType_PMN#21
Address = [null]
Time = [null]
Lat Lon = [null]
Capability = Caps_PMN#21
Credential = Cred_PMN#21
Description = Desc_PMN#21

In the example illustrated in Table 7, the Local Graph DB 124_2 retains an ID (VNID=Id_PMN #21) of the PMNode 30PM_21 as the instance information of the PMNode 30PM_21. When the PMNode 30PM_21 operates as the MEC Server, the Local Graph DB 124_2 retains information concerning the Mec Server (isRegardedAs=Id_MEC #21) and the like. Note that Id_MEC #21 is an identifier for identifying the MEC Server when the PMNode 30PM_21 operates as the MEC Server.

Note that the instance information illustrated in Table 7 is an example. The Local Graph DB 124_2 can retain information other than the information illustrated in Table 7 as the instance information of the PMNode 30PM_21.

### <5.7. Fixed Node Installation Procedure>

Subsequently, a procedure in which the PNode 30P_11, which is a fixed node, is installed anew in the M2M system via the PSink 20P_11 is explained. Note that, although the installation procedure for the PNode 30P_11 is explained here, other fixed nodes (for example, PNode 30P_21) can be installed in a similar manner.

Table 8 is a table illustrating entries of the PNode 30P_11 in the initial state in the Local Graph DB 124_1. Table 8 illustrates another example of the instance information of the PNode 30P_11 according to the embodiment of the present disclosure.

TABLE 8
Entries of PNode 30P_11 in initial
state in Local Graph DB 124_1

VNID = Id_PN#11
isVirtualizedWith = [null]
isVirtualizedWith = [null]
requestsViaDevApi = [null]
PNType = [null]
Address = [null]
Time = [null]
Lat Lon = [null]
Capability = [null]
Credential = Cred_PN#11
Description = [null]

First, when the PNode 30P_11 is installed in the M2M system, the administrator (user) UA registers the instance information illustrated in Table 8 in the Local Graph DB 124_1.

That is, the administrator UA allocates an Id PN #11, which is an identifier, to the PNode 30P_11. Further, the administrator UA registers a Cred PN #11, which is credit information of the PNode 30P_11, in a Local AAA 135_1.

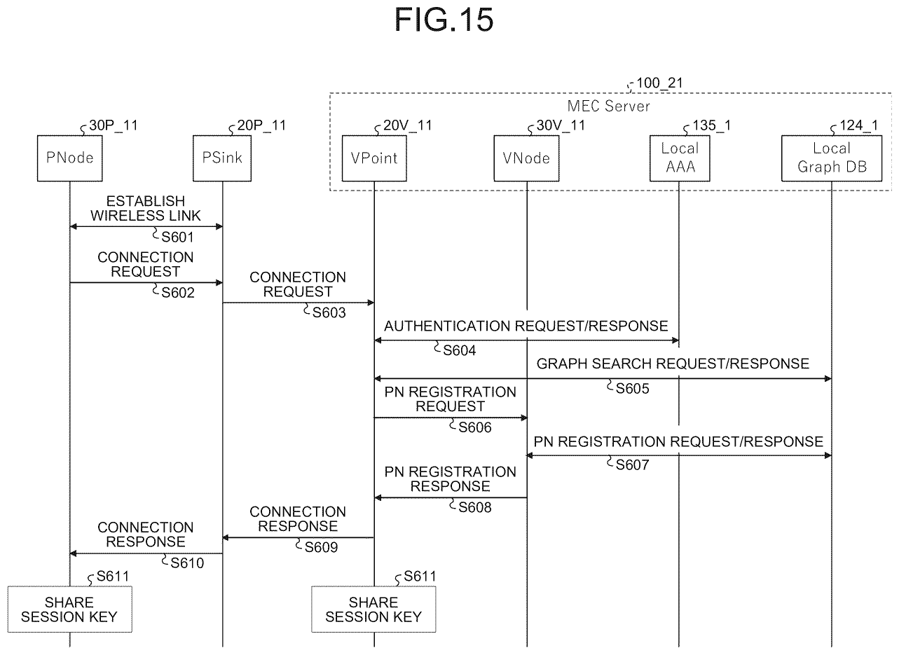

FIG. 15 is a sequence chart illustrating an example of an installation procedure for the fixed node according to the embodiment of the present disclosure. The procedure illustrated in FIG. 15 is executed when the PNode 30P, which is basically a fixed node, is connected to the M2M system first.

First, the PNode 30P_11 establishes a wireless link with the PSink 20P_11 (step S601).

The PNode 30P_11 transmits a connection request message to the PSink 20P_11 that is a virtual module corresponding thereto (step S602).

Table 9 is a table illustrating the connection request message. Table 9 illustrates an example of the connection request message transmitted to the PSink 20P_11 by the PNode 30P_11 according to the embodiment of the present disclosure.

TABLE 9
Connection request message

Type = Connection request
PNID = Id_PN#11
PNType = PNType_PN#11
Time = Time_PN#11
Lat Lon = LatLon_PN#11
Capability = Caps_PN#11
Credential = Cred_PN#11
Home MEC ID = [null]
Description = Desc_PN#11

The connection request message can include, for example, an identifier of the PNode 30P_11 and information concerning a type, a connection time, and the like of the PNode 30P_11. Note that, since the PNode 30P_11 is the fixed node, a Home MEC ID field is blank (Home MEC ID=[null]). Note that the connection request message illustrated here is an example. The PNode 30P_11 can transmit a connection request message including information other than the information illustrated in Table 9 to the PSink 20P_11.

As illustrated in FIG. 15, when receiving the connection request message, the PSink 20P_11 transmits the connection request message to the VPoint 20V_11 that is a virtual module corresponding thereto (step S603).

When receiving the connection request message, the VPoint 20V_11 determines that the PNode 30P_11 is the fixed node because a value of the Home MEC ID field is blank.

The VPoint 20V_11 transmits an authentication request message to the Local AAA 135_1. When authenticity check is successful, the Local AAA 135_1 transmits an authentication response message to the VPoint 20V_11 (step S604).

Table 10 is a table illustrating the authentication request message. Table 10 illustrates an example of the authentication request message transmitted to the Local AAA 135_1 by the VPoint 20V_11.

TABLE 10
Authentication request message

Type = Authentication request
PNID = Id_PN#11
Credential = Cred_PN#11

The authentication request message can include, for example, an identifier of the PNode 30P_11 and credit information of the PNode 30P_11. Note that the authentication request message illustrated here is an example. The VPoint 20V_11 can transmit an authentication request message including information other than the information illustrated in Table 10 to the Local AAA 135_1.

Table 11 is a table illustrating the authentication response message. Table 11 illustrates an example of the authentication response message transmitted to the VPoint 20V_11 by the Local AAA 135_1.

TABLE 11
Authentication response message

Type = Authentication response
PNID = Id_PN#11
Status = OK

The authentication response message can include, for example, an identifier of the PNode 30P_11 and information (Status) concerning an authentication result. Table 11 illustrates an authentication response message in the case in which the authentication is successful. Note that the authentication response message illustrated here is an example. The Local AAA 135_1 can transmit an authentication response message including information other than the information illustrated in Table 11 to the VPoint 20V_11.

As illustrated in FIG. 15, when receiving the authentication response message, the VPoint 20V_11 creates an SKey PN #11 that is a session key indicating that the PNode 30P_11 has already been authenticated.

Subsequently, a graph search request/response is exchanged between the VPoint 20V_11 and the Local Graph DB 124_1 (step S605). The VPoint 20V_11 transmits a graph search request message to the Local Graph DB 124_1 and searches for the VNode 30V corresponding to the PNode 30P_11.

When receiving the graph search request message, the Local Graph DB 124_1 searches through a database for the VNode 30V corresponding to the PNode 30P_11 based on a value of the PNType field and transmits a graph search response message to the VPoint 20V_11. In this example, the VNode 30V_11 is found as the VNode 30V corresponding to the PNode 30P_11.

Table 12 is a table illustrating the graph search request message. Table 12 illustrates an example of the graph search request message transmitted to the Local Graph DB 124_1 by the VPoint 20V_11.

TABLE 12
Graph search request message

Type = Graph search request
Query Type = Node search #1
PNID = Id_PN#11
PNType = PNType_PN#11

The graph search request message can include, for example, an identifier of the PNode 30P_11 and Query Type indicating a type of a data resolution request. Note that the graph search request message illustrated here is an example. The VPoint 20V_11 can transmit a graph search request message including information other than the information illustrated in Table 12 to the Local Graph DB 124_1.

Table 13 is a table illustrating the graph search response message. Table 13 illustrates an example of the graph search response message transmitted to the VPoint 20V_11 by the Local Graph DB 124_1.

TABLE 13
Graph search response message

Type = Graph search response
Query Type = Node search #1
PNID = Id_PN#11
VNID = Id_VN#11

The graph search response message can include, for example, an identifier of the PNode 30P_11 and Query Type indicating a type of a data resolution request. Table 13 illustrates a case in which VNode 30V corresponding to the PNode 30P_11 is the VNode 30V_11 as the graph search result. Note that the graph search response message illustrated here is an example. The Local Graph DB 124_1 can transmit a graph search response message including information other than the information illustrated in Table 13 to the VPoint 20V_11.

Subsequently, the VPoint 20V_11 transmits a PN registration request message to the VNode 30V_11 (step S606). Using the PN registration request message, the VPoint 20V_11 requests the VNode 30V_11 to register the PNode 30P_11.

Table 14 is a table illustrating the PN registration request message. Table 14 illustrates an example of the PN registration request message transmitted to the VNode 30V_11 by the VPoint 20V_11.

TABLE 14
PN registration request message

Type = PN registration request
PNID = Id_PN#11
Address = Addr_PN#11
VNID = Id_VN#11
PSID = Id_PSink#11

The PN registration request message can include, for example, an identifier of the PNode 30P_11 and information concerning a network address of the PNode 30P_11. Note that the PN registration request message illustrated here is an example. The VPoint 20V_11 can transmit a PN registration request message including information other than the information illustrated in Table 14 to the VNode 30V_11.

When receiving the PN registration request message, the VNode 30V_11 recognizes that PNode 30P_11 has been added as a management target of the VNode 30V_11.

Subsequently, a PN registration request/response is exchanged between the VNode 30V_11 and the Local Graph DB 124_1 (step S607).

The VNode 30V_11 transmits the PN registration request message to the Local Graph DB 124_1. When receiving the PN registration request message, the Local Graph DB 124_1 writes information concerning the PNode 30P_11 in the database. Subsequently, the Local Graph DB 124_1 transmits the PN registration response message to the VNode 30V_11. The PN registration request message transmitted by the VNode 30V_11 can be the same as the PN registration request message illustrated in Table 14.

Table 15 is a table illustrating the PN registration response message. Table 15 illustrates an example of the PN registration response message transmitted to the VNode 30V_11 by the Local Graph DB 124_1.

TABLE 15
PN registration response message

Type = PN registration response
PNID = Id_PN#11
Status = OK

The PN registration response message can include, for example, an identifier of the PNode 30P_11 and information (Status) concerning a registration result. Table 15 illustrates the PN registration response message in the case in which the registration is successful. Note that the PN registration response message illustrated here is an example. The Local Graph DB 124_1 can transmit the PN registration response message including information other than the information illustrated in Table 15 to the VNode 30V_11.

As illustrated in FIG. 15, when receiving the PN registration response message, the VNode 30V_11 transmits the PN registration response message to the VPoint 20V_11 (step S608).

When receiving the PN registration response message, the VPoint 20V_11 transmits a connection response message to the PSink 20P_11 (step S609).

Table 16 is a table illustrating the connection response message. Table 16 illustrates an example of the connection response message transmitted to the PSink 20P_11 by the VPoint 20V_11.

TABLE 16
Connection response message

Type = Connection response
Status = OK
PNID = Id_PN#11
Session Key = SKey_PN#11

The connection response message can include, for example, an identifier of the PNode 30P_11 and information (Status) concerning a connection result. Table 16 illustrates the connection response message in the case in which the connection is successful. Note that the connection response message illustrated here is an example. The VPoint 20V_11 can transmit a connection response message including information other than the information illustrated in Table 16 to the PSink 20P_11.

When receiving the connection response message, the PSink 20P_11 transmits the connection response message to the PNode 30P_11 (step S610). The PNode 30P_11 receives the connection response message. As a result, the PNode 30P_11 and the VPoint 20V_11 share the SKey PN #11 that is the session key (step S611).

By executing the procedure illustrated in FIG. 15, the VPoint 20V_11 and the VNode 30V_11 add entries illustrated in Table 17 to the PNode management tables respectively included in the VPoint 20V_11 and the VNode 30V_11. Table 17 is a table illustrating PNode management table entries for the PNode 30P_11.

TABLE 17
PNode management table entries for PNode 30P_11

PNID = Id_PN#11
Address = Addr_PN#11
VNID = Id_VN#11
PSID = Id_PSink#11
Time = Time_PN#11
Session Key = SKey_PN#11

The PNode management table entries can include, for example, an identifier of the PNode 30P_11 and information concerning a network address. Note that the PNode management table entries illustrated here are an example. The VPoint 20V_11 and the VNode 30V_11 can manage the PNode management table entries as PNode management table entries including information other than the information illustrated in Table 17 as the PNode management table entries. The VPoint 20V_11 and the VNode 30V_11 can respectively manage different kinds of information as the PNode management table entries.

In the following explanation, when transmitting sensor data to the VPoint 20V_11 via the PSink 20P_11, the PNode 30P_11 transmits a data notification message including the SKey PN #11. Accordingly, the VPoint 20V_11 can confirm that the PNode 30P_11 has already been authenticated without inquiring the Local AAA 135_1.

The Local Graph DB 124_1 updates the instance information of the PNode 30P_11 illustrated in Table 8 as illustrated in Table 18. Table 18 is a table illustrating entries of the PNode 30P_11 in the Local Graph DB 124_1 after the installation of the PNode 30P_11.

TABLE 18
Entries of PNode 30P_11 in Local Graph
DB124_1 after PNode 30P_11 installation

VNID = Id_PN#11
isVirtualizedWith = Id_VN#11
isVirtualizedWith = Id_VP#11
requests ViaDevApi = Id_PS#11
PNType = PNType_PN#11
Address = Addr_PN#11
Time = Time_PN#11
Lat Lon = LatLon_PN#11
Capability = Caps_PN#11
Credential = Cred_PN#11
Description = Desc_PN#11

In addition, the Local Graph DB 124_1 updates the instance information of the VNode 30V_11 illustrated in Table 3 as illustrated in Table 19. Table 19 is a table illustrating entries of the VNode 30V_11 in the Local Graph DB 124_1 after the installation of the PNode 30P_11.

TABLE 19
Entries of VNode 30V_11 in Local Graph
DB124_1 after PNode 30P_11 installation

VNID = Id_VN#11
isRunningOn = Id_MEC1
requestsViaPrimApi = Id_VP#11
isComposedOf = Id_PN#11
PNType = PNType_VN#11
Address = Addr_VN#11
Capability = Caps_PN#11
Description = Desc_VN#11

The LocalGraph DB 124_1 updates the instance information of the PSink 20P_11 illustrated in Table 1 as illustrated in Table 20. Table 20 is a table illustrating entries of the PSink 20P_11 in the Local Graph DB 124_1 after the installation of the PNode 30P_11.

TABLE 20
Entries of PSink 20P_11 in Local Graph
DB124_1 after PNode 30P_11 installation

PSID = Id_PS#11
isVirtualizedWtih = Id_VP#11
isInstalledIn = Id_Area#1
requestsViaDevApi = Id_PN#11
Address = Addr_PS#11
Lat Lon = LatLon_PS#11
Description = Desc_PS#11

The Local Graph DB 124_1 updates the instance information of the VPoint 20V_11 illustrated in Table 4 as illustrated in Table 21. Table 21 is a table illustrating entries of the VPoint 20V_11 in the Local Graph DB 124_1 after the installation of the PNode 30P_11.

TABLE 21
Entries of VPoint 20V_11 in Local Graph
DB124_1 after PNode 30P_11 installation

VPID = Id_VP#11
isRunningOn = Id_MEC1
isComposedOf = Id_PS#11
isComposedOf = Id_PN#11
respondsViaPrimApi = Id_VN#11
Address = Addr_VP#11
Lat Lon = LatLon_PN#11
Description = Desc_VP#11

It is assumed that a PNode 30P_12 is present near a PNode 30P_11 and the PNode 30P_11 and the PNode 30P_12 have the same PNType. In this case, the same processing as the processing illustrated in FIG. 15 is executed when the PNode 30P_12 is connected. At this time, since the PNode 30P_11 and the PNode 30P_12 have the same PNType, as a result of step S605, the VNode 30V_11 is selected as a virtual module of the PNode 30P_12. As explained above, for example, a plurality of PNodes 30P having the same PNType can be associated with one VNode 30V.

Further, when the PMNode 30PM_11, which is a mobile node, is connected to the PSink 20P_11 subordinate to the Home MEC Server, the procedure illustrated in FIG. 15 is executed in the same manner. The mobile node 30PM executes this procedure every time the PSink 20P_11 at a connection destination changes.

As a result of this procedure, the VPoint 20V_11 and the VNode 30V_11 add entries illustrated in Table 22 to the PNode management tables included in the VPoint 20V_11 and the VNode 30V_11. Table 22 is a table illustrating PNode management table entries for the PMNode 30PM_11.

TABLE 22
PNode management table entries for PMNode 30PM_11

PNID = Id_PMN#11
Address = Addr_PMN#11
VNID = Id_VMN#11
PSID = Id_PSink#11
Time = Time_PMN#11
Session Key = SKey_PMN#11

The PNode management table entries can include, for example, an identifier of the PMNode 30PM_11 and information concerning a network address. Note that the PNode management table entries illustrated here are an example. The VPoint 20V_11 and the VNode 30V_11 can manage the PNode management table entries as PNode management table entries including information other than the information illustrated in Table 22 as PNode management table entries. The VPoint 20V_11 and the VNode 30V_11 can respectively manage different kinds of information as the PNode management table entries.

As a result, the VPoint 20V_11 and the VNode 30V_11 recognize that the PMNode 30PM_11 is currently connected to the PSink 20P_11.

While the PMNode 30PM_11 is connected to the PSink 20P_11, a session key is shared between the PMNode 30PM_11 and the VPoint 20V_11. Accordingly, when the PMNode 30PM_11 transmits sensor data, the VPoint 20V_11 can confirm that the PMNode 30PM_11 has already been authenticated without inquiring the Local AAA 135_1.

The Local Graph DB 124_1 updates the instance information of the PMNode 30PM_11 illustrated in Table 6 as illustrated in Table 23. Table 23 is a table illustrating entries of the PMNode 30PM_11 in the Local Graph DB 124_1 after the PMNode 30PM_11 connection.

TABLE 23
Entries of PMNode 30PM_11 in Local Graph
db124_1 after PMNode 30PM_11 connection

VNID = Id_PMN#11
isRegardedAs = Id_MEC#11
isVirtualizedWith = Id_VMN#11
isVirtualizedWith = Id_VP#11
respondsViaDevApi = Id_PS#11
PNType = PNType_PMN#11
Address = Addr_PMN#11
Time = Time_PMN#11
Lat Lon = LatLon_PMN#11
Capability = Caps_PMN#11
Credential = Cred_PMN#11
Description = Desc_PMN#11

For example, the Local Graph DB 124_1 adds information concerning PSink 20P_11 to which the PMNode 30PM_11 is connected (for example, respondsViaDevApi=Id_PS #11) to the instance information of the PMNode 30PM_11. For example, the Local Graph DB 124_1 adds information concerning the VPoint 20V_11 corresponding to the PSink 20P_11 (for example, isVirtualizedWith=Id_VP #11) to the instance information of the PMNode 30PM_11. The Local Graph DB 124_1 updates a blank field (for example, the Time field or the Lat Lon field).

The Local Graph DB 124_1 updates the instance information of the PSink 20P_11 illustrated in Table 20 as illustrated in Table 24. Table 24 is a table illustrating entries of the PSink 20P_11 in the Local Graph DB 124_1 after the PMNode 30PM_11 connection.

TABLE 24
Entries of PSink 20P_11 in Local Graph
DB124_1 after PMNode 30PM_11 connection

PSID = Id_PS#11
isVirtualizedWtih = Id_VP#11
isInstalledIn = Id_Area1
requestsViaDevApi = Id_PN#11
requestsViaDevApi = Id_PMN#11
Address = Addr_PS#11
Lat Lon = LatLon_PS#11
Description = Desc_PS#11

For example, the Local Graph DB 124_1 updates a field (for example, the requestsViaDevApi field) that is blank in the instance information of the PSink 20P_11. For example, the Local Graph DB 124_1 adds information concerning the physical node 30 (the PMNode 30PM_11 and the PNode 30P_11) connected to the PSink 20P_11.

The Local Graph DB 124_1 updates the instance information of the VPoint 20V_11 illustrated in Table 21 as illustrated in Table 25. Table 25 is a table illustrating entries of the VPoint 20V_11 in the Local Graph DB 124_1 after the PMNode 30PM_11 connection.

TABLE 25
Entries of VPoint 20V_11 in Local Graph
DB124_1 after PMNode 30PM_11 connection

VPID = Id_VP#11
isRunningOn = Id_MEC1
isComposedOf = Id_PS#11
isComposedOf = Id_PN#11
isComposedOf = Id_PMN#11
respondsViaPrimApi = Id_VN#11
respondsViaPrimApi = Id_VMN#11
Address = Addr_VP#11
Lat Lon = LatLon_PS#11
Lat Lon = LatLon_PN#11
Lat Lon = LatLon_PMN#11
Description = Desc_VP#11

For example, the Local Graph DB 124_1 adds information concerning the physical node 30 (the PMNode 30PM_11 and the PNode 30P_11) connected to the PSink 20P_11 corresponding to the VPoint 20V_11 to the instance information of the VPoint 20V_11.

As a result, the Local Graph DB 124_1 recognizes that the PMNode 30PM_11 is currently connected to the PSink 20P_11.

<5.8. Connection Procedure for the Mobile Node (Other than Home MEC Server)>

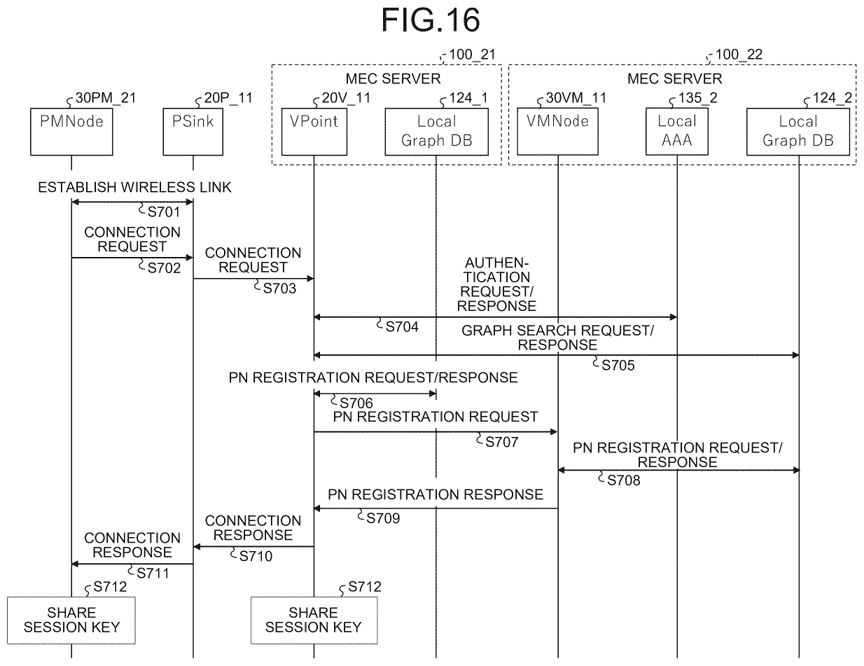

Subsequently, FIG. 16 is a sequence chart illustrating an example of a mobile node connection procedure according to the embodiment of the present disclosure. Here, a procedure in which the PMNode 30PM_21, which is a mobile node, is connected to the PSink 20P_11 is explained.

Since the Home MEC Server of the PMNode 30PM_21 is the MEC Server 100_22, the example illustrated in FIG. 16 indicates a procedure at the time when the mobile node is connected to other than the Home MEC Server. The mobile node executes the procedure illustrated in FIG. 16 every time the PSink 20P to be connected changes.

The PMNode 30PM_21 establishes a wireless link with the PSink 20P_11 (step S701).

The PMNode 30PM_21 transmits a connection request message to the PSink 20P_11 (step S702).

Table 26 is a table illustrating the connection request message. Table 26 illustrates an example of the connection request message transmitted to the PSink 20P_11 by the PMNode 30PM_21 according to the embodiment of the present disclosure.

TABLE 26
Connection request message

Type = Connection request
PNID = Id_PMN#21
PNType = PNType_PMN#21
Time = Time_PMN#21
Lat Lon = LatLon_PMN#21
Capability = Caps_PMN#21
Credential = Cred_PMN#21
Home MEC ID = Id_MEC#2
Description = Desc_PMN#21

The connection request message can include, for example, an identifier of the PMNode 30PM_21 and information concerning a type, a connection time, and the like of the PMNode 30PM_21. Note that, since the PMNode 30PM_21 is the mobile node, the Home MEC ID field includes information indicating the MEC Server 100_22 that is the Home MEC Server.

Note that the connection request message illustrated here is an example. The PMNode 30PM_21 can transmit a connection request message including information other than the information illustrated in Table 26 to the PSink 20P_11.

When receiving the connection request message, the PSink 20P_11 transmits the connection request message to the VPoint 20V_11 that is a virtual module corresponding thereto (step S703).

When the VPoint 20V_11 receives the connection request message, an authentication request/response is exchanged between the VPoint 20V_11 and a Local AAA 135_2 (step S704).

Specifically, the VPoint 20V_11 transmits an authentication request message to the Local AAA 135_2 because a value of the Home MEC ID field of the received connection request message indicates an identifier of the MEC Server 100_22.

Table 27 is a table illustrating the authentication request message. Table 27 illustrates an example of the authentication request message transmitted to the Local AAA 135_2 by the VPoint 20V_11.

TABLE 27
Authentication request message

Type = Authentication request
PNID = Id_PMN#21
Credential = Cred_PMN#21

The authentication request message can include, for example, an identifier of the PMNode 30PM_21 and credit information of the PMNode 30PM_21. Note that the authentication request message illustrated here is an example. The VPoint 20V_11 can transmit an authentication request message including information other than the information illustrated in Table 27 to the Local AAA 135_2.

When receiving the authentication request message, the Local AAA 135_2 uses content of the Credential field to confirm authenticity of the PMNode 30PM_21 indicated by the PNID field. When the authenticity check is successful, the Local AAA 135_2 transmits an authentication response message to the VPoint 20V_11.

Table 28 is a table illustrating the authentication response message. Table 28 illustrates an example of the authentication response message transmitted to the VPoint 20V_11 by the Local AAA 135_2.

TABLE 28
Authentication response message

Type = Authentication response
PNID = Id_PMN#21
Status = OK

The authentication response message can include, for example, an identifier of the PMNode 30PM_21 and information (Status) concerning an authentication result. Table 28 illustrates an authentication response message in the case in which the authentication is successful. Note that the authentication response message illustrated here is an example. The Local AAA 135_2 can transmit an authentication response message including information other than the information illustrated in Table 28 to the VPoint 20V_11.

As illustrated in FIG. 16, when receiving the authentication response message, the VPoint 20V_11 creates an SKey PN #21 that is a session key indicating that the PMNode 30PM_21 has already been authenticated.

Subsequently, a graph search request/response is exchanged between the VPoint 20V_11 and the Local Graph DB 124_2 (step S705). The VPoint 20V_11 transmits a graph search request message to the Local Graph DB 124_2 and searches for the VNode 30V corresponding to the PMNode 30PM_21.

Table 29 is a table illustrating the graph search request message. Table 29 illustrates an example of the graph search request message transmitted to the Local Graph DB 124_2 by the VPoint 20V_11.

TABLE 29
Graph search request message

Type = Graph search request
Query Type = Node search #1
PNID = Id_PMN#21
PNType = PNType_PMN#21

The graph search request message can include, for example, an identifier of the PMNode 30PM_21 and a Query Type indicating a type of a data resolution request. Note that the graph search request message illustrated here is an example. The VPoint 20V_11 can transmit a graph search request message including information other than the information illustrated in Table 29 to the Local Graph DB 124_2.

When receiving the graph search request message, the Local Graph DB 124_2 searches through a database for the VNode 30V corresponding to the PMNode 30PM_21 based on a value of the PNType field and transmits a graph search response message to the VPoint 20V_11. In this example, the VMNode 30VM_21 is found as the VNode 30V corresponding to the PMNode 30PM_21.

Table 30 is a table illustrating the graph search response message. Table 30 illustrates an example of the graph search response message transmitted to the VPoint 20V_11 by the Local Graph DB 124_2.

TABLE 30
Graph search response message

Type = Graph search response
Query Type = VNode search 1
PNID = Id_PMN#21
VNID = Id_VMN#21

The graph search response message can include, for example, an identifier of the PMNode 30PM_21 and a Query Type indicating a type of a data resolution request. Table 30 illustrates a case in which, as a result of the graph search, the VNode 30V corresponding to the PMNode 30PM_21 is the VMNode 30VM_21. Note that the graph search response message illustrated here is an example. The Local Graph DB 124_2 can transmit a graph search response message including information other than the information illustrated in Table 30 to the VPoint 20V_11.

As a result of this exchange, it is seen that the VNode 30V corresponding to the PMNode 30PM_21 is the VMNode 30VM_21. In other words, the VPoint 20V_11 transmits the graph search request message to the Local Graph DB 124_2 to notify the VMNode 30VM_21 that the PMNode 30PM_21 is connected to the PSink 20P_11.

Subsequently, a PN registration request/response is exchanged between the VPoint 20V_11 and the Local Graph DB 124_1 (step S706). Specifically, the VPoint 20V_11 transmits a PN registration request message to the Local Graph DB 124_1.

Table 31 is a table illustrating the PN registration request message. Table 31 illustrates an example of the PN registration request message transmitted to the Local Graph DB 124_1 by the VPoint 20V_11.

TABLE 31
PN registration request message

Type = PN registration request
PNID = Id_PMN#21
Address = Addr_PMN#21
VNID = Id_VMN#21
PSID = Id_PSink#11

The PN registration request message can include, for example, an identifier of the PMNode 30PM_21 and information concerning a network address of the PMNode 30PM_21. Note that the PN registration request message illustrated here is an example. The VPoint 20V_11 can transmit a PN registration request message including information other than the information illustrated in Table 31 to the Local Graph DB 124_1.

When receiving the PN registration request message, the Local Graph DB 124_1 writes information concerning the PMNode 30PM_21 in the database. Subsequently, the Local Graph DB 124_1 transmits the PN registration response message to the VPoint 20V_11.

Table 32 is a table illustrating the PN registration response message. Table 32 illustrates an example of the PN registration response message transmitted to the VPoint 20V_11 by the Local Graph DB 124_1.

TABLE 32
PN registration response message

Type = PN registration response
PNID = Id_PMN#21
Status = OK

The PN registration response message can include, for example, an identifier of the PMNode 30PM_21 and information (Status) concerning a registration result. Table 32 illustrates a PN registration response message in the case in which the registration is successful. Note that the PN registration response message illustrated here is an example. The Local Graph DB 124_1 can transmit a PN registration response message including information other than the information illustrated in Table 32 to the VPoint 20V_11.

Subsequently, the VPoint 20V_11 transmits a PN registration request message to the VMNode 30VM_21 (step S707). The PN registration request message can be the same message as the message illustrated in Table 31. When receiving the PN registration request message, the VMNode 30VM_21 recognizes that the PMNode 30PM_21 has been added as a management target of the VMNode 30VM_21.

A PN registration request/response is exchanged between the VMNode 30VM_21 and the Local Graph DB 124_2 (step S708). The VMNode 30VM_21 transmits the PN registration request message to the Local Graph DB 124_2. The PN registration request message transmitted by the VMNode 30VM_21 can be the same as the PN registration request message illustrated in Table 31.

When receiving the PN registration request message, the Local Graph DB 124_2 writes information concerning the VMNode 30VM_21 in the database. The Local Graph DB 124_2 transmits a PN registration response message to the VMNode 30VM_21. The PN registration response message transmitted by the Local Graph DB 124_2 can be the same as the PN registration request message illustrated in Table 32.

When receiving the PN registration response message, the VMNode 30VM_21 transmits the PN registration response message to the VPoint 20V_11 (step S709).

When receiving the PN registration response message, the VPoint 20V_11 transmits a connection response message to the PSink 20P_11 (step S710).

Table 33 is a table illustrating the connection response message. Table 33 illustrates an example of the connection response message transmitted to the PSink 20P_11 by the VPoint 20V_11.

TABLE 33
Connection response message

Type = Connection response
Status = OK
PNID = Id_PMN#21
Session Key = SKey_PMN#21

The connection response message can include, for example, an identifier of the PMNode 30PM_21 and information (Status) concerning a connection result. Table 33 illustrates a connection response message in the case in which the connection is successful. Note that the connection response message illustrated here is an example. The VPoint 20V_11 can transmit a connection response message including information other than the information illustrated in Table 33 to the PSink 20P_11.

When receiving the connection response message, the PSink 20P_11 transmits the connection response message to the PMNode 30PM_21 (step S711). The PMNode 30PM_21 receives the connection response message. As a result, the PMNode 30PM_21 and the VPoint 20V_11 share a SKey PN #12 that is a session key (step S712).

By executing the procedure illustrated in FIG. 16, the VPoint 20V_11 and the VMNode 30VM_21 add entries illustrated in Table 34 to the PNode management tables respectively included in the VPoint 20V_11 and the VMNode 30VM_21. Table 34 is a table illustrating PNode management table entries for the PMNode 30PM_21.

TABLE 34
PNode management table entries for PMNode 30PM_21

PNID = Id_PMN#21
Address = Addr_PMN#21
VNID = Id_VMN#21
PSID = Id_PSink#11
Time = Time_PMN#21
Session Key = SKey_PMN#21

The PNode management table entries can include, for example, an identifier of the PMNode 30PM_21 and information concerning a network address. Note that the PNode management table entries illustrated here are an example. The VPoint 20V_11 and the VMNode 30VM_21 can manage the PNode management table entries as PNode management table entries including information other than the information illustrated in Table 34 as the PNode management table entries. The VPoint 20V_11 and the VMNode 30VM_21 can respectively manage different kinds of information as the PNode management table entries.

By executing the procedure illustrated in FIG. 16, the VPoint 20V_11 and the VMNode 30VM_21 recognize that the PMNode 30PM_21 is currently connected to the PSink 20P_11.

When transmitting sensor data to the VPoint30P_11 via the PSink 20P_11, the PMNode 30PM_21 transmits a data notification message including the SKey PN #21. Accordingly, the VPoint30P_11 can confirm that the PMNode 30PM_21 has already been authenticated without inquiring the Local AAA 135_2.

The Local Graph DB 124_2 updates the instance information of the PMNode 30PM_21 illustrated in Table 7 as illustrated in Table 35. Table 35 is a table illustrating entries of the PMNode 30PM_21 in the Local Graph DB 124_2 after the PMNode 30PM_21 connection.

TABLE 35
Entries of PMNode 30PM_21 in Local Graph
DB124_2 after PMNode 30PM_21 connection

VNID = Id_PMN#21
isRegardedAs = Id_MEC#21
isVirtualizedWith = Id_VMN#21
isVirtualizedWith = Id_VP#11
respondsWithDevApi = Id_PS#11
PNType = PNType_PMN#21
Address = Addr_PMN#21
Time = Time_PMN#21
Lat Lon = LatLon_PMN#21
Capability = Caps_PMN#21
Credential = Cred_PMN#21
Description = Desc_PMN#21

For example, the Local Graph DB 124_2 adds information concerning the PSink 20P_11 to which the PMNode 30PM_21 is connected (for example, respondsViaDevApi=Id_PS #11) to the instance information of the PMNode 30PM_21. For example, the Local Graph DB 124_2 adds information concerning the VPoint 20V_11 corresponding to the PSink 20P_11 (for example, isVirtualizedWith=Id_VP #11) to the instance information of the PMNode 30PM_21. The Local Graph DB 124_2 updates a blank field (for example, the Time field or the Lat Lon field).

The Local Graph DB 124_1 updates the instance information of the PSink 20P_11 illustrated in Table 24 as illustrated in Table 36. Table 36 is a table illustrating entries of the PSink 20P_11 in the Local Graph DB 124_1 after the PMNode 30PM_21 connection.

TABLE 36
Entries of PSink 20P_11 in Local Graph
DB124_1 after PMNode 30PM_21 connection

PSID = Id_PS#11
isVirtualizedWtih = Id_VP#11
isInstalledIn = Id_Area#1
requestsViaDevApi = Id_PN#11
requestsViaDevApi = Id_PMN#11
requestsViaDevApi = Id_PMN#21
Address = Addr_PS#11
Lat Lon = LatLon_PS#11
Description = Desc_PS#11

For example, the Local Graph DB 124_1 adds information concerning the PMNode 30PM_21 connected to the PSink 20P_11 to the instance information of the PSink 20P_11.

The Local Graph DB 124_1 updates the instance information of the VPoint 20V_11 illustrated in Table 25 as illustrated in Table 37. Table 37 is a table illustrating entries of the VPoint 20V_11 in the Local Graph DB 124_1 after the PMNode 30PM_21 connection.

TABLE 37
Entries of VPoint 20V_11 in Local Graph
DB124_1 after PMNode 30PM_21 connection

VPID = Id_VP#11
isRunningOn = Id_MEC1
isComposedOf = Id_PS#11
isComposedOf = Id_PN#11
isComposedOf = Id_PMN#11
isComposedOf = Id_PMN#21
respondsViaPrimApi = Id_VN#11
respondsViaPrimApi = Id_VMN#11
respondsViaPrimApi = Id_VMN#21
Address = Addr_VP#11
Lat Lon = LatLon_PS#11
Lat Lon = LatLon_PN#11
Lat Lon = LatLon_PMN#11
Lat Lon = LatLon_PMN#21
Description = Desc_VP#11

For example, the Local Graph DB 124_1 adds information concerning the PMNode 30PM_21 connected to the PSink 20P_11 corresponding to the VPoint 20V_11 to the instance information of the VPoint 20V_11.

<5.9. Mobile Node Disconnection Procedure (Other than the Home MEC Server)>

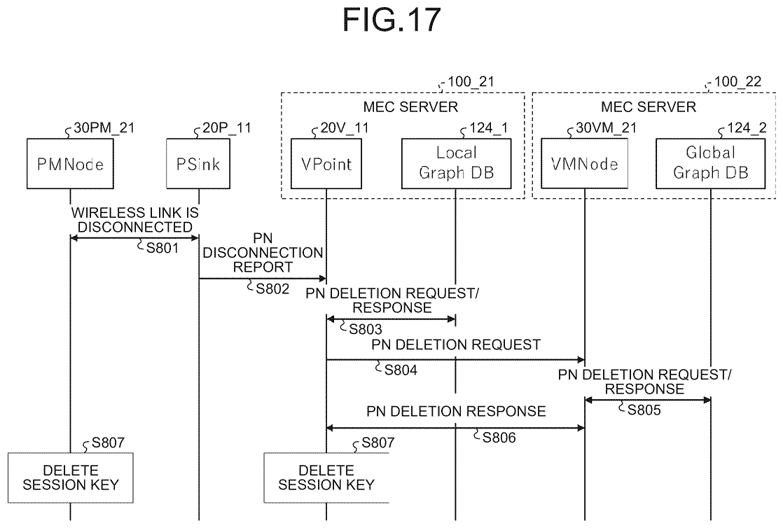

FIG. 17 is a sequence chart illustrating an example of a mobile node disconnection procedure according to the embodiment of the present disclosure. Here, a procedure in which the PMNode 30PM_21, which is a mobile node, is disconnected from the PSink 20P_11 subordinate to other than the Home MEC Server is explained.

Since the PMNode 30PM_21 has moved and left a wireless communication range of the PSink 20P_11, a wireless link between the PMNode 30PM_21 and the PSink 20P_11 is disconnected (step S801).

The PSink 20P_11 detects the wireless link disconnection from the PMNode 30PM_21 and transmits a PN disconnection report message to the VPoint 20V_11 (step S802). Table 38 is a table illustrating the PN disconnection report message. Table 38 illustrates an example of the PN disconnection report message transmitted to the VPoint 20V_11 by the PSink 20P_11 according to the embodiment of the present disclosure.

TABLE 38
PN disconnection report message

Type = PN disconnection report
PNID = Id_PMN#21

The PN disconnection report message can include, for example, an identifier of the PMNode 30PM_21. Note that the PN disconnection report message illustrated here is an example. The PSink 20P_11 can transmit a PN disconnection report message including information other than the information illustrated in Table 38 to the VPoint 20V_11.

When receiving the PN disconnection report message, the VPoint 20V_11 recognizes that the PMNode 30PM_21 has left the subordinate thereto. Subsequently, the VNode 30V_11 exchanges a PN deletion request/response with the Local Graph DB 124_1 (step S803).

Specifically, the VPoint 20V_11 transmits a PN deletion request message to the Local Graph DB 124_1. Table 39 is a table illustrating the PN deletion request message. Table 39 illustrates an example of the PN deletion request message transmitted to the Local Graph DB 124_1 by the VPoint 20V_11 according to the embodiment of the present disclosure.

TABLE 39
PN deletion request message

Type = PN deletion request
PNID = Id_PMN#21
VNID = Id_VMN#21

The PN deletion request message can include, for example, an identifier of the PMNode 30PM_21 and an identifier of the VMNode 30VM_21 corresponding to the PMNode 30PM_21. Note that the PN deletion request message illustrated here is an example. The VPoint 20V_11 can transmit a PN deletion request message including information other than the information illustrated in Table 39 to the Local Graph DB 124_1.

When receiving the PN deletion request message, the Local Graph DB 124_1 deletes information concerning the PMNode 30PM_21 from the database. Subsequently, the Local Graph DB 124_1 transmits a PN deletion response message to the VPoint 20V_11.

Table 40 is a table illustrating the PN deletion response message. Table 40 illustrates an example of the PN deletion response message transmitted to the VPoint 20V_11 by the Local Graph DB 124_1.

TABLE 40
PN deletion response message

Type = PN deletion response
PNID = Id_PMN#21
Status = OK

The PN deletion response message can include, for example, an identifier of the PMNode 30PM_21 and information (Status) concerning a deletion result. Table 40 illustrates a PN deletion response message in the case in which the deletion is successful. Note that the PN deletion response message illustrated here is an example. The Local Graph DB 124_1 can transmit a PN deletion response message including information other than the information illustrated in Table 40 to the VPoint 20V_11.

Subsequently, the VPoint 20V_11 transmits the PN deletion request message to the VMNode 30VM_21 (step S804). The PN deletion request message can be the same message as the message illustrated in Table 39. When receiving the PN deletion request message, the VMNode 30VM_21 recognizes that the PMNode 30PM_21 has left the communication range of the PSink 20P_11.

Subsequently, a PN deletion request/response is exchanged between the VMNode 30VM_21 and the Local Graph DB 124_2 (step S805). The VMNode 30VM_21 transmits the PN deletion request message to the Local Graph DB 124_2. The PN deletion request message transmitted by the VMNode 30VM_21 can be the same as the PN deletion request message illustrated in Table 39.

When receiving the PN deletion request message, the Local Graph DB 124_2 deletes information concerning the VMNode 30VM_21 from the database. The Local Graph DB 124_2 transmits a PN deletion response message to the VMNode 30VM_21. The PN deletion response message transmitted by the Local Graph DB 124_2 can be the same as the PN deletion request message illustrated in Table 40.

When receiving the PN deletion response message, the VMNode 30VM_21 transmits the PN deletion response message to the VPoint 20V_11 (step S806).

When receiving the PN deletion response message, the VPoint 20V_11 deletes a SKey PMN #21 that is a session key shared with the PMNode 30PM_21. Similarly, the PMNode 30PM_21 also deletes the SKey PMN #21 that is the session key shared with the VPoint 20V_11. Accordingly, the session key is deleted from the VPoint 20V_11 and the PMNode 30PM_21 (step S807).

When the procedure illustrated in FIG. 17 is executed, the VPoint 20V_11 and the VMNode 30VM_21 delete the entries of the PNode management table illustrated in Table 34.

The Local Graph DB 124_1 updates the instance information of the PSink 20P_11 illustrated in Table 36 as illustrated in Table 24. The LocalGraph DB 124_1 updates the instance information of the VPoint 20V_11 illustrated in Table 37 as illustrated in Table 25. The Local Graph DB 124_2 updates the instance information of the PMNode 30PM_21 illustrated in Table 35 as illustrated in Table 7.

As a result, the VPoint 20V_11 and the Local Graph DB 124_1 do not retain the management information of the PMNode 30PM_21. As a result, the PMNode 30PM_21 is removed from the control of the M2M system until the PMNode 30PM_21 is connected to the PSink 20P next.

### <5.10. Mobile Node Disconnection Procedure (the Home Mec Server)>

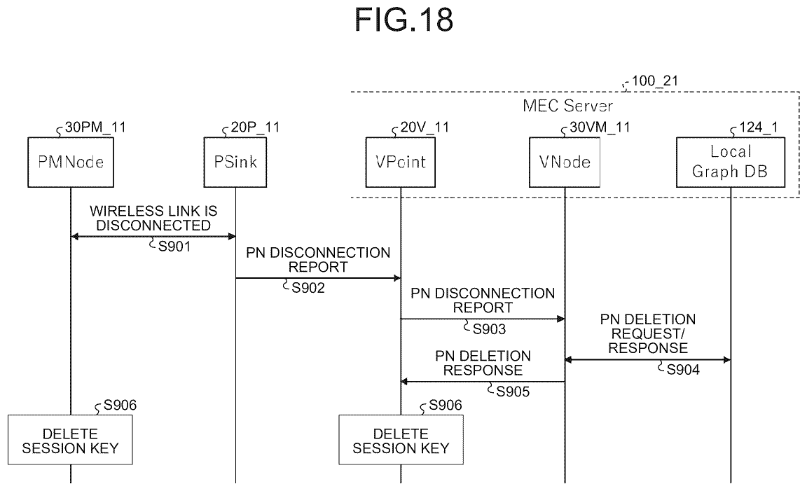

FIG. 18 is a sequence chart illustrating another example of the mobile node disconnection procedure according to the embodiment of the present disclosure. Here, a procedure in which the PMNode 30PM_11, which is a mobile node, is disconnected from the PSink 20P_11 subordinate to the Home MEC Server is explained.

Since the PMNode 30PM_11 has moved and left the wireless communication range of the PSink 20P_11, the wireless link between the PMNode 30PM_21 and the PSink 20P_11 is disconnected (step S901).

The PSink 20P_11 detects the wireless link disconnection from the PMNode 30PM_11 and transmits a PN disconnection report message to the VPoint 20V_11 (step S902). Table 41 is a table illustrating the PN disconnection report message. Table 41 illustrates an example of the PN disconnection report message transmitted to the VPoint 20V_11 by the PSink 20P_11 according to the embodiment of the present disclosure.

TABLE 41
PN disconnection report message

Type = PN disconnection report
PNID = Id_PMN#11

The PN disconnection report message can include, for example, an identifier of the PMNode 30PM_11. Note that the PN disconnection report message illustrated here is an example. The PSink 20P_11 can transmit a PN disconnection report message including information other than the information illustrated in Table 41 to the VPoint 20V_11.

The VPoint 20V_11 transmits a PN deletion request message to the VNode 30V_11 (step S903). Table 42 is a table illustrating the PN deletion request message. Table 42 illustrates an example of the PN deletion request message transmitted to the VNode 30V_11 by the VPoint 20V_11 according to the embodiment of the present disclosure.

TABLE 42
PN deletion request message

Type = PN deletion request
PNID = Id_PMN#11
VNID = Id_VMN#11

The PN deletion request message can include, for example, an identifier of the PMNode 30PM_11 and an identifier of the VNode 30V_11 corresponding to the PMNode 30PM_11. Note that the PN deletion request message illustrated here is an example. The VPoint 20V_11 can transmit a PN deletion request message including information other than the information illustrated in Table 42 to the VNode 30V_11.

When receiving the PN deletion request message, the VNode 30V_11 recognizes that the PMNode 30PM_11 has left the subordinate thereto. Subsequently, the VNode 30V_11 exchanges a PN deletion request/response with the Local Graph DB 124_1 (step S904).

Specifically, the VNode 30V_11 transmits the PN deletion request message to the Local Graph DB 124_1. The PN deletion request message can be the same message as the message illustrated in Table 42.

When receiving the PN deletion request message, the Local Graph DB 124_1 deletes information concerning the PMNode 30PM_11 from the database. Subsequently, the Local Graph DB 124_1 transmits a PN deletion response message to the VNode 30V_11.

Table 43 is a table illustrating the PN deletion response message. Table 43 illustrates an example of the PN deletion response message transmitted to the VNode 30V_11 by the Local Graph DB 124_1.

TABLE 43
PN deletion response message

Type = PN deletion response
PNID = Id_PMN#11
Status = OK

The PN deletion response message can include, for example, an identifier of the PMNode 30PM_11 and information (Status) concerning a deletion result. Table 43 illustrates a PN deletion response message in the case in which the deletion is successful. Note that the PN deletion response message illustrated here is an example. The Local Graph DB 124_1 can transmit a PN deletion response message including information other than the information illustrated in Table 43 to the VNode 30V_11.

When receiving the PN deletion response message, the VNode 30V_11 transmits the PN deletion response message to the VPoint 20V_11 (step S905).

When receiving the PN deletion response message, the VPoint 20V_11 deletes the SKey PMN #21 that which is the session key shared with the PMNode 30PM_11. Similarly, the PMNode 30PM_11 also deletes the SKey PMN #21 that is the session key shared with the VPoint 20V_11. Accordingly, the session key is deleted from the VPoint 20V_11 and the PMNode 30PM_11 (step S906).

When the procedure illustrated in FIG. 18 is executed, the VPoint 20V_11 and the VNode 30V_11 delete the entries of the PNode management table illustrated in Table 22.

The Local Graph DB 124_1 updates the instance information of the PMNode 30PM_11 illustrated in Table 23 as illustrated in Table 6. The Local Graph DB 124_1 updates the instance information of the PSink 20P_11 illustrated in Table 24 as illustrated in Table 20. The Local Graph DB 124_1 updates the instance information of the VPoint 20V_11 illustrated in Table 25 as illustrated in Table 21.

As a result, the PMNode 30PM_11 is removed from the control of the M2M system until the PMNode 30PM_11 is connected to the PSink 20P next.

<5.11. Sensor Data Registration Procedure from the Fixed Node>

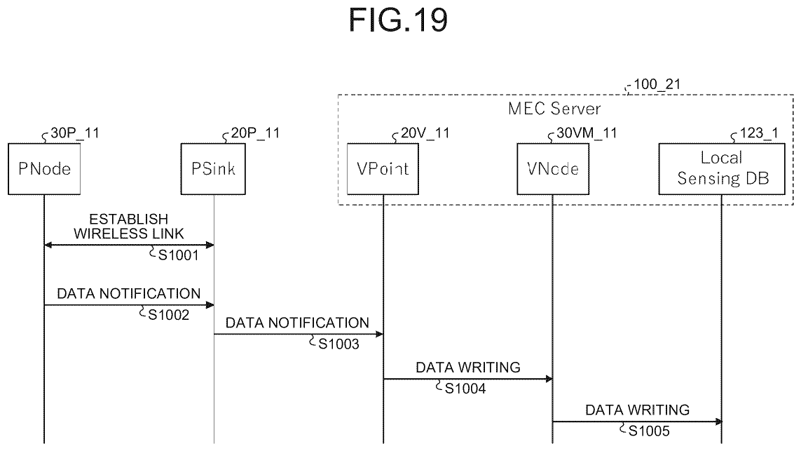

FIG. 19 is a sequence chart illustrating an example of a data registration procedure for registering sensor data from the fixed node according to the embodiment of the present disclosure. Here, a procedure in which the PNode 30P_11, which is the fixed node, registers sensor data in the MEC Server 100_21 is explained.

The PNode 30P_11 establishes a wireless link with the PSink 20P_11 that is a physical sink (step S1001). The PNode 30P_11 transmits a data notification message to the PSink 20P_11 (step S1002).

Table 44 is a table illustrating the data notification message. Table 44 illustrates an example of a data notification message transmitted to the PSink 20P_11 by the PNode 30P_11 according to the embodiment of the present disclosure.

TABLE 44
Data notification message

Type = Data notification
PNID = Id_PN#11
Session Key = SKey_PN#11
Time = Time_PN#11_D
Data = Data_PN#11

The data notification message can include, for example, an identifier of the PNode 30P_11 and information (the Session Key field) concerning a session key. Note that the data notification message illustrated here is an example. The PNode 30P_11 can transmit a data notification message including information other than the information illustrated in Table 44 to the PSink 20P_11.

The PSink 20P_11 transmits the data notification message to the VPoint 20V_11 that is a virtual module corresponding thereto (step S1003). The data notification message can be the same message as the message illustrated in Table 44.

When receiving the data notification message, the VPoint 20V_11 recognizes, from a value of the Session Key field, that the PNode 30P_11 has already been authenticated and transmits a data write message to the VNode 30V_11 (step S1004).

Table 45 is a table illustrating the data write message. Table 45 illustrates an example of the data write message transmitted to the VNode 30V_11 by the VPoint 20V_11 according to the embodiment of the present disclosure.

TABLE 45
Data writing message

Type = Data writing
PNID = Id_PN#11
VNID = Id_VN#11
PSID = Id_PSink#11
VPID = Id_VP#11
Time = Time_PN#11_D
Data = Data_PN#11

The data write message can include, for example, an identifier of the PNode 30P_11, an identifier of the VNode 30V_11, and information (the Data field) concerning sensing data. Note that the data write message illustrated here is an example. The VPoint 20V_11 can transmit a data write message including information other than the information illustrated in Table 45 to the VNode 30V_11.

When receiving the data notification message, the VNode 30V_11 transmits a data write message to a Local Sensing DB 123_1 (step S1005). When receiving the data write request message, the Local Sensing DB 123_1 writes content of the Data field in a database.

When the procedure illustrated in FIG. 19 is executed, the Local Sensing DB 123_1 adds entries illustrated in Table 46 to the database. Table 46 is a table illustrating sensor data entries of the PNode 30P_11.

TABLE 46
Sensor data entries of PNode 30P_11

PNID = Id_PN#11
VNID = Id_VN#11
VSID = Id_PSink#11
VPID = Id_VP#11
Capability = Caps_PN#11
Time = Time_PN#11_D
Data = Data_PN#11

The sensor data entries can include, for example, an identifier of PNode 30P_11 and information concerning sensor data. Note that the sensor data entries illustrated here are an example. The Local Sensing DB 123_1 can manage the sensor data entries as sensor data entries including information other than the information illustrated in Table 46 as the sensor data entries.

In addition, the VNode 30V_11 may also retain the sensor data entries as a cache.

Note that, also when the PMNode 30PM_11, which is a mobile node, registers data via the PSink 20P_11 subordinate to the Home MEC Server, the same procedure as the procedure illustrated in FIG. 19 is executed.

<5.12. Sensor Data Registration Procedure from the Mobile Node (Other than the Home MEC Server)>

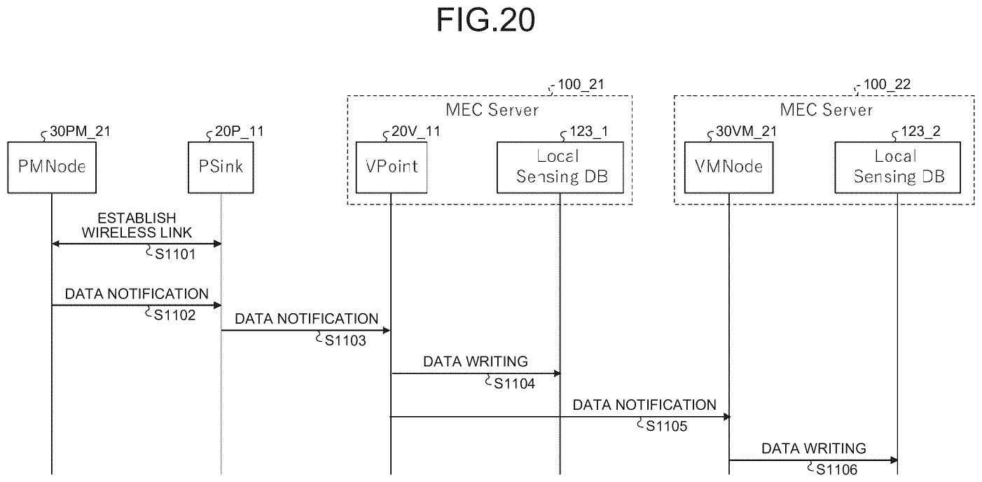

FIG. 20 is a sequence chart illustrating an example of a data registration procedure of registering sensor data from the mobile node according to the embodiment of the present disclosure. Here, the PMNode 30PM_21, which is a mobile node, performs sensor data registration via the PSink 20P_11 temporarily connected thereto.

The Home MEC Server of the PMNode 30PM_21 is the MEC Server 100_22. For that reason, in the example illustrated in FIG. 20, a data registration procedure at the time when the mobile node is connected to other than the Home MEC Server is illustrated.

The PMNode 30PM_21 establishes a wireless link with the PSink 20P_11 that is a physical sink (step S1101). The PMNode 30PM_21 transmits a data notification message to the PSink 20P_11 (step S1102).

Table 47 is a table illustrating the data notification message. Table 47 illustrates an example of the data notification message transmitted to the PSink 20P_11 by the PMNode 30PM_21 according to the embodiment of the present disclosure.

TABLE 47
Data notification message

Type = Data notification
PNID = Id_PMN#21
Session Key = SKey_PMN#21
Time = Time_PMN#21_D
Data = Data_PMN#21

The data notification message can include, for example, an identifier of the PMNode 30PM_21 and information (the Session Key field) concerning a session key. Note that the data notification message illustrated here is an example. The PMNode 30PM_21 can transmit a data notification message including information other than the information illustrated in Table 47 to the PSink 20P_11.

The PSink 20P_11 transmits the data notification message to the VPoint 20V_11 that is a virtual module corresponding thereto (step S1103). The data notification message can be the same message as the message illustrated in Table 47.

When receiving the data notification message, the VPoint 20V_11 recognizes, from a value of the Session Key field, that the PMNode 30PM_21 has already been authenticated and transmits a data write message to the Local Sensing DB 123_1 (step S1104).

Table 48 is a table illustrating the data write message. Table 48 illustrates an example of the data write message transmitted to the Local Sensing DB 123_1 by the VPoint 20V_11 according to the embodiment of the present disclosure.

TABLE 48
Data writing message

Type = Data writing
PNID = Id_PMN#21
VNID = Id_VMN#21
Time = Time_PMN#21_D
Data = Data_PMN#21

The data write message can include, for example, an identifier of the PMNode 30PM_21, an identifier of the VMNode 30VM_11, and information (the Data field) concerning sensing data. Note that the data write message illustrated here is an example. The VPoint 20V_11 can transmit a data write message including information other than the information illustrated in Table 48 to the Local Sensing DB 123_1.

When receiving the data write request message, the Local Sensing DB 123_1 writes content of the Data field in a database.

In addition, the VPoint 20V_11 recognizes that the virtual module corresponding to the PMNode 30PM_21 is the VMNode 30VM_21 when the PMNode 30PM_21 is connected to the PSink 20P_11. Therefore, the VPoint 20V_11 transmits a data notification message to the VMNode 30VM_21 (step S1105). The data notification message can be the same message as the message illustrated in Table 47.

When receiving the data notification message, the VMNode 30VM_21 transmits a data write message to a Local Sensing DB 123_2 (step S1106). The data write message can be the same message as the message illustrated in Table 48.

When receiving the data write request message, the Local Sensing DB 123_2 writes content of the Data field in a database.

When the procedure illustrated in FIG. 20 is executed, the Local Sensing DBs 123_1 and 123_2 add entries illustrated in Table 49 to the databases. Table 49 is a table illustrating sensor data entries of the PMNode 30PM_21.

TABLE 49
Sensor data entries of PMNode 30PM_21

PNID = Id_PMN#21
VNID = Id_VMN#21
VSID = Id_PSink#11
Capability = Cap_PMN#21
Time = Time_PMN#21_D
Data = Data_PMN#21

The sensor data entries can include, for example, an identifier of the PMNode 30PM_21 and information concerning sensor data. Note that the sensor data entries illustrated here are an example. The Local Sensing DBs 123_1 and 123_2 can be managed as the sensor data entries as sensor data entries including information other than the information illustrated in Table 49.

The VMNode 30VM_21 may also retain the sensor data entries as a cache.

### <5.13. Global Graph DB Update Procedure>

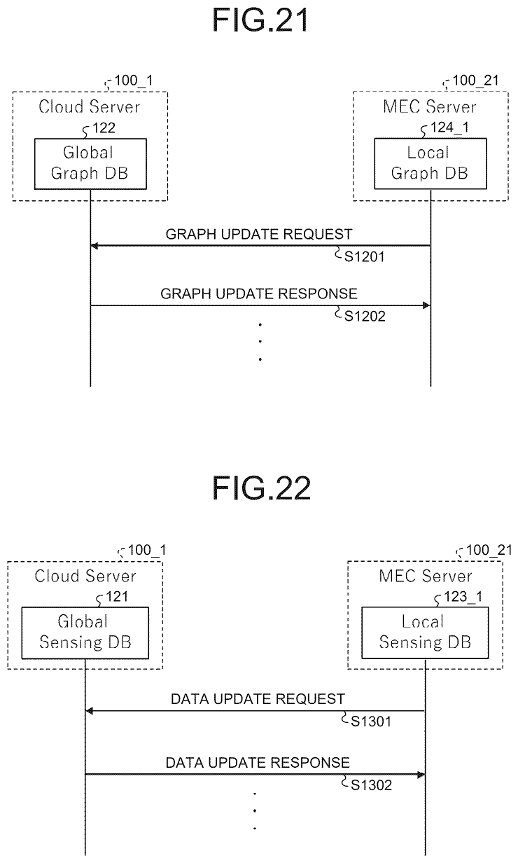

For example, the Local Graph DB 124 of the MEC Server 100_20 periodically transmits update data to the Global Graph DB 122. FIG. 21 is a sequence chart illustrating an example of an update procedure for the Global Graph DB 122 according to the embodiment of the present disclosure. FIG. 21 illustrates a procedure in which the Local Graph DB 124_1 transmits update data to the Global Graph DB 122.

The Local Graph DB 124_1 detects update information from the last graph information update execution and transmits a graph update request message to the Global Graph DB 122 (step S1201).

Table 50 is a table illustrating the graph update request message. Table 50 illustrates an example of the graph update request message transmitted to the Global Graph DB 122 by the Local Graph DB 124_1 according to the embodiment of the present disclosure.

TABLE 50
Graph update request message

Type = Graph update request
Time = Time_GraphUpdate
Data = Data_GraphUpdate

The graph update request message can include, for example, information concerning a transmission date and time of update data and information (the Data field) concerning the update data of a graph. Note that the graph update request message illustrated here is an example. The Local Graph DB 124_1 can transmit a graph update request message including information other than the information illustrated in Table 50 to the Global Graph DB 122.

When receiving the graph update request message, the Global Graph DB 122 updates a database with content of the Data field and transmits a graph update response message to the Local Graph DB 124_1 (step S1202).

Table 51 a table illustrating the graph update response message. Table 51 illustrates an example of the graph update response message transmitted to the Local Graph DB 124_1 by the Global Graph DB 122.

TABLE 51
Graph update response message

Type = Graph update response
Status = OK

The graph update response message can include, for example, information (Status) concerning a graph update result. Table 51 illustrates a graph update response message in the case in which the graph update is successful. Note that the graph update response message illustrated here is an example. The Global Graph DB 122 can transmit a graph update response message including information other than the information illustrated in Table 51 to the Local Graph DB 124_1.

Thereafter, the Local Graph DB 124_1 and the Global Graph DB 122 repeat the operation illustrated in FIG. 21. The Local Graph DB 124_1 may transmit the graph update request message at a predetermined period or may transmit the graph update request message at the opportunity when a node is registered/deleted. Alternatively, the Local Graph DB 124_1 may transmit a graph update request message in response to a request from the Global Graph DB 122.

As a result of this procedure, the Global Graph DB 122 becomes capable of grasping configuration information of the entire M2M system according to the present embodiment.

### <5.14. Global Sensing DB Update Procedure>

For example, the Local Sensing DB 123 of the MEC Server 100_20 periodically transmits update data (sensor data) to the Global Sensing DB 121. FIG. 22 is a sequence chart illustrating an example of an update procedure for the Global Sensing DB 121 according to the embodiment of the present disclosure. FIG. 22 illustrates a procedure in which the Local Sensing DB 123_1 transmits update data to the Global Sensing DB 121.

The Local Sensing DB 123_1 detects update information from the last sensor data update execution and transmits a data update request message to the Global Sensing DB 121 (step S1301).

Table 52 is a table illustrating the data update request message. Table 52 illustrates an example of the data update request message transmitted to the Global Sensing DB 121 by the Local Sensing DB 123_1 according to the embodiment of the present disclosure.

TABLE 52
Data update request message

Type = Data update request
Time = Time_DataUpdate
Data = Data_Update

The data update request message can include, for example, information concerning a transmission date and time of update data and information (the Data field) concerning update data of sensor data. Note that the data update request message illustrated here is an example. The Local Sensing DB 123_1 can transmit a data update request message including information other than the information illustrated in Table 52 to the Global Sensing DB 121.

When receiving the data update request message, the Global Sensing DB 121 updates a database with content of the Data field and transmits a data update response message to the Local Sensing DB 123_1 (step S1302).

Table 53 is a table illustrating the data update response message. Table 53 illustrates an example of the data update response message transmitted to the Local Sensing DB 123_1 by the Global Sensing DB 121.

TABLE 53
Data update response message

Type = Data update response
Status = OK

The data update response message can include, for example, information (Status) concerning a data update result. Table 53 illustrates a data update response message in the case in which the data update is successful. Note that the data update response message illustrated here is an example. The Global Sensing DB 121 can transmit a data update response message including information other than the information illustrated in Table 53 to the Local Sensing DB 123_1.

Thereafter, the Local Sensing DB 123_1 and the Global Sensing DB 121 repeat the operation illustrated in FIG. 22. The Local Sensing DB 123_1 may transmit the data update request message at a predetermined period or may transmit the data update request message at the opportunity when the data write message is received. Alternatively, the Local Sensing DB 123_1 may transmit the data update request message in response to a request from the Global Sensing DB 121.

As a result of this procedure, the Global Sensing DB 121 becomes capable of storing sensor data measured in the entire M2M system according to the present embodiment.

### <5.15. M2M Application Start Procedure (in the Case of the Cloud Server)>

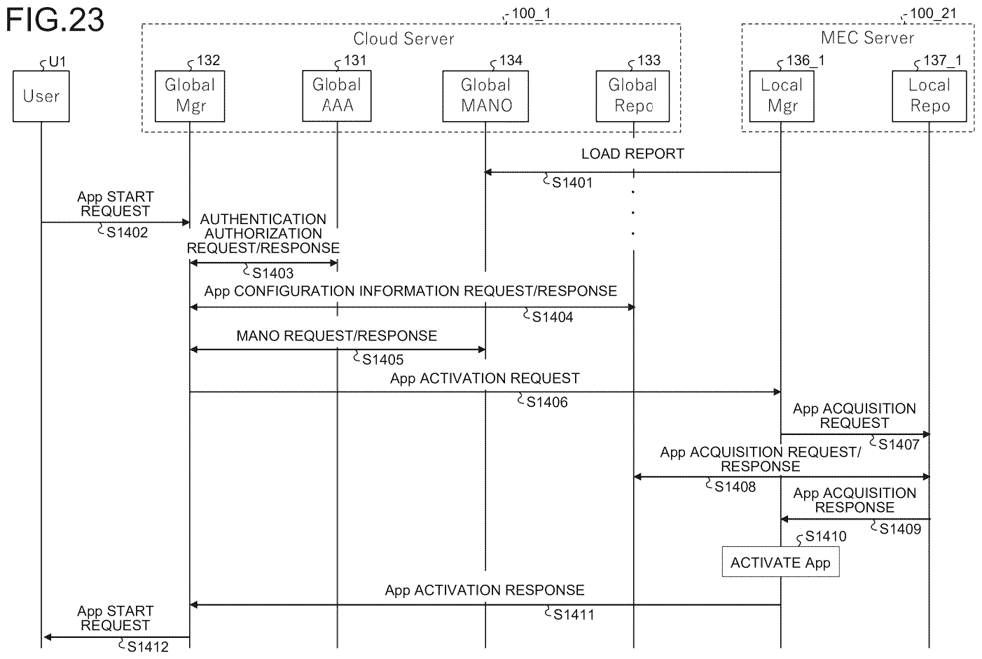

FIG. 23 is a sequence chart illustrating an example of a start procedure for the M2M application 10 according to the embodiment of the present disclosure. FIG. 23 illustrates a procedure in the case in which the M2M application 10 is started on the Cloud Server 100_1.

The Local Mgr 136 operating on the MEC Server 100_20 (in the example illustrated in FIG. 23, a Local Mgr 136_1 operating on the MEC Server 100_21) periodically transmits a load report message to the Global MANO 134 operating on the Cloud Server 100_1 (step S1401).

Note that, although not illustrated, since the PMNode 30PM also functions as the MEC Server 100_211, the Local Mgr 136_21 in the PMNode 30PM also periodically transmits a load report message to the Global MANO 134.

Table 54 is a table illustrating the load report message. Table 54 illustrates an example of the load report message transmitted to the Global MANO 134 by the Local Mgr 136_1 according to the embodiment of the present disclosure.

TABLE 54
Load report message

Type = Load report
MECID = Id_MEC#1
Time = Time_LoadUpdate
CompLoad = Load_Comp
NetLoad = Load_Net

The load report message can include, for example, identification information of the operating MEC Server 100_21 and load information of calculation resources. Note that the load report message illustrated here is an example. The Local Mgr 136_1 can transmit a load report message including information other than the information illustrated in Table 54 to the Global MANO 134.

The Global MANO 134 can grasp a load status of the entire M2M system by periodically receiving the load report message from the Local Mgr 136.

The user U1 transmits an App start request message to the Global Mgr 132 (step S1402). Table 55 is a table illustrating the App start request message. Table 55 illustrates an example of the App start request message transmitted to the Global Mgr 132 by the user U1 according to the embodiment of the present disclosure.

TABLE 55
App start request message

Type = App start request
UserID = Id_User#4
Credential = Cred_User#4
AppName = App_Name
Param = App_Param

The App start request message can include, for example, identification information of the user U1, credit information of the user U1, and information concerning the application (the AppName field). Note that the App start request message illustrated here is an example. The user U1 can transmit an App start request message including information other than the information illustrated in Table 55 to the Global Mgr 132.

When receiving the App start request message, the Global Mgr 132 exchanges authentication authorization request/response with the Global AAA 131 (step S1403).

Specifically, the Global Mgr 132 transmits an authentication authorization request message to the Global AAA 131. Table 56 is a table illustrating the authentication authorization request message. Table 56 illustrates an example of the authentication authorization request message transmitted to the Global AAA 131 by the Global Mgr 132 according to the embodiment of the present disclosure.

TABLE 56
Authentication authorization request message

Type = Authentication authorization request
UserID = Id_User#4
Credential = Cred_User#4
AppName = App_Name

The authentication authorization request message can include, for example, identification information (the UserID field) of the user U1, credit information of the user U1, and information (the AppName field) concerning an application. Note that the authentication authorization request message illustrated here is an example. The Global Mgr 132 can transmit an authentication authorization request message including information other than the information illustrated in Table 56 to the Global AAA 131.

When receiving the authentication authorization request message, the Global AAA 131 checks authenticity of the user U1 indicated by the UserID field and execution authority of an application indicated by the AppName. When succeeding in the check, the Global AAA 131 transmits an authentication authorization response message to the Global Mgr 132.

Table 57 is a table illustrating the authentication authorization response message. Table 57 illustrates an example of the authentication authorization response message transmitted to the Global Mgr 132 by the Global AAA 131.

TABLE 57
Authentication authorization response message

Type = Authentication authorization response
UserID = Id_User#4
Status = OK

The authentication authorization response message can include, for example, identification information (the UserID field) of the user U1 and information (Status) concerning an authentication authorization result. Table 57 illustrates a data update response message in the case in which the authentication authorization is successful. Note that the authentication authorization response message illustrated here is an example. The Global AAA 131 can transmit an authentication authorization response message including information other than the information illustrated in Table 57 to the Global Mgr 132.

Subsequently, the Global Mgr 132 exchanges an App configuration information request/response with the Global Repo 133 (step S1404). Specifically, the Global Mgr 132 transmits an App configuration information request message to the Global Repo 133.

Table 58 is a table illustrating the App configuration information request message. Table 58 illustrates an example of the App configuration information request message transmitted to the Global Repo 133 by the Global Mgr 132 according to the embodiment of the present disclosure.

TABLE 58
App configuration information request message

Type = App configuration information request
AppName = App_Name

The App configuration information request message can include, for example, information concerning the application (the AppName field). Note that the App configuration information request message illustrated here is an example. The Global Mgr 132 can transmit an App configuration information request message including information other than the information illustrated in Table 58 to the Global Repo 133.

When receiving the App configuration information request message, the Global Repo 133 reads configuration information (a size of a program, requested calculation resources, a network band, and the like) concerning the application indicated by the AppName field from a database. The Global Repo 133 transmits an App configuration information response message to the Global Mgr 132.

Table 59 is a table illustrating an App configuration information response message. Table 59 illustrates an example of the App configuration information response message transmitted to the Global Mgr 132 by the Global Repo 133.

TABLE 59
App configuration information response message

Type = App configuration information response
AppName = App_Name
Status = OK
ConfInfo = App_Info

The App configuration information response message can include, for example, information concerning an application and information (Status) concerning a request result of App configuration information. Table 59 illustrates an App configuration information response message in the case in which a request for the App configuration information is successful. Note that the App configuration information response message illustrated here is an example. The Global Repo 133 can transmit an App configuration information response message including information other than the information illustrated in Table 59 to the Global Mgr 132.

Subsequently, the Global Mgr 132 exchanges a MANO request/response with the Global MANO 134 (step S1405). Specifically, the Global Mgr 132 transmits a MANO request message to the Global MANO 134.

Table 60 is a table illustrating the MANO request message. Table 60 illustrates an example of a MANO request message transmitted to the Global MANO 134 by the Global Mgr 132 according to the embodiment of the present disclosure.

TABLE 60
MANO request message

Type = MANO request
AppName = App_Name
ConfInfo = App_Info

The MANO request message can include, for example, information concerning an application. Note that the MANO request message illustrated herein is an example. The Global Mgr 132 can transmit a MANO request message including information other than the information illustrated in Table 60 to the Global MANO 134.

Based on load reports from the MEC Servers 100_20, the Global MANO 134 determines the MEC Server 100_20 or the Cloud Server 100_1 in which the application indicated by the AppName field is disposed. In this example, it is assumed that the MEC Server 100_21 is selected.

Subsequently, the Global MANO 134 transmits a MANO response message to the Global Mgr 132. Table 61 is a table illustrating the MANO response message. Table 61 illustrates an example of the MANO response message transmitted to the Global Mgr 132 by the Global MANO 134.

TABLE 61
MANO response message

Type = MANO response
AppName = App_Name
MECID = Id_MEC#1

The MANO response message can include, for example, information concerning an application and information (MECID) concerning a device in which the application is disposed. Note that the MANO response message illustrated here is an example. The Global MANO 134 can transmit a MANO response message including information other than the information illustrated in Table 61 to the Global Mgr 132.

Subsequently, the Global Mgr 132 transmits an App activation request message to the Local Mgr 136_1 operating on the MEC Server 100_21 (step S1406).

Table 62 is a table illustrating the App activation request message. Table 62 illustrates an example of the App activation request message transmitted to the Local Mgr 136_1 by the Global Mgr 132 according to the embodiment of the present disclosure.

TABLE 62
App activation request message

Type = App activation request
UserID = Id_User#4
AppName = App_Name
Param = App_Param

The App activation request message can include, for example, identification information of the user U1 and information concerning an application. Note that the App activation request message illustrated here is an example. The Global Mgr 132 can transmit an App activation request message including information other than the information illustrated in Table 62 to the Local Mgr 136_1.

The Local Mgr 136_1 transmits an App acquisition request message to a Local Repo 137_1 (step S1407). Table 63 is a table illustrating the App acquisition request message. Table 63 illustrates an example of the App acquisition request message transmitted to the Local Repo 137_1 by the Local Mgr 136_1 according to the embodiment of the present disclosure.

TABLE 63
App acquisition request message

Type = App acquisition request
AppName = App_Name

The App acquisition request message can include, for example, information concerning the application (the AppName field). Note that the App acquisition request message illustrated here is an example. The Local Mgr 136_1 can transmit an App acquisition request message including information other than the information illustrated in Table 63 to the Local Repo 137_1.

When receiving the App acquisition request message, the Local Repo 137_1 searches through a database thereof for the application indicated by the AppName field. When the application is not found, as illustrated in FIG. 23, the Local Repo 137_1 exchanges an App acquisition request/response with the Global Repo 133 operating on the Cloud Server 100_1 (step S1408).

Specifically, the Local Repo 137_1 transmits the App acquisition request message to the Global Repo 133. This App acquisition request message can be the same message as the message illustrated in Table 63.

When receiving the App acquisition request message, the Global Repo 133 searches the database thereof for the application indicated by the AppName field and transmits an App acquisition response message to the Local Repo 137_1.

Table 64 is a table illustrating the App acquisition response message. Table 64 illustrates an example of the App acquisition response message transmitted to the Local Repo 137_1 by the Global Repo 133.

TABLE 64
App acquisition response message

Type = App acquisition response
AppName = App_Name
Status = OK
AppImage = App_Image

The App acquisition response message can include, for example, information concerning an application and information (Status) concerning an App acquisition result. Table 64 illustrates an App acquisition response message in the case in which the acquisition of the application is successful. Note that the App acquisition response message illustrated here is an example. The Global Repo 133 can transmit an App acquisition response message including information other than the information illustrated in Table 64 to the Local Repo 137_1.

When receiving the App acquisition response message, the Local Repo 137_1 transmits the App acquisition response message to the Local Mgr 136_1 (step S1409).

When receiving the App acquisition response message, the Local Mgr 136_1 activates an application (step S1410). The Local Mgr 136_1 activates, for example, the M2M application 10.

Subsequently, the Local Mgr 136_1 transmits an App activation response message to the Global Mgr 132 (step S1411). Table 65 is a table illustrating the App activation response message. Table 65 illustrates an example of the App activation response message transmitted to the Global Mgr 132 by the Local Mgr 136_1.

TABLE 65
App activation response message

Type = App activation response
AppName = App_Name
Status = OK

The App activation response message can include, for example, information concerning an application and information (Status) concerning an App activation result. Table 65 illustrates an App activation response message in the case in which the activation of the application is successful. Note that the App activation response message illustrated here is an example. The Local Mgr 136_1 can transmit an App activation response message including information other than the information illustrated in Table 65 to the Global Mgr 132.

When receiving the App activation response message, the Global Mgr 132 transmits an App start response message to the user U1 (step S1412). Table 66 is a table illustrating the App start response message. Table 66 illustrates an example of an App start response message transmitted to the user U1 by the Global Mgr 132.

TABLE 66
App start response message

Type = App start response
AppName = App_Name
Status = OK

The App start response message can include, for example, information concerning an application and information (Status) concerning an App start result. Table 66 illustrates an App start response message in the case in which the start of the application is successful. Note that the App start response message illustrated here is an example. The Global Mgr 132 can transmit an App start response message including information other than the information illustrated in Table 66 to the user U1.

By executing the procedure illustrated in FIG. 23, when starting the M2M application 10 on the Cloud Server 100_1, the M2M system can dispose the M2M application 10 on an optimum device (the Cloud Server 100_1 or the MEC Server 100_20) considering a calculation load and a network load (for example, a communication delay).

<5.16. M2M application start procedure (in case of the mobile node)>

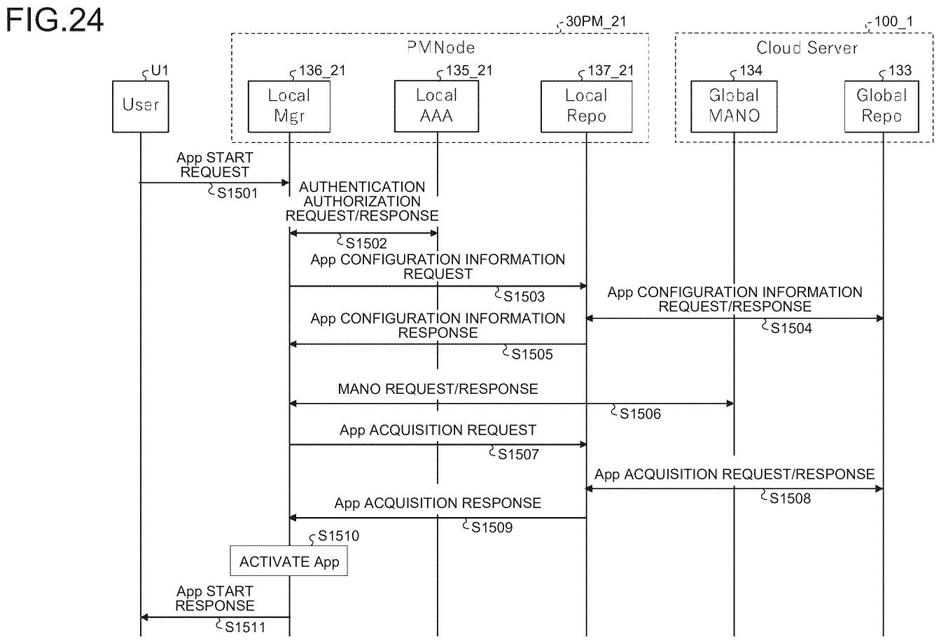

FIG. 24 is a sequence chart illustrating another example of the start procedure for the M2M application 10 according to the embodiment of the present disclosure. FIG. 24 illustrates a procedure in the case in which the M2M application 10 is started by the user U2 in the PMNode 30PM_21.

The user U2 transmits an App start request message to the Local Mgr 136_21 (step S1501). Table 67 is a table illustrating the App start request message. Table 67 illustrates an example of the App start request message transmitted to the Local Mgr 136_21 by the user U2 according to the embodiment of the present disclosure.

TABLE 67
App start request message

Type = App start request
UserID = Id_User#2
Credential = Cred_User#2
AppName = App_Name
Param = App_Param

The App start request message is the same as the App start request message illustrated in Table 55 except that the information concerning the user U is not the information concerning the user U1 but is information concerning the user U2.

When receiving the App start request message, the Local Mgr 136_21 exchanges an authentication authorization request/response with a Local AAA 135_21 (step S1502).

Specifically, the Local Mgr 136_21 transmits an authentication authorization request message to the Local AAA 135_21. Table 68 is a table illustrating the authentication authorization request message. Table 68 illustrates an example of the authentication authorization request message transmitted to the Local AAA 135_21 by the Local Mgr 136_21 according to the embodiment of the present disclosure.

TABLE 68
Authentication authorization request message

Type = Authentication authorization request
UserID = Id_User#2
Credential = Cred_User#2
AppName = App_Name

The authentication authorization request message is the same as the authentication authorization request message illustrated in Table 56 except that the information concerning the user U1 is not the information concerning the user U1 but is information concerning the user U2.

When receiving the authentication authorization request message, the Local AAA 135_21 checks authenticity of the user U2 indicated by the UserID field and an execution authority for the application indicated by the AppName. When succeeding in the check, the Local AAA 135_21 transmits an authentication authorization response message to the Local Mgr 136_21.

Table 69 is a table illustrating the authentication authorization response message. Table 69 illustrates an example of the authentication authorization response message transmitted to the Local Mgr 136_21 by the Local AAA 135_21.

TABLE 69
Authentication authorization response message

Type = Authentication authorization response
UserID = Id_User#2
Status = OK

The authentication authorization response message is the same as the authentication authorization response message illustrated in Table 57 except that the information concerning the user U1 is not the information concerning the user U1 but is information concerning the user U2.

Subsequently, the Local Mgr 136_21 transmits an App configuration information request message to a Local Repo 137_21. (Step S1503). The App configuration information request message can be the same as the message illustrated in Table 58.

When receiving the App configuration information request message, the Local Repo 137_21 searches through a database for configuration information (a size of a program, requested calculation resources, a network band, and the like) concerning the application indicated by the AppName field. When the configuration information is not found, as illustrated in FIG. 24, the Local Repo 137_21 exchanges an App configuration information request/response with the Global Repo 133 (step S1504).

Specifically, the Local Repo 137_21 transmits the App configuration information request message to the Global Repo 133. The App configuration information request message can be the same as the message illustrated in Table 58.

When receiving the App configuration information request message, the Global Repo 133 reads configuration information (a size of a program, requested calculation resources, a network band, and the like) concerning the application indicated by the AppName field from a database. The Global Repo 133 transmits an App configuration information response message to the Local Repo 137_21. The App configuration information response message can be the same as the message illustrated in Table 59.

When receiving the App configuration information response message, the Local Repo 137_21 transmits the App configuration information response message to the Local Mgr 136_21 (step S1505).

Subsequently, the Local Mgr 136_21 exchanges a MANO request/response with the Global MANO 134 (step S1506). Specifically, the Local Mgr 136_21 transmits a MANO request message to the Global MANO 134. The MANO request message can be the same as the message illustrated in Table 60.

When receiving the MANO request message, the Global MANO 134 determines, based on load reports from the MEC Servers 100_20, the MEC Server 100_20 or the Cloud Server 100_1 in which the application indicated by the AppName field is disposed. In this example, it is assumed that the PMNode 30PM_21 is selected.

Subsequently, the Global MANO 134 transmits a MANO response message to the Local Mgr 136_21. Table 70 is a table illustrating the MANO response message. Table 70 illustrates an example of the MANO response message transmitted to the Local Mgr 136_21 by the Global MANO 134.

TABLE 70
MANO response message

Type = MANO response
AppName = App_Name
MECID = Id_MEC#21

The MANO response message is the same as the MANO response message illustrated in Table 61 except that the information (MECID) concerning the device in which the application is disposed is an identifier of the PMNode 30PM_21.

When receiving the MANO response message, the Local Mgr 136_21 transmits an App acquisition request message to the Local Repo 137_21 (step S1507). The App acquisition request message can be the same as the message illustrated in Table 63.

When receiving the App acquisition request message, the Local Repo 137_21 searches through the database thereof for the application indicated by the AppName field. When the application is not found, as illustrated in FIG. 24, the Local Repo 137_21 exchanges an App acquisition request/response with the Global Repo 133 operating on the Cloud Server 100_1 (step S1508).

Specifically, the Local Repo 137_21 transmits the App acquisition request message to the Global Repo 133. This App acquisition request message can be the same message as the message illustrated in Table 63.

When receiving the App acquisition request message, the Global Repo 133 searches through the database thereof for the application indicated by the AppName field and transmits an App acquisition response message to the Local Repo 137_21. The App response request message can be the same message as the message illustrated in Table 64.

When receiving the App acquisition response message, the Local Repo 137_21 transmits the App acquisition response message to the Local Mgr 136_21 (step S1509).

When receiving the App acquisition response message, the Local Mgr 136_21 activates an application (step S1510). The Local Mgr 136_21 activates, for example, the M2M application 10.

When activating the application, the Local Mgr 136_21 transmits an App start response message to the user U2 (step S1511). The App start request message can be the same message as the message illustrated in Table 66.

By executing the procedure illustrated in FIG. 24, when starting the M2M application 10 on the PMNode 30PM_21, the M2M system can dispose the M2M application 10 in an optimum device (the Cloud Server 100_1 or the MEC Server 100_20) considering a calculation load and a network load (for example, a communication delay).

### <5.17. Point Resolution Procedure>

As explained above, in the present embodiment, processing of designating a geographical area and searching for the VPoint 20V installed in the geographical area is referred to as point resolution.

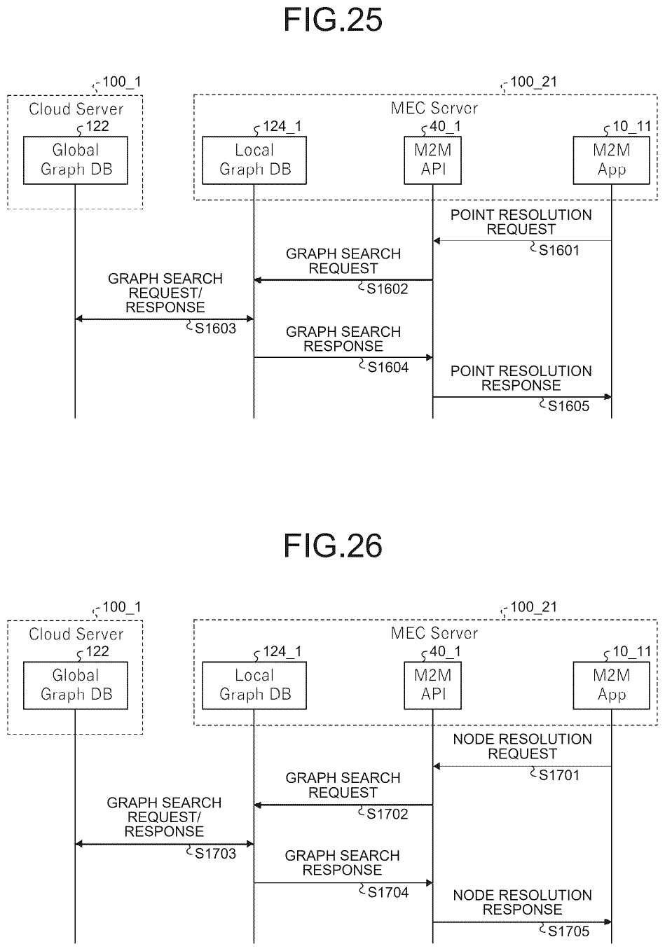

FIG. 25 is a sequence chart illustrating an example of a point resolution procedure according to the embodiment of the present disclosure. FIG. 25 illustrates a procedure in the case in which the M2M App 10_11, which is the M2M application 10 operating on the MEC Server 100_21, executes the point resolution.

The M2M App 10_11 transmits a point resolution request message to the M2M API 40_1 operating on the MEC Server 100_21 (step S1601).

Table 71 is a table illustrating the point resolution request message. Table 71 illustrates an example of the point resolution request message transmitted to the M2M API 40_1 by the M2M App 10_11 according to the embodiment of the present disclosure.

TABLE 71
Point resolution request message

Type = Point resolution request
SW Lat Lon = LatLon_SW
NE Lat Lon = LatLon_NE

The point resolution request message can include, for example, information concerning a geographical area (for example, an SW LatLon field or an NE LatLon field). Note that the point resolution request message illustrated here is an example. The M2M App 10_11 can transmit a point resolution request message including information other than the information illustrated in Table 71 to the M2M API 40_1.

When receiving the point resolution request message, the M2M API 40_1 transmits a graph search request message to the Local Graph DB 123_1 (step S1602).

Table 72 is a table illustrating the graph search request message. Table 72 illustrates an example of the graph search request message transmitted to the Local Graph DB 123_1 by the M2M API 40_1 according to the embodiment of the present disclosure.

TABLE 72
Graph search request message

Type = Graph search request
Query Type = Point search
SW Lat Lon = LatLon_SW
NE Lat Lon = LatLon_NE

The graph search request message can include, for example, information concerning a type of a data resolution request or information concerning a geographical area (for example, the SW LatLon field or the NE LatLon field). Note that the graph search request message illustrated here is an example. The M2M API 40_1 can transmit a graph search request message including information other than the information illustrated in Table 72 to the Local Graph DB 123_1.

When receiving the graph search request message, the Local Graph DB 123_1 determines whether the geographical area indicated by the SW LatLon field and the NE LatLon field is a control range of the Local Graph DB 123_1. When the designated geographical area is the control range of the Local Graph DB 123_1, the Local Graph DB 123_1 searches through the database for the VPoint 20V present in the designated geographical area and proceeds to step S1604.

On the other hand, when the designated geographical area is not the control range of the Local Graph DB 123_1, the Local Graph DB 123_1 exchanges a graph search request/response with the Global Graph DB 122 operating on the Cloud Server 100_1 (step S1603).

Specifically, the Local Graph DB 123_1 transmits a graph search request message to the Global Graph DB 122. The graph search request message can be the same as the message illustrated in Table 72.

When receiving the graph search request message, the Global Graph DB 122 accesses the database and searches for the VPoint 20V present in the designated geographical area. Subsequently, the Global Graph DB 122 transmits a graph search response message to the Local Graph DB 124_1.

Table 73 is a table illustrating the graph search response message. Table 73 illustrates an example of the graph search response message transmitted to the Local Graph DB 124_1 by the Global Graph DB 122.

TABLE 73
Graph search response message

| | | |
|---|---|---|
| Type = Graph search response | | |
| Query Type = Graph search | | |
| Status = OK | | |
| No VPs = Num_VPs | | |
| VPID = Id_VP | | Num_VPs |
| | {close oversize brace} | |
| Address = Addr_VP | | |

The graph search response message can include, for example, information concerning a search result. Note that Table 73 illustrates a graph search response message in the case in which the graph search is successful.

When a plurality of VPoints 20V can be present in the designated geographical area as a result of the graph search, the Global Graph DB 122 transmits the graph search response message including information concerning the plurality of VPoints 20V to the Local Graph DB 124_1. Examples of the information concerning the plurality of VPoints 20V include an identifier of the VPoint 20V and information concerning a network address.

Note that the graph search response message illustrated here is an example. The Global Graph DB 122 can transmit a graph search response message including information other than the information illustrated in Table 73 to the Local Graph DB 124_1.

When searching for the VPoint 20V, the Global Graph DB 122 refers to, for example, the Lat Lon field included in the instance information of the VPoint 20V illustrated in Table 37.

As illustrated in FIG. 25, the Local Graph DB 124_1 combines the information concerning the VPoint 20V searched by itself and the information concerning the VPoint 20V received from the Global Graph DB 122 and transmits a graph search response message to the M2M API 40_1 (step S1604). The graph search response message can be a message of the same format as the message illustrated in Table 73.

For example, the Local Graph DB 124_1 adds the information concerning the VPoint 20V searched by itself to the graph search response message received from the Global Graph DB 122 to generate a new graph search response message. The Local Graph DB 124_1 transmits the generated graph search response message to the M2M API 40_1.

When receiving the graph search response message, the M2M API 40_1 transmits a point resolution response message to the M2M App 10_11 (step S1605).

Table 74 is a table illustrating the point resolution response message. Table 74 illustrates an example of the point resolution response message transmitted to the M2M App 10_11 by the M2M API 40_1.

TABLE 74
Point resolution response message

| | |
|---|---|
| Type = Point resolution response | |
| Status = OK | |
| No VPs = Num_VPs | |
| VPID = Id_VP | }Num_VPs |

The point resolution response message can include, for example, information concerning a point resolution result. Note that Table 74 illustrates a point resolution response message in the case in which the point resolution is successful.

When a plurality of VPoints 20V can be present in a designated geographical area as a result of point resolution, the M2M API 40_1 transmits the point resolution response message including information concerning the plurality of VPoints 20V to the M2M App 10_11. Examples of the information concerning the plurality of VPoints 20V include identifiers of the VPoints 20V.

Note that the point resolution response message illustrated here is an example. The M2M API 40_1 can transmit a point resolution response message including information other than the information illustrated in Table 74 to the M2M App 10_11.

In this procedure, the point resolution request/response is a function of the M2M API 40_1 and the graph search request/response is a function of the Prim API.

### <5.18. Node Resolution Procedure>

When node-designated type data resolution is performed, first, the M2M application 10 performs point resolution to search for the VPoint 20V and searches for the VNode 30V having a desired function for the obtained VPoint 20V. In the present embodiment, as explained above, this search processing is referred to as node resolution.

The M2M application 10 designates, for example, the VNode 30V obtained by the node resolution and executes the node-designated type data resolution.

FIG. 26 is a sequence chart illustrating an example of a node resolution procedure according to the embodiment of the present disclosure. FIG. 26 illustrates a procedure in the case in which the M2M App 10_11, which is the M2M application 10 operating on the MEC Server 100_21, performs the node resolution.

The M2M App 10_11 transmits a node resolution request message to the M2M API 40_1 operating on the MEC Server 100_21 (step S1701).

Table 75 is a table illustrating the node resolution request message. Table 75 illustrates an example of the node resolution request message transmitted to the M2M API 40_1 by the M2M App 10_11 according to the embodiment of the present disclosure.

TABLE 75
Node resolution request message

| | |
|---|---|
| Type = Node resolution request | |
| Capability = CapType | |
| No VPs = Num_VPs | |
| VPID = Id_VP | }Num_VPs |

The node resolution request message can include, for example, information concerning the VPoint 20V, which is a search range, and information concerning a desired function. Note that, when there are a plurality of VPoints 20V that are search ranges, information (for example, identifiers) concerning the plurality of VPoints 20V can be included in the node resolution request message.

Note that the node resolution request message illustrated here is an example. The M2M App 10_11 can transmit a node resolution request message including information other than the information illustrated in Table 75 to the M2M API 40_1.

When receiving the node resolution request message, the M2M API 40_1 transmits a graph search request message to the Local Graph DB 123_1 (step S1702).

Table 76 is a table illustrating the graph search request message. Table 76 illustrates an example of the graph search request message transmitted to the Local Graph DB 123_1 by the M2M API 40_1 according to the embodiment of the present disclosure.

TABLE 76
Graph search request message

| | |
|---|---|
| Type = Graph search request | |
| Query Type = Node search #2 | |
| Capability = CapType | |
| No VPs = Num_VPs | |
| VPID = Id_VP | }Num_VPs |

The graph search request message is different from the graph search request message illustrated in Table 72 in, for example, a type of a data resolution request. The graph search request message can include not information concerning a geographical area but information concerning the VPoint 20V, which is the search range, or information concerning a desired function.

Note that the graph search request message illustrated here is an example. The M2M API 40_1 can transmit a graph search request message including information other than the information illustrated in Table 76 to the Local Graph DB 123_1.

When receiving the graph search request message, concerning the VNode 30V having a designated Capability for the VPoint 20V controlled by the Local Graph DB 123_1 among the designated VPoints 20V, the Local Graph DB 123_1 searches through the database and proceeds to step S1704.

On the other hand, concerning the VPoints 20V outside the control of the Local Graph DB 123_1, the Local Graph DB 123_1 exchanges a graph search request/response with the Global Graph DB 122 operating on the Cloud Server 100_1 (step S1703).

Specifically, the Local Graph DB 123_1 transmits a graph search request message to the Global Graph DB 122. The graph search request message can be the same as the message illustrated in Table 76.

When receiving the graph search request message, the Global Graph DB 122 accesses the database and, concerning the designated VPoint 20V, searches through the database for the VNode 30V having the designated Capability. Subsequently, the Global Graph DB 122 transmits a graph search response message to the Local Graph DB 124_1.

Table 77 is a table illustrating the graph search response message. Table 77 illustrates an example of the graph search response message transmitted to the Local Graph DB 124_1 by the Global Graph DB 122.

TABLE 77
Graph search response message

| | |
|---|---|
| Type = Graph search response | |
| Query Type = Node search #2 | |
| Status = OK | |
| No VNs = Number of VNodes | |
| VNID = Identifier of VNode | |
| VNAddress = Address of VNode | }No VNs |

The graph search response message is different from the graph search response message illustrated in Table 73 in a type of a data resolution request. The graph search response message can include not the information concerning the VPoint 20V but information (for example, an identifier or a network address) concerning the VNode 30V that is a search range. When a plurality of VNodes 30V are found as a result of the graph search, the Global Graph DB 122 transmits the graph search response message including information concerning the plurality of VNodes 30V to the Local Graph DB 124_1.

Note that the graph search response message illustrated here is an example. The Global Graph DB 122 can transmit a graph search response message including information other than the information illustrated in Table 77 to the Local Graph DB 124_1.

The Global Graph DB 122 refers to, for example, the respondsViaPrimApi field included in the instance information of the VPoint 20V illustrated in Table 37 to know an identifier of the VNode 30V. The Global Graph DB 122 refers to the Capabilities field included in the instance information of VNode 30V illustrated in Table 19, for example, in order to search for the VNode 30V having a desired function.

As illustrated in FIG. 26, the Local Graph DB 124_1 combines the information concerning the VNode 30V found by itself and the information concerning VNode 30V received from the Global Graph DB 122 and transmits a graph search response message to the M2M API 40_1 (step S1704). The graph search response message can be a message of the same format as the message illustrated in Table 77.

For example, the Local Graph DB 124_1 adds the information concerning the VNode 30V found by itself to the graph search response message received from the Global Graph DB 122 to generate a new graph search response message. The Local Graph DB 124_1 transmits the generated graph search response message to the M2M API 40_1.

When receiving the graph search response message, the M2M API 40_1 stores information (for example, a value of the VNID field or a value of the VNAddress field) concerning the VNode 30V and transmits a node resolution response message to the M2M App 10_11 (step S1705).

Table 78 is a table illustrating the node resolution response message. Table 78 illustrates an example of the node resolution response message transmitted to the M2M App 10_11 by the M2M API 40_1.

TABLE 78
Node resolution response message

| | |
|---|---|
| Type = Node resolution response | |
| Status = OK | |
| No VNs = Num_VNs | |
| VNID = Id_VN | }Num_VPs |

The node resolution response message can include, for example, information concerning a node resolution result. Note that Table 78 illustrates a node resolution response message in the case in which the node resolution is successful.

When a plurality of VNodes 30V are found as a result of the node resolution, the M2M API 40_1 transmits the node resolution response message including information concerning the plurality of VNodes 30V to the M2M App 10_11. Examples of the information concerning the plurality of VNodes 30V include identifiers of the VNodes 30V.

Note that the node resolution response message illustrated here is an example. The M2M API 40_1 can transmit a node resolution response message including information other than the information illustrated in Table 78 to the M2M App 10_11.

In this procedure, the node resolution request/response is a function of the M2M API 40_1 and the graph search request/response is a function of the Prim API.

<5.19. Node-Designated Type Past Data Resolution procedure (the fixed node)>

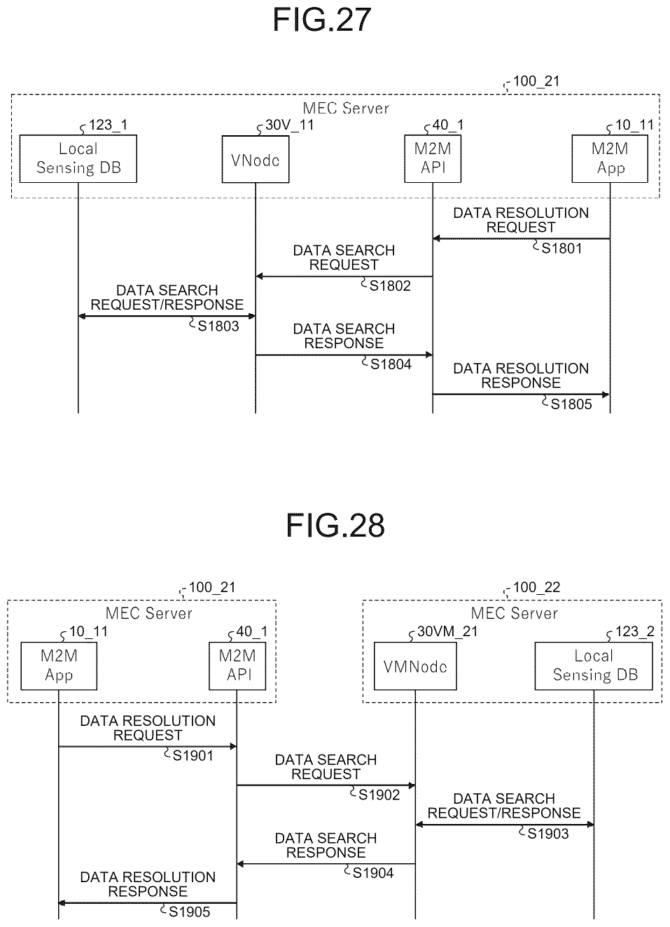

The M2M application 10 can execute node-designated type data resolution after performing the point resolution and/or the node resolution explained above. FIG. 27 is a sequence chart illustrating an example of the node-designated type past data resolution procedure according to the embodiment of the present disclosure. FIG. 27 illustrates a procedure in which the M2M App 10_11 designates the VNode 30V_11 and acquires sensor data observed in the past.

The M2M App 10_11 transmits a data resolution request message to the M2M API 40_1 (step S1801). Table 79 is a table illustrating the data resolution request message. Table 79 illustrates an example of the data resolution request message transmitted to the M2M API 40_1 by the M2M App 10_11 according to the embodiment of the present disclosure.

TABLE 79
Data resolution request message

Type = Data resolution request
Query Type = Node_Past
VNID = Id_VN#11
Capability = CapType
Start Time = Time_Start
End Time = Time_End

The data resolution request message can include, for example, information concerning the VNode 30V_11, which is a data acquisition destination, and information concerning time. For example, the information concerning the time can include time information for designating a period in the past when sensor data was observed (for example, start time and end time of the period).

Note that the data resolution request message illustrated here is an example. The M2M App 10_11 can transmit a data resolution request message including information other than the information illustrated in Table 79 to the M2M API 40_1.

When receiving the data resolution request message, the M2M API 40_1 transmits a data search request message to the VNode 30V_11 (step S1802).

Table 80 is a table illustrating the data search request message. Table 80 illustrates an example of the data search request message transmitted to the VNode 30V_11 by the M2M API 40_1 according to the embodiment of the present disclosure.

TABLE 80
Data search request message

Type = Data search request
Query Type = Node_Past
VNID = Id_VN#11
Capability = CapType
Start Time = Time_Start
End Time = Time_End

The data search request message can include, for example, information concerning a type of a data resolution request and information concerning time. The information concerning the time can be the same information as, for example, the time information included in the data resolution request message.

Note that the data search request message illustrated here is an example. The M2M API 40_1 can transmit a data search request message including information other than the information illustrated in Table 80 to the VNode 30V_11.

When receiving the data search request message, the VNode 30V_11 exchanges a data search request/response with the Local Sensing DB 123_1 (step S1803). Specifically, when receiving the data search request message, the VNode 30V_11 transmits the data search request message to the Local Sensing DB 123_1.

When receiving the data search request message, the Local Sensing 123_1 accesses the database and reads requested data. Thereafter, the Local Sensing DB 123_1 transmits a data search response message to the VNode 30V_11.

Table 81 is a table illustrating the data search response message. Table 81 illustrates an example of the data search response message transmitted to the VNode 30V_11 by the Local Sensing DB 123_1.

TABLE 81
Data search response message

| | | |
|---|---|---|
| Type = Data search response | | |
| Query Type = Node_Past | | |
| Status = OK | | |
| Capability = CapType | | |
| No Values = Num_Values | | |
| Time = Time_Sensed | | Num_Values |
| | {close oversize brace} | |
| Data = Data_Sensed | | |

The data search response message can include, for example, information concerning a data search result and information concerning data (for example, sensor data and an acquisition date and time of the data sensor). When a plurality of sensor data are found as a result of the data search, the Local Sensing DB 123_1 transmits the data search response message including information concerning the plurality of sensor data to the VNode 30V_11.

Note that the data search response message illustrated here is an example. The Local Sensing DB 123_1 can transmit a data search response message including information other than the information illustrated in Table 81 to the VNode 30V_11.

Note that the Local Sensing DB 123_1 searches for sensor data referring to, for example, the VNID field, the Capability field, and the Time field included in the registration data (the sensor data entries) illustrated in Table 46.

As illustrated in FIG. 27, when receiving the data search response message, the VNode 30V_11 transmits the data search response message to the M2M API 40_1 (step S1804).

When receiving the data search response message, the M2M API 40_1 transmits a data resolution response message to the M2M App 10_11 (step S1805).

Table 82 is a table illustrating the data resolution response message. Table 82 illustrates an example of the data resolution response message transmitted to the M2M App 10_11 by the M2M API 40_1.

TABLE 82
Data resolution response message

| | | |
|---|---|---|
| Type = Data resolution response | | |
| Query Type = Node_Past | | |
| Status = OK | | |
| Capability = CapType | | |
| No Values = Num_Values | | |
| Time = Time_Sensed | | Num_Values |
| | {close oversize brace} | |
| Data = Data_Sensed | | |

The data resolution response message can include, for example, information concerning a data resolution result. Note that Table 82 illustrates a data resolution response message in the case in which the data resolution is successful.

When a plurality of sensor data are found as a result of the data resolution, the M2M API 40_1 transmits the data resolution response message including information concerning the plurality of sensor data to the M2M App 10_11. Examples of the information concerning the plurality of sensor data include sensor data and an acquisition date and time of the sensor data.

Note that the data resolution response message illustrated here is an example. The M2M API 40_1 can transmit a data resolution response message including information other than the information illustrated in Table 82 to the M2M App 10_11.

In this procedure, the data resolution request/response is a function of the M2M API 40_1 and the data search request/response is a function of the Prim API.

Note that it is assumed that the M2M App 10_11 designates the VMNode 30VM_11, which is a virtual module corresponding to the PMNode 30PM_11 in which the MEC Server 100_21 on which the M2M App 10_11 operates is the Home MEC Server, and performs node-designated type data resolution. In this case, also when the M2M App 10_11 acquires sensor data observed in the past from the VMNode 30VM_11, the same procedure as the procedure illustrated in FIG. 27 can be executed.

### <5.20. Node-Designated Type Past Data Resolution Procedure (the Mobile Node)>

FIG. 28 is a sequence chart illustrating another example of the node-designated type past data resolution procedure according to the embodiment of the present disclosure. FIG. 28 illustrates a procedure in which the M2M App 10_11 designates the VMNode 30VM_21 and acquires sensor data observed in the past. Note that the VMNode 30VM_21 is a virtual module corresponding to the PMNode 30PM_11 in which a server other than the MEC Server 100_21 on which the M2M App 10_11 operates is the Home MEC Server.

The M2M App 10_11 transmits a data resolution request message to the M2M API 40_1 (step S1901). Table 83 is a table illustrating the data resolution request message. Table 83 illustrates an example of the data resolution request message transmitted to the M2M API 40_1 by the M2M App 10_11 according to the embodiment of the present disclosure.

TABLE 83
Data resolution request message

Type = Data resolution request
Query Type = Node_Past
VNID = Id_VMN#21
Capability = CapType
Start Time = Time_Start
End Time = Time_End

The data resolution request message can be the same as, for example, the message illustrated in Table 79 except that a data acquisition destination is the VMNode 30VM_21.

Note that the data resolution request message illustrated here is an example. The M2M App 10_11 can transmit a data resolution request message including information other than the information illustrated in Table 83 to the M2M API 40_1.

When receiving the data resolution request message, the M2M API 40_1 transmits a data search request message to the VMNode 30VM_21 (step S1902).

Table 84 is a table illustrating the data search request message. Table 84 illustrates an example of the data search request message transmitted to the VMNode 30VM_21 by the M2M API 40_1 according to the embodiment of the present disclosure.

TABLE 84
Data search request message

Type = Data search request
Query Type = Node_Past
VNID = Id_VMN#21
Capability = CapType
Start Time = Time_Start
End Time = Time_End

The data search request message can be the same as, for example, the message illustrated in Table 80 except that a data acquisition destination is the VMNode 30VM_21.

Note that the data search request message illustrated here is an example. The M2M API 40_1 can transmit a data search request message including information other than the information illustrated in Table 80 to the VMNode 30VM_21.

When receiving the data search request message, the VMNode 30VM_21 exchanges a data search request/response with the Local Sensing DB 123_2 (step S1903). Specifically, when receiving the data search request message, the VMNode 30VM_21 transmits the data search request message to the Local Sensing DB 123_2.

When receiving the data search request message, the Local Sensing 123_2 accesses the database and reads requested data. Thereafter, the Local Sensing DB 123_2 transmits a data search response message to the VMNode 30VM_21. The data search response message can be the same format as the message illustrated in Table 81.

When receiving the data search response message, the VMNode 30VM_21 transmits the data search response message to the M2M API 40_1 (step S1904).

When receiving the data search response message, the M2M API 40_1 transmits a data resolution response message to the M2M App 10_11 (step S1905). The data resolution response message can be the same format as the message illustrated in Table 82.

In this procedure, the data resolution request/response is a function of the M2M API 40_1 and the data search request/response is a function of the Prim API.

As explained above, the M2M App 10_11 according to the present embodiment can acquire sensor data measured in the past from the mobile node in the same procedure as the procedure for the fixed node. As explained above, the M2M App 10_11 according to the present embodiment can more easily acquire sensor data from the mobile node.

### <5.21. Node-Designated Type Current Data Resolution Procedure (the Fixed Node)>

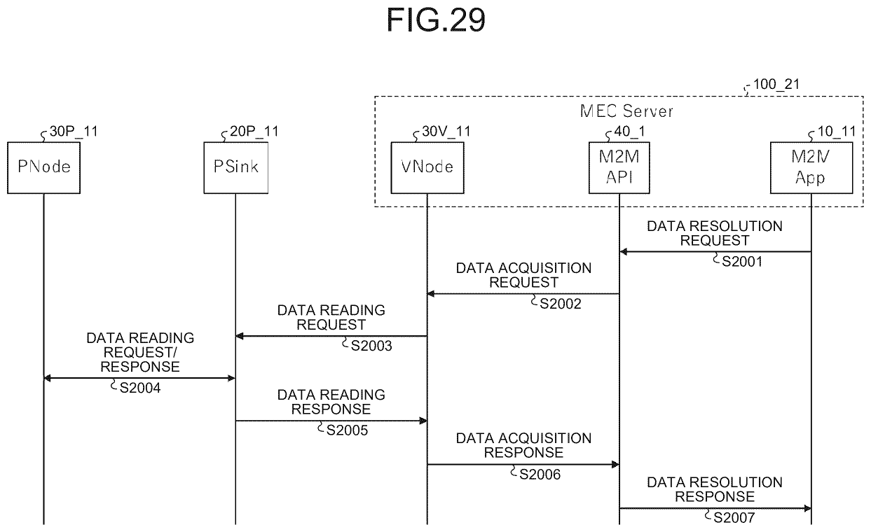

FIG. 29 is a sequence chart illustrating an example of a node-designated type current data resolution procedure according to the embodiment of the present disclosure. FIG. 29 illustrates a procedure in which the M2M App 10_11 designates the VNode 30V_11 and acquires current sensor data.

The M2M App 10_11 transmits a data resolution request message to the M2M API 40_1 (step S2001). Table 85 is a table illustrating the data resolution request message. Table 85 illustrates an example of the data resolution request message transmitted to the M2M API 40_1 by the M2M App 10_11 according to the embodiment of the present disclosure.

TABLE 85
Data resolution request message

Type = Data resolution request
Query Type = Node_Current
VNID = Id_VN#11
Capability = CapType

In the data resolution request message, for example, a type of a data resolution request is a type (Query Type=Node_Current) indicating data resolution for current data. A field indicating a data acquisition period is not included. The other information is the same as, for example, the information of the data resolution request message illustrated in Table 79.

Note that the data resolution request message illustrated here is an example. The M2M App 10_11 can transmit a data resolution request message including information other than the information illustrated in Table 85 to the M2M API 40_1.

When receiving the data resolution request message, the M2M API 40_1 transmits a data acquisition request message to the VNode 30V_11 (step S2002).

Table 86 is a table illustrating the data acquisition request message. Table 86 illustrates an example of the data acquisition request message transmitted to the VNode 30V_11 by the M2M API 40_1 according to the embodiment of the present disclosure.

TABLE 86
Data acquisition request message

Type = Data acquisition request
Query Type = Node_Current
VNID = Id_VN#11
Capability = CapType

The data acquisition request message can include, for example, information concerning a type of a data resolution request and information concerning the VNode 30V_11 that is a data acquisition target.

Note that the data acquisition request message illustrated here is an example. The M2M API 40_1 can transmit a data acquisition request message including information other than the information illustrated in Table 86 to the VNode 30V_11.

When receiving the data acquisition request message, the VNode 30V_11 transmits a data reading request message to the PSink 20P_11 (step S2003).

Table 87 is a table illustrating the data reading request message. Table 87 illustrates an example of the data reading request message transmitted from the VNode 30V_11 to the PSink 20P_11 according to the embodiment of the present disclosure.

TABLE 87
Data reading request message

Type = Data reading request
Capability = CapType

The data reading request message can include, for example, information concerning a type of a data resolution request. Note that the data reading request message illustrated here is an example. The VNode 30V_11 can transmit a data reading request message including information other than the information illustrated in Table 87 to the PSink 20P_11.

When receiving the data search request message, the PSink 20P_11 exchanges a data search request/response with the PNode 30P_11 (step S2004). Specifically, when receiving the data reading request message, the PSink 20P_11 transmits the data reading request message to the PNode 30P_11.

When receiving the data reading request message, the PNode 30P_11 measures sensor data. Thereafter, the PNode 30P_11 transmits a data reading response message including measured sensor data to the PSink 20P_11.

Table 88 is a table illustrating the data reading response message. Table 88 illustrates an example of the data reading response message transmitted to the PSink 20P_11 by the PNode 30P_11.

TABLE 88
Data reading response message

Type = Data reading response
Status = OK
Capability = CapType
Time = Time_Sensed
Data = Data_Sensed

The data reading response message can include, for example, information concerning success or failure of measurement and information concerning measured data (for example, sensor data and an acquisition date and time of the data sensor). Table 88 illustrates a data reading response message in the case in which the data measurement is successful.

Note that the data reading response message illustrated here is an example. The PNode 30P_11 can transmit a data reading response message including information other than the information illustrated in Table 88 to the PSink 20P_11.

When receiving the data reading response message, the PSink 20P_11 transmits the data reading response message to the VNode 30V_11 (step S2005).

When receiving the data reading response message, the VNode 30V_11 transmits a data acquisition response message to the M2M API 40_1 (step S2006).

Table 89 is a table illustrating the data acquisition response message. Table 89 illustrates an example of the data acquisition response message transmitted to the M2M API 40_1 by the VNode 30V_11.

TABLE 89
Data acquisition response message

Type = Data acquisition response
Query Type = Node_Current
Status = OK
Capability = CapType
Time = Time_Sensed
Data = Data_Sensed

The data acquisition response message can include, for example, information concerning success or failure of acquisition and information concerning measured data (for example, sensor data and an acquisition date and time of the data sensor). Table 89 illustrates a data acquisition response message in the case in which the data acquisition is successful.

Note that the data acquisition response message illustrated here is an example. The VNode 30V_11 can transmit a data acquisition response message including information other than the information illustrated in Table 89 to the M2M API 40_1.

When receiving the data acquisition response message, the M2M API 40_1 transmits a data resolution response message to the M2M App 10_11 (step S2007).

Table 90 is a table illustrating the data resolution response message. Table 90 illustrates an example of the data resolution response message transmitted to the M2M App 10_11 by the M2M API 40_1.

TABLE 90
Data resolution response message

Type = Data resolution response
Query Type = Node_Current
Status = OK
Capability = CapType
Time = Time_Sensed
Data = Data_Sensed

The data resolution response message can include, for example, information concerning a data resolution result and information concerning measured data (for example, sensor data and an acquisition date and time of the data sensor). Note that Table 90 illustrates a data resolution response message in the case in which the data resolution is successful.

Note that the data resolution response message illustrated here is an example. The M2M API 40_1 can transmit a data resolution response message including information other than the information illustrated in Table 90 to the M2M App 10_11.

In this procedure, the data resolution request/response is a function of the M2M API 40_1 and the data acquisition request/response is a function of the Prim API. The data reading request/response is a function of the Dev API.

### <5.22. Node-Designated Type Current Data Resolution Procedure (the Mobile Node)>

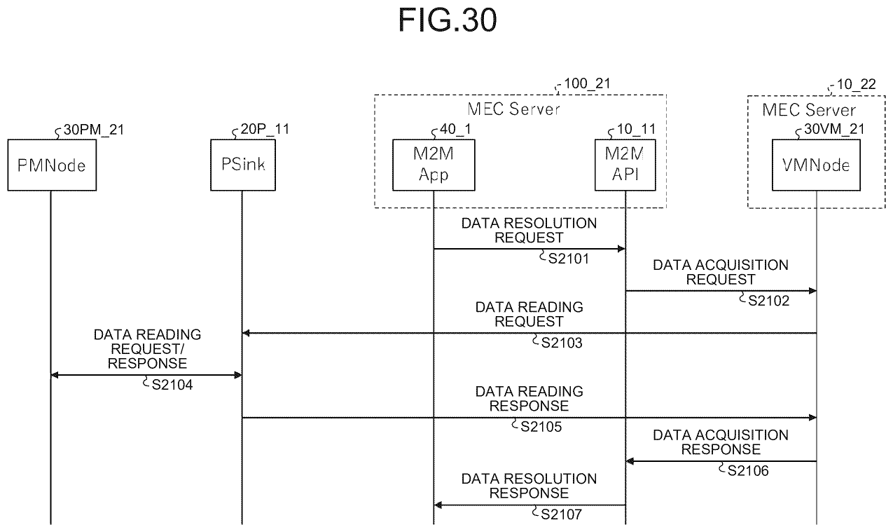

FIG. 30 is a sequence chart illustrating another example of the node-designated type current data resolution procedure according to the embodiment of the present disclosure. FIG. 30 illustrates a procedure in which the M2M App 10_11 designates the VMNode 30VM_21 and acquires current sensor data. Note that the VMNode 30VM_21 is a virtual module corresponding to the PMNode 30PM_11 in which a server other than the MEC Server 100_21 on which the M2M App 10_11 operates is the Home MEC Server.

The M2M App 10_11 transmits a data resolution request message to the M2M API 40_1 (step S2101). Table 91 is a table illustrating the data resolution request message. Table 91 illustrates an example of the data resolution request message transmitted to the M2M API 40_1 by the M2M App 10_11 according to the embodiment of the present disclosure.

TABLE 91
Data resolution request message

Type = Data resolution request
Query Type = Node_Current
VNID = Id_VMN#21
Capability = CapType

The data resolution request message can be the same as, for example, the message illustrated in Table 85 except that a data acquisition destination is the VMNode 30VM_21.

Note that the data resolution request message illustrated here is an example. The M2M App 10_11 can transmit a data resolution request message including information other than the information illustrated in Table 91 to the M2M API 40_1.

When receiving the data resolution request message, the M2M API 40_1 transmits a data acquisition request message to the VMNode 30VM_21 (step S2102).

Table 92 is a table illustrating the data acquisition request message. Table 92 illustrates an example of the data acquisition request message transmitted to the VMNode 30VM_21 by the M2M API 40_1 according to the embodiment of the present disclosure.

TABLE 92
Data acquisition request message

Type = Data acquisition request
Query Type = Node_Current
VNID = Id_VMN#21
Capability = CapType

The data acquisition request message can be the same as, for example, the message illustrated in Table 86 except that a data acquisition destination is the VMNode 30VM_21.

Note that the data acquisition request message illustrated here is an example. The M2M API 40_1 can transmit a data acquisition request message including information other than the information illustrated in Table 92 to the VMNode 30VM_21.

When receiving the data acquisition request message, the VMNode 30VM_21 transmits a data reading request message to the PSink 20P_11 (step S2103). The data reading request message can be the same as, for example, the message illustrated in Table 86.

When receiving the data search request message, the PSink 20P_11 exchanges a data search request/response with the PMNode 30PM_21 (step S2104). Specifically, when receiving the data reading request message, the PSink 20P_11 transmits the data reading request message to the PMNode 30PM_21.

When receiving the data reading request message, the PMNode 30PM_21 measures sensor data. Thereafter, the PMNode 30PM_21 transmits a data reading response message including the measured sensor data to the PSink 20P_11. The data reading response message can be the same as, for example, the message illustrated in Table 88.

When receiving the data reading response message, the PSink 20P_11 transmits the data reading response message to the VMNode 30VM_21 (step S2105).

When receiving the data reading response message, the VMNode 30VM_21 transmits a data acquisition response message to the M2M API 40_1 (step S2106). The data acquisition response message can be the same as, for example, the message illustrated in Table 89.

When receiving the data acquisition response message, the M2M API 40_1 transmits a data resolution response message to the M2M App 10_11 (step S2107). The data resolution response message can be the same as, for example, the message illustrated in Table 90.

In this procedure, the data resolution request/response is a function of the M2M API 40_1 and the data acquisition request/response is a function of the Prim API. The data reading request/response is a function of the Dev API.

As explained above, the M2M App 10_11 according to the present embodiment can acquire the current sensor data from the mobile node in the same procedure as the procedure for the fixed node. As explained above, the M2M App 10_11 according to the present embodiment can more easily acquire sensor data from the mobile node.

### <5.23. Node-Designated Type Condition Satisfaction Data Resolution Procedure (the Fixed Node)>

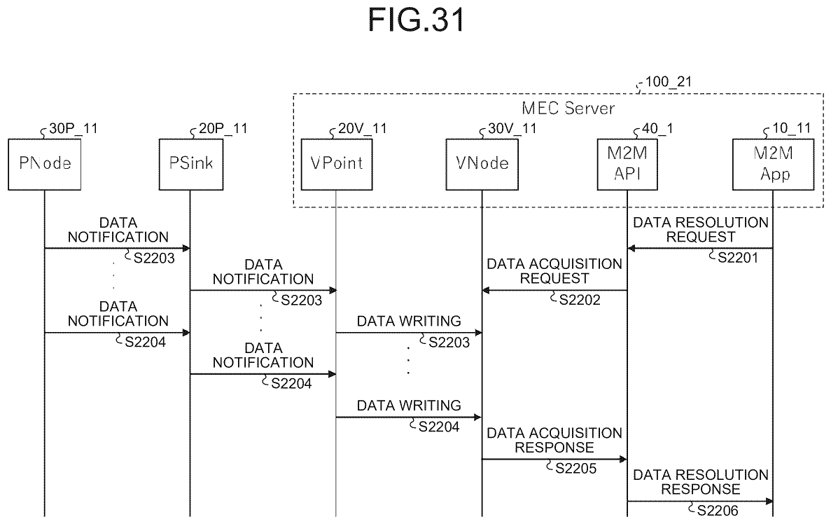

FIG. 31 is a sequence chart illustrating an example of a node-designated type condition satisfaction data resolution procedure according to the embodiment of the present disclosure. FIG. 31 illustrates a procedure in which the M2M App 10_11 designates the VNode 30V_11 and acquires condition satisfaction sensor data.

The M2M App 10_11 acquires sensor data from the VNode 30V_11 at timing when a predetermined condition is satisfied. That is, the M2M App 10_11 executes a node-designated type future data resolution procedure for designating a node and acquiring future data.

The M2M App 10_11 transmits a data resolution request message to the M2M API 40_1 (step S2201). Table 93 is a table illustrating the data resolution request message. Table 93 illustrates an example of the data resolution request message transmitted to the M2M API 40_1 by the M2M App 10_11 according to the embodiment of the present disclosure.

TABLE 93
Data resolution request message

Type = Data resolution request
Query Type = Node_Condition
VNID = Id_VN#11
Capability = CapType
Condition = CondType

In the data resolution request message, for example, a type of a data resolution request is a type (Query Type=Node_Condition) indicating condition satisfaction data resolution. The data resolution request message includes information for designating a data acquisition condition. The other information is the same as, for example, the information of the data resolution request message illustrated in Table 85.

Note that the data resolution request message illustrated here is an example. The M2M App 10_11 can transmit a data resolution request message including information other than the information illustrated in Table 93 to the M2M API 40_1.

When receiving the data resolution request message, the M2M API 40_1 transmits a data acquisition request message to the VNode 30V_11 (step S2202).

Table 94 is a table illustrating the data acquisition request message. Table 94 illustrates an example of the data acquisition request message transmitted to the VNode 30V_11 by the M2M API 40_1 according to the embodiment of the present disclosure.

TABLE 94
Data acquisition request message

Type = Data acquisition request
Query Type = Node_Condition
VNID = Id_VN#11
Capability = CapType
Condition = CondType

In the data acquisition request message, for example, a type of a data resolution request is a type (Query Type=Node_Condition) indicating condition satisfaction data resolution. The data acquisition request message includes information for designating a data acquisition condition. The other information is the same as, for example, the information of the data acquisition request message illustrated in Table 86.

Note that the data acquisition request message illustrated here is an example. The M2M API 40_1 can transmit a data acquisition request message including information other than the information illustrated in Table 94 to the VNode 30V_11.

When receiving the data acquisition request message, the VNode 30V_11 waits for reception of a data notification message including sensor data satisfying a condition (Condition=CondType) included in the data acquisition request message. That is, the VNode 30V_11 determines whether the acquired sensor data satisfies the condition.

The PNode 30P_11 notifies data to the VPoint 20V_11 of data via PSink 20P_11 at, for example, predetermined timing. The VPoint 20V_11 writes the data in the VNode 30V_11 (step S2203). Note that the predetermined timing may be predetermined periodic timing or may be timing corresponding to an instruction from the M2M App 10_11 or the like.

Eventually, the PNode 30P_11 notifies the sensor data satisfying the condition to the VPoint 20V_11 via the PSink 20P_11. The VPoint 20V_11 writes the data in the VNode 30V_11 (step S2204).

Then, the VNode 30V_11 transmits a data acquisition response message including the sensor data satisfying the condition to the M2M API 40_1 (step S2205).

Table 95 is a table illustrating the data acquisition response message. Table 95 illustrates an example of the data acquisition response message transmitted to the M2M API 40_1 by the VNode 30V_11.

TABLE 95
Data acquisition response message

Type = Data acquisition response
Query Type = Node_Condition
VNID = Id_VN#11
Status = OK
Capability = CapType
Time = Time_Sensed
Data = Data_Sensed

In the data acquisition response message, for example, a type of a data resolution request is a type (Query Type=Node_Condition) indicating condition satisfaction data resolution. The data acquisition response message includes information for designating a data acquisition condition. The other information is the same as, for example, the information of the data acquisition response message illustrated in Table 89.

Note that the data acquisition response message illustrated here is an example. The VNode 30V_11 can transmit a data acquisition response message including information other than the information illustrated in Table 95 to the M2M API 40_1.

When receiving the data acquisition response message, the M2M API 40_1 transmits a data resolution response message to the M2M App 10_11 (step S2206).

Table 96 is a table illustrating the data resolution response message. Table 96 illustrates an example of a data resolution response message transmitted to the M2M App 10_11 by the M2M API 40_1.

TABLE 96
Data resolution response message

Type = Data resolution response
Query Type = Node_Condition
VNID = Id_VN#11
Status = OK
Capability = CapType
Time = Time_Sensed
Data = Data_Sensed

In the data resolution response message, for example, a type of a data resolution request is a type (Query Type=Node_Condition) indicating condition satisfaction data resolution. The data resolution response message includes information for designating a data acquisition condition. The other information is the same as, for example, the information of the data resolution response message illustrated in Table 90.

Note that the data resolution response message illustrated here is an example. The M2M API 40_1 can transmit a data resolution response message including information other than the information illustrated in Table 96 to the M2M App 10_11.

In this procedure, the data resolution request/response is a function of the M2M API 40_1 and the data acquisition request/response is a function of the Prim API.

### <5.24. Node-Designated Type Condition Satisfaction Data Resolution Procedure (the Mobile Node)>

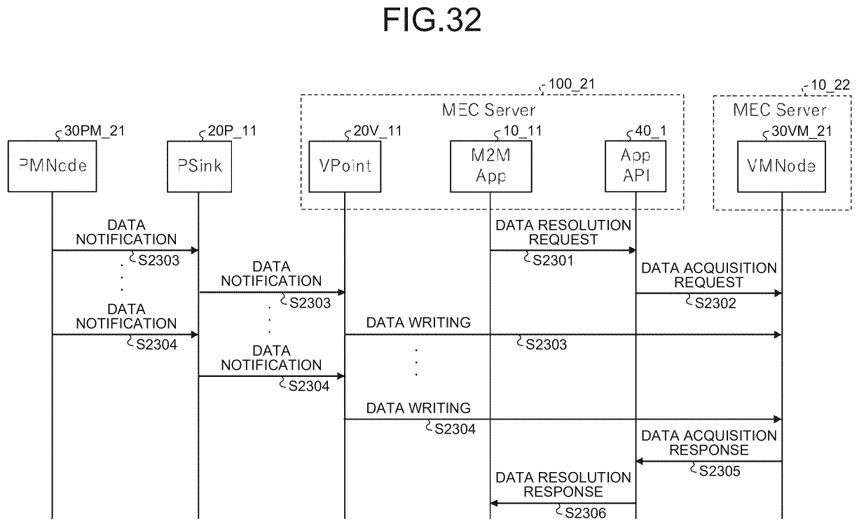

FIG. 32 is a sequence chart illustrating another example of the node-designated type condition satisfaction data resolution procedure according to the embodiment of the present disclosure. FIG. 32 illustrates a procedure in which the M2M App 10_11 designates the VMNode 30VM_21 and acquires condition satisfaction data. Note that the VMNode 30VM_21 is a virtual module corresponding to the PMNode 30PM_11 in which a server other than the MEC Server 100_21 on which the M2M App 10_11 operates is the Home MEC Server.

The M2M App 10_11 acquires sensor data from the VMNode 30VM_21 at timing when a predetermined condition is satisfied. That is, the M2M App 10_11 executes a node-designated type future data resolution procedure for designating a node and acquiring future data.

The M2M App 10_11 transmits a data resolution request message to the M2M API 40_1 (step S2301). Table 97 is a table illustrating the data resolution request message. Table 97 illustrates an example of the data resolution request message transmitted to the M2M API 40_1 by the M2M App 10_11 according to the embodiment of the present disclosure.

TABLE 97
Data resolution request message

Type = Data resolution request
Query Type = Node_Condition
VNID = Id_VMN#21
Capability = CapType
Condition = CondType

The data resolution request message can be the same as, for example, the message illustrated in Table 93 except that a data acquisition destination is the VMNode 30VM_21.

Note that the data resolution request message illustrated here is an example. The M2M App 10_11 can transmit a data resolution request message including information other than the information illustrated in Table 97 to the M2M API 40_1.

When receiving the data resolution request message, the M2M API 40_1 transmits a data acquisition request message to the VMNode 30VM_21 (step S2302).

Table 98 is a table illustrating the data acquisition request message. Table 98 illustrates an example of the data acquisition request message transmitted to the VMNode 30VM_21 by the M2M API 40_1 according to the embodiment of the present disclosure.

TABLE 98
Data acquisition request message

Type = Data acquisition request
Query Type = Node_Condition
VNID = Id_VMN#21
Capability = CapType
Condition = CondType

The data acquisition request message can be the same as, for example, the message illustrated in Table 94 except that a data acquisition destination is the VMNode 30VM_21.

Note that the data acquisition request message illustrated here is an example. The M2M API 40_1 can transmit a data acquisition request message including information other than the information illustrated in Table 98 to the VMNode 30VM_21.

When receiving the data acquisition request message, the VMNode 30VM_21 waits for reception of a data notification message including sensor data satisfying a condition (Condition=CondType) included in the data acquisition request message. That is, the VMNode 30VM_21 determines whether the acquired sensor data satisfies the condition.

The PMNode 30PM_21 notifies data to the VPoint 20V_11 via the PSink 20P_11, for example, at predetermined timing. The VPoint 20V_11 writes the data in the VMNode 30VM_21 (step S2303).

Note that the predetermined timing may be predetermined periodic timing or may be timing corresponding to an instruction from the M2M App 10_11 or the like.

Here, since the PMNode 30PM_21 is communicating with the PSink 20P_11, the PMNode 30PM_21 notifies the sensor data to the VMNode 30VM_21 via the PSink 20P_11 and the VPoint 20V_11. The PMNode 30PM_21 notifies the sensor data to the VMNode 30VM_21 via the PSink 20P connected at a point in time when the sensor data is notified and the VPoint 20V_11 corresponding to the PSink 20P. For that reason, the PMNode 30PM_21 can notify the sensor data via the PSink 20P other than the PSink 20P_11.

Eventually, the PMNode 30PM_21 notifies the sensor data satisfying the condition to the VPoint 20V_11 via the PSink 20P_11 and the VPoint 20V_11 writes the data in the VMNode 30VM_21 (step S2304).

Then, the VMNode 30VM_21 transmits a data acquisition response message including the sensor data satisfying the condition to the M2M API 40_1 (step S2305).

Table 99 is a table illustrating the data acquisition response message. Table 99 illustrates an example of the data acquisition response message transmitted to the M2M API 40_1 by the VMNode 30VM_21.

TABLE 99
Data acquisition response message

Type = Data acquisition response
Query Type = Node_Condition
VNID = Id_VMN#21
Status = OK
Capability = CapType
Time = Time_Sensed
Data = Data_Sensed

The data acquisition response message can be the same as, for example, the message illustrated in Table 95 except that a data acquisition destination is the VMNode 30VM_21.

Note that the data acquisition response message illustrated here is an example. The VMNode 30VM_21 can transmit a data acquisition response message including information other than the information illustrated in Table 99 to the M2M API 40_1.

When receiving the data acquisition response message, the M2M API 40_1 transmits a data resolution response message to the M2M App 10_11 (step S2306).

Table 100 is a table illustrating the data resolution response message. Table 100 illustrates an example of the data resolution response message transmitted to the M2M App 10_11 by the M2M API 40_1.

TABLE 100
Data resolution response message

Type = Data resolution response
Query Type = Node_Condition
VNID = Id_VMN#21
Status = OK
Capability = CapType
Time = Time_Sensed
Data = Data_Sensed

The data acquisition response message can be the same as, for example, the message illustrated in Table 96 except that a data acquisition destination is the VMNode 30VM_21.

Note that the data resolution response message illustrated here is an example. The M2M API 40_1 can transmit a data resolution response message including information other than the information illustrated in Table 100 to the M2M App 10_11.

In this procedure, the data resolution request/response is a function of the M2M API 40_1 and the data acquisition request/response is a function of the Prim API.

As explained above, the M2M App 10_11 according to the present embodiment can acquire the condition satisfaction data from the mobile node in the same procedure as the procedure for the fixed node. As explained above, the M2M App 10_11 according to the present embodiment can more easily acquire sensor data from the mobile node.

### <5.25. Point-Designated Type Past Data Resolution Procedure>

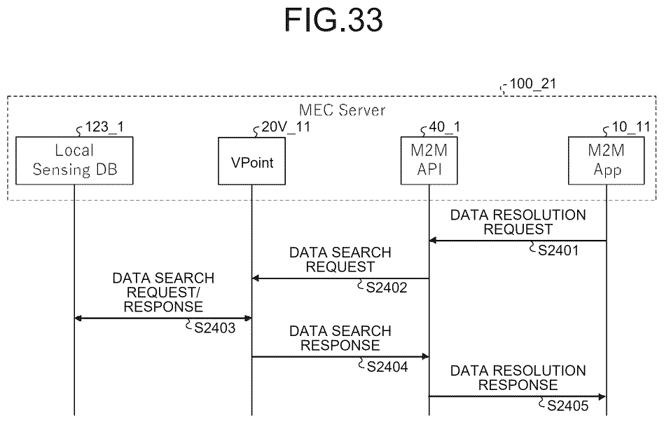

FIG. 33 is a sequence chart illustrating an example of a point-designated type past data resolution procedure according to the embodiment of the present disclosure. FIG. 33 illustrates a procedure in which the M2M App 10_11 designates the VPoint 20V_11 and acquires sensor data observed in the past.

The M2M App 10_11 transmits a data resolution request message to the M2M API 40_1 (step S2401). Table 101 is a table illustrating the data resolution request message. Table 101 illustrates an example of the data resolution request message transmitted to the M2M API 40_1 by the M2M App 10_11 according to the embodiment of the present disclosure.

TABLE 101
Data resolution request message

Type = Data resolution request
Query Type = Point_Past
VPID = Id_VP#11
Capability = CapType
Start Time = Time_Start
End Time = Time_End

In the data resolution request message, for example, a type of a data resolution request is a type (Query Type=Point_Past) indicating point-designated type past data resolution. A field (VPID=Id_VP #11) for designating the VPoint 20V_11 is included instead of a field for designating the VNode 30V_11. The other information is the same as, for example, the information of the data resolution request message illustrated in Table 79.

Note that the data resolution request message illustrated here is an example. The M2M App 10_11 can transmit a data resolution request message including information other than the information illustrated in Table 101 to the M2M API 40_1. When receiving the data resolution request message, the M2M API 40_1 transmits a data search request message to the VPoint 20V_11 (step S2402).

Table 102 is a table illustrating the data search request message. Table 102 illustrates an example of the data search request message transmitted to the VPoint 20V_11 by the M2M API 40_1 according to the embodiment of the present disclosure.

TABLE 102
Data search request message

Type = Data search request
Query Type = Point_Past
VPID = Id_VP#11
Capability = CapType
Start Time = Time_Start
End Time = Time_End

In the data search request message, for example, a type of a data resolution request is a type (Query Type=Point_Past) indicating point-designated type past data resolution. A field (VPID=Id_VP #11) for designating the VPoint 20V_11 is included instead of a field for designating the VNode 30V_11. The other information is the same as, for example, the information of the data search request message illustrated in Table 80.

Note that the data search request message illustrated here is an example. The M2M API 40_1 can transmit a data search request message including information other than the information illustrated in Table 102 to the VPoint 20V_11.

When receiving the data search request message, the VPoint 20V_11 exchanges a data search request/response with the Local Sensing DB 123_1 (step S2403). Specifically, when receiving the data search request message, the VPoint 20V_11 transmits the data search request message to the Local Sensing DB 123_1.

When receiving the data search request message, the Local Sensing 123_1 accesses the database and reads requested data. Thereafter, the Local Sensing DB 123_1 transmits a data search response message including the read data to the VPoint 20V_11.

Table 103 is a table illustrating the data search response message. Table 103 illustrates an example of the data search response message transmitted to VPoint 20V_11 by the Local Sensing DB 123_1.

TABLE 103
Data search response message

| | | |
|---|---|---|
| Type = Data search response | | |
| Query Type = Point_Past | | |
| Status = OK | | |
| Capability = CapType | | |
| No Values = Num_Values | | |
| Time = Time_Sensed | | Num_Values |
| | {close oversize brace} | |
| Data = Data_Sensed | | |

In the data search response message, for example, a type of a data resolution request is a type (Query Type=Point_Past) indicating point-designated type past data resolution. The other information is the same as, for example, the information of the data search response message illustrated in Table 81.

Note that the data search response message illustrated here is an example. The Local Sensing DB 123_1 can transmit a data search response message including information other than the information illustrated in Table 103 to the VPoint 20V_11.

Note that the Local Sensing DB 123_1 searches for sensor data referring to, for example, the VNID field, the Capability field, and the Time field included in the registration data (the sensor data entries) illustrated in Table 46.

As illustrated in FIG. 33, when receiving the data search response message, the VPoint 20V_11 transmits the data search response message to the M2M API 40_1 (step S2404).

When receiving the data search response message, the M2M API 40_1 transmits a data resolution response message to the M2M App 10_11 (step S2405).

Table 104 is a table illustrating the data resolution response message. Table 104 illustrates an example of the data resolution response message transmitted to the M2M App 10_11 by the M2M API 40_1.

TABLE 104
Data resolution response message

| | | |
|---|---|---|
| Type = Data resolution response | | |
| Query Type = Point_Past | | |
| Status = OK | | |
| Capability = CapType | | |
| No Values = Num_Values | | |
| Time = Time_Sensed | | Num_Values |
| | {close oversize brace} | |
| Data = Data_Sensed | | |

In the data search response message, for example, a type of a data resolution request is a type (Query Type=Point_Past) indicating point-designated type past data resolution. The other information is the same as, for example, the information of the data search response message illustrated in Table 82.

Note that the data resolution response message illustrated here is an example. The M2M API 40_1 can transmit a data resolution response message including information other than the information illustrated in Table 104 to the M2M App 10_11.

As explained above with reference to FIG. 20, the data that is measured by the PMNode 30PM_21 temporarily connected to the PSink 20P_11 and is registered in the VMNode 30VM_21 is also stored in the Local Sensing DB 123_1. For that reason, the M2M application 10 can also obtain the sensor data registered by the mobile node by executing the procedure illustrated in FIG. 33. As explained above, the M2M application 10 according to the present embodiment can more easily acquire the sensor data from the mobile node.

### <5.26. Point-Designated Type Current Data Resolution Procedure>

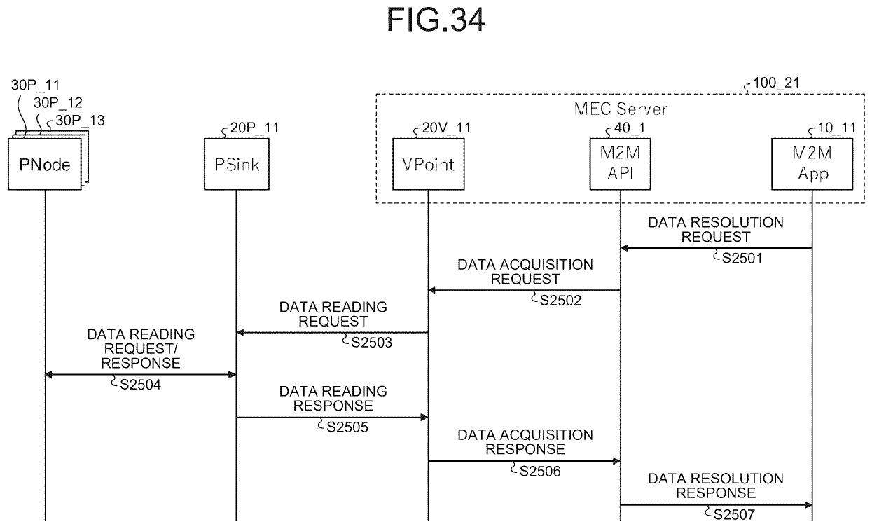

FIG. 34 is a sequence chart illustrating an example of a point-designated type current data resolution procedure according to the embodiment of the present disclosure. FIG. 34 illustrates a procedure in which the M2M App 10_11 designates the VPoint 20V_11 and acquires current sensor data.

The M2M App 10_11 transmits a data resolution request message to the M2M API 40_1 (step S2501). Table 105 is a table illustrating the data resolution request message. Table 105 illustrates an example of the data resolution request message transmitted to the M2M API 40_1 by the M2M App 10_11 according to the embodiment of the present disclosure.

TABLE 105
Data resolution request message

Type = Data resolution request
Query Type = Point_Current
VPID = Id_VP#11
Capability = CapType

In the data resolution request message, for example, a type of a data resolution request is a type (Query Type=Point_Current) indicating point-type current data resolution. A field (VPID=Id_VP #11) for designating the VPoint 20V_11 is included instead of a field for designating the VNode 30V_11. The other information is the same as, for example, the information of the data resolution request message illustrated in Table 85.

Note that the data resolution request message illustrated here is an example. The M2M App 10_11 can transmit a data resolution request message including information other than the information illustrated in Table 105 to the M2M API 40_1.

When receiving the data resolution request message, the M2M API 40_1 transmits a data acquisition request message to the VPoint 20V_11 (step S2502).

Table 106 is a table illustrating the data acquisition request message. Table 106 illustrates an example of the data acquisition request message transmitted to the VPoint 20V_11 by the M2M API 40_1 according to the embodiment of the present disclosure.

TABLE 106
Data acquisition request message

Type = Data acquisition request
Query Type = Point_Current
VPID = Id_VP#11
Capability = CapType

In the data acquisition request message, for example, a type of a data resolution request is a type (Query Type=Point_Current) indicating point-type current data resolution. A field (VPID=Id_VP #11) for designating the VPoint 20V_11 is included instead of a field for designating the VNode 30V_11. The other information is the same as, for example, the information of the data acquisition request message illustrated in Table 86.

Note that the data acquisition request message illustrated here is an example. The M2M API 40_1 can transmit a data acquisition request message including information other than the information illustrated in Table 106 to the VPoint 20V_11.

When receiving the data acquisition request message, the VPoint 20V_11 transmits a data reading request message to the PSink 20P_11 (step S2503). The data reading request message can be the same as, for example, the data reading request message illustrated in Table 87.

When receiving the data search request message, the PSink 20P_11 exchanges a data search request/response with the PNode 30P (the PNodes 30P_11 to 30P_13 in FIG. 34) connected to the PSink 20P_11 (step S2504). Specifically, when receiving the data reading request message, PSink 20P_11 transmits the data reading request message to the PNode PNodes 30P_11 to 30P_13.

When receiving the data reading request message, the PNodes 30P_11 to 30P_13 measure sensor data. Thereafter, the PNodes 30P_11 to 30P_13 respectively transmit data reading response messages including the measured sensor data to the PSink 20P_11. The data reading response messages can be the same as, for example, the data reading response message illustrated in Table 88.

When receiving the data reading response messages respectively from the PNodes 30P_11 to 30P_13, the PSink 20P_11 transmits the data reading response messages to the VPoint 20V_11 (step S2505).

When receiving the data reading response messages, the VPoint 20V_11 transmits the data acquisition response messages to the M2M API 40_1 (step S2506).

Table 107 is a table illustrating the data acquisition response message. Table 107 illustrates an example of the data acquisition response message transmitted to the M2M API 40_1 by the VPoint 20V_11.

TABLE 107
Data acquisition response message

| | | |
|---|---|---|
| Type = Data acquisition response | | |
| Query Type = Point_Current | | |
| Status = OK | | |
| Capability = CapType | | |
| No Values = Num_Values | | |
| Time = Time_Sensed | | Num_Values |
| | {close oversize brace} | |
| Data = Data_Sensed | | |

In the data acquisition response message, for example, a type of a data resolution request is a type (Query Type=Point_Current) indicating point-type current data resolution. For example, information (for example, sensor data and an acquisition date and time of the data sensor) concerning data measured by at least one PNode 30P (the PNode 30P_11 to 30P_13 in FIG. 34) is included. Otherwise, the data resolution request data is the same as, for example, the data resolution request message illustrated in Table 89.

Note that the data acquisition response message illustrated here is an example. The VPoint 20V_11 can transmit a data acquisition response message including information other than the information illustrated in Table 107 to the M2M API 40_1.

When receiving the data acquisition response message, the M2M API 40_1 transmits a data resolution response message to the M2M App 10_11 (step S2507).

Table 108 is a table illustrating the data resolution response message. Table 108 illustrates an example of the data resolution response message transmitted to the M2M App 10_11 by the M2M API 40_1.

TABLE 108
Data resolution response message

| | | |
|---|---|---|
| Type = Data resolution response | | |
| Query Type = Point_Current | | |
| Status = OK | | |
| Capability = CapType | | |
| No Values = Num_Values | | |
| Time = Time_Sensed | | Num_Values |
| | {close oversize brace} | |
| Data = Data_Sensed | | |

In the data acquisition response message, for example, a type of a data resolution request is a type (Query Type=Point_Current) indicating point-type current data resolution. For example, information (for example, sensor data and an acquisition date and time of the data sensor) concerning data measured by at least one PNode 30P (the PNode 30P_11 to 30P_13 in FIG. 34) is included. Otherwise, the data resolution response message is the same as, for example, the data resolution request message illustrated in Table 90.

Note that the data resolution response message illustrated here is an example. The M2M API 40_1 can transmit a data resolution response message including information other than the information illustrated in Table 108 to the M2M App 10_11.

Here, the PSink 20P_11 acquires sensor data from the PNode 30P connected to the PSink 20P_11. However, the PSink 20P_11 can also acquire data from a mobile node (for example, the PMNode 30PM_11 or 30PM_21) connected to the PSink 20P_11.

As explained above with reference to FIG. 17, the VPoint 20V_11 manages the connection status of the PMNode 30PM_21 temporarily connected to the PSink 20P_11. For that reason, the M2M application 10 can also obtain sensor data measured by the mobile node by executing the procedure illustrated in FIG. 34. As explained above, the M2M application 10 according to the present embodiment can more easily acquire the sensor data from the mobile node.

### <5.27. Point-Designated Type Condition Satisfaction Data Resolution Procedure>

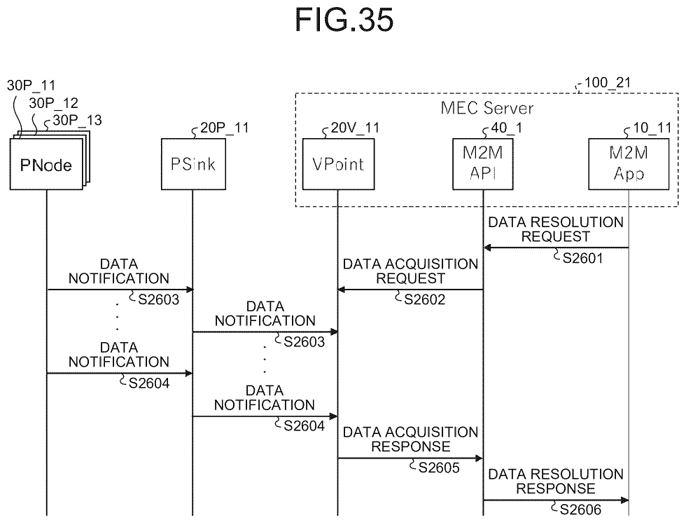

FIG. 35 is a sequence chart illustrating an example of a point-designated type condition satisfaction data resolution procedure according to the embodiment of the present disclosure. FIG. 35 illustrates a procedure in which the M2M App 10_11 designates the VPoint 20V_11 and acquires condition satisfaction sensor data.

The M2M App 10_11 acquires sensor data from the VPoint 20V_11 at timing when a predetermined condition is satisfied. That is, the M2M App 10_11 executes a point-designated type future data resolution procedure for designating a node and acquiring future data.

The M2M App 10_11 transmits a data resolution request message to the M2M API 40_1 (step S2601). Table 109 is a table illustrating the data resolution request message. Table 109 illustrates an example of the data resolution request message transmitted to the M2M API 40_1 by the M2M App 10_11 according to the embodiment of the present disclosure.

TABLE 109
Data resolution request message

Type = Data resolution request
Query Type = Point_Condition
VPID = Id_VP#11
Capability = CapType
Condition = CondType

In the data resolution request message, for example, a type of a data resolution request is a type (Query Type=Point_Condition) indicating point-type condition satisfaction data resolution. A field (VPID=Id_VP #11) for designating the VPoint 20V_11 is included instead of a field for designating the VNode 30V_11. The other information is the same as, for example, the information of the data resolution request message illustrated in Table 93.

Note that the data resolution request message illustrated here is an example. The M2M App 10_11 can transmit a data resolution request message including information other than the information illustrated in Table 109 to the M2M API 40_1.

When receiving the data resolution request message, the M2M API 40_1 transmits a data acquisition request message to the VPoint 20V_11 (step S2602).

Table 110 is a table illustrating the data acquisition request message. Table 110 illustrates an example of the data acquisition request message transmitted to the VPoint 20V_11 by the M2M API 40_1 according to the embodiment of the present disclosure.

TABLE 110
Data acquisition request message

Type = Data acquisition request
Query Type = Point_Condition
VPID = Id_VP#11
Capability = CapType
Condition = CondType

In the data acquisition request message, for example, a type of a data resolution request is the type (Query Type=Point_Condition) indicating the point-type condition satisfaction data resolution. A field (VPID=Id_VP #11) for designating the VPoint 20V_11 is included instead of a field for designating the VNode 30V_11. The other information is the same as, for example, the information of the data acquisition request message illustrated in Table 94.

Note that the data acquisition request message illustrated here is an example. The M2M API 40_1 can transmit a data acquisition request message including information other than the information illustrated in Table 110 to the VPoint 20V_11.

When receiving the data acquisition request message, the VPoint 20V_11 waits for reception of a data notification message including sensor data satisfying a condition (Condition=CondType) included in the data acquisition request message. That is, the VPoint 20V_11 determines whether the acquired sensor data satisfies the condition.

At least one PNode 30P connected to the PSink 20P_11 notifies data to the VPoint 20V_11 via PSink 20P_11, for example, at predetermined timing and the VPoint 20V_11 writes the data in the VNode 30V_11 (step S2603).

The PSink 20P_11 is a physical sink corresponding to the VPoint 20V_11. FIG. 35 illustrates an example in which the PNodes 30P_11 to 30P_13 notify data. The predetermined timing may be predetermined periodic timing or may be timing corresponding to an instruction from the M2M App 10_11 or the like.

Eventually, at least one of the PNodes 30P_11 to 30P_13 notifies the sensor data satisfying the condition to the VPoint 20V_11 via the PSink 20P_11 (step S2604).

Then, the VPoint 20V_11 transmits a data acquisition response message including the sensor data satisfying the condition to the M2M API 40_1 (step S2605).

Table 111 is a table illustrating the data acquisition response message. Table 111 illustrates an example of the data acquisition response message transmitted to the M2M API 40_1 by the VPoint 20V_11.

TABLE 111
Data acquisition response message

Type = Data acquisition response
Query Type = Point_Condition
VPID = Id_VP#11
Status = OK
Capability = CapType
Time = Time_Sensed
Data = Data_Sensed

In the data acquisition response message, for example, a type of a data resolution request is the type (Query Type=Point_Condition) indicating the point-type condition satisfaction data resolution. A field (VPID=Id_VP #11) for designating the VPoint 20V_11 is included instead of a field for designating the VNode 30V_11. The other information is the same as, for example, the information of the data acquisition response message illustrated in Table 95.

Note that the data acquisition response message illustrated here is an example. The VPoint 20V_11 can transmit a data acquisition response message including information other than the information illustrated in Table 111 to the M2M API 40_1.

When receiving the data acquisition response message, the M2M API 40_1 transmits a data resolution response message to the M2M App 10_11 (step S2606).

Table 112 is a table illustrating the data resolution response message. Table 112 illustrates an example of the data resolution response message transmitted to the M2M App 10_11 by the M2M API 40_1.

TABLE 112
Data resolution response message

Type = Data resolution response
Query Type = Point_Condition
VPID = Id_VP#11
Status = OK
Capability = CapType
Time = Time_Sensed
Data = Data_Sensed

In the data resolution response message, for example, a type of a data resolution request is the type (Query Type=Point_Condition) indicating the point-type condition satisfaction data resolution. A field (VPID=Id_VP #11) for designating the VPoint 20V_11 is included instead of a field for designating the VNode 30V_11. The other information is the same as, for example, the information of the data resolution response message illustrated in Table 96.

Note that the data resolution response message illustrated here is an example. The M2M API 40_1 can transmit a data resolution response message including information other than the information illustrated in Table 112 to the M2M App 10_11.

Here, the VPoint 20V_11 acquires sensor data from the PNode 30P connected to the PSink 20P_11. However, the PSink 20P_11 can also acquire data from a mobile node (for example, the PMNode 30PM_11 or 30PM_21) connected to the PSink 20P_11.

Timings at which the plurality of PNodes 30P notify data may be different or may be the same in the PNodes 30P.

### <5.28. Operation Instruction Procedure (the Fixed Node)>

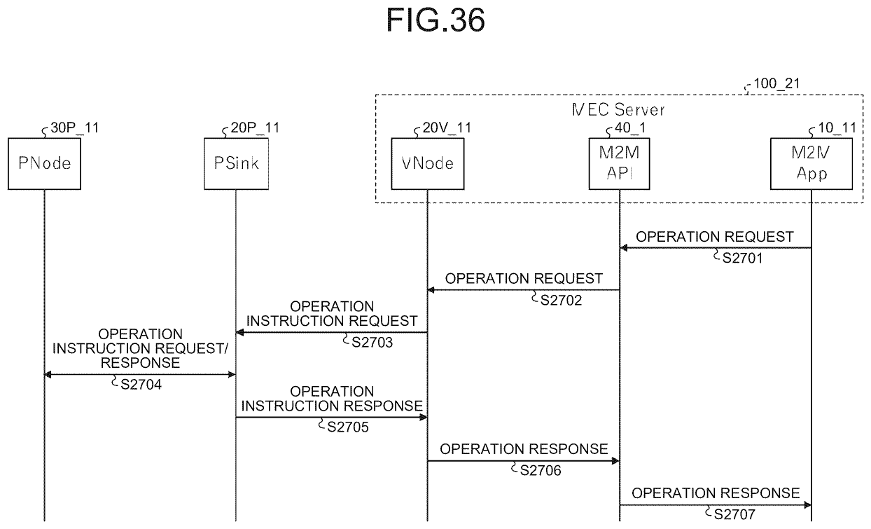

FIG. 36 is a sequence chart illustrating an example of an operation instruction procedure according to the embodiment of the present disclosure. FIG. 36 illustrates a procedure in which the M2M App 10_11 designates the VNode 30V_11 and instructs an operation.

The M2M App 10_11 transmits an operation request message to the M2M API 40_1 (step S2701). Table 113 is a table illustrating the operation request message. Table 113 illustrates an example of the operation request message transmitted to the M2M API 40_1 by the M2M App 10_11 according to the embodiment of the present disclosure.

TABLE 113
Operation request message

Type = Operation request
VNID = Id_VN#11
Action = Act_Name
Param = Act_Param

The operation request message can include, for example, information for designating an operation instruction target and information concerning operation content. Note that the operation request message illustrated here is an example. The M2M App 10_11 can transmit an operation request message including information other than the information illustrated in Table 113 to the M2M API 40_1.

When receiving the operation request message, the M2M API 40_1 transmits the operation request message to the VNode 30V_11 (step S2702).

When receiving the operation request message, the VNode 30V_11 transmits an operation instruction request message to the PSink 20P_11 (step S2703). Table 114 is a table illustrating the operation instruction request message. Table 114 illustrates an example of the operation instruction request message transmitted to the PSink 20P_11 by the VNode 30V_11 according to the embodiment of the present disclosure.

TABLE 114
Operation instruction request message

Type = Operation instruction request
Action = Act_Name
Param = Act_Param

The operation instruction request message can include, for example, information concerning operation content. Note that the operation instruction request message illustrated here is an example. The VNode 30V_11 can transmit an operation instruction request message including information other than the information illustrated in Table 114 to the PSink 20P_11.

When receiving the operation instruction request message, the PSink 20P_11 exchanges an operation instruction request/response with the PNode 30P_11 (step S2704). Specifically, when receiving the operation instruction request message, the PSink 20P_11 transmits the operation instruction request message to the PNode 30P_11.

When receiving the operation instruction request message, the PNode 30P_11 performs an operation as instructed and transmits an operation instruction response message to the PSink 20P_11.

Table 115 is a table illustrating the operation instruction response message. Table 115 illustrates an example of the operation instruction response message transmitted to the PSink 20P_11 by the PNode 30P_11 according to the embodiment of the present disclosure.

TABLE 115
Operation instruction response message

Type = Operation instruction response
Status = OK

The operation instruction response message can include, for example, information concerning success or failure of the operation. Here, an operation instruction request message in the case in which the operation is successful is illustrated. Note that the operation instruction request message illustrated here is an example. The PNode 30P_11 can transmit an operation instruction response message including information other than the information illustrated in Table 115 to the PSink 20P_11.

When receiving the operation instruction response message, the PSink 20P_11 transmits the operation instruction response message to the VNode 30V_11 (step S2705).

When receiving the operation instruction response message, the VNode 30V_11 transmits an operation response message to the M2M API 40_1 (step S2706).

Table 116 is a table illustrating the operation response message. Table 116 illustrates an example of the operation response message transmitted to the M2M API 40_1 by the VNode 30V_11 according to the embodiment of the present disclosure.

TABLE 116
Operation response message

Type = Operation response
VNID = Id_VN#11
Status = OK

The operation response message can include, for example, information concerning success or failure of the operation. Here, an operation request message in the case in which the operation is successful is illustrated. Note that the operation request message illustrated here is an example. The VNode 30V_11 can transmit an operation response message including information other than the information illustrated in Table 116 to the M2M API 40_1.

When receiving the operation response message, the M2M API 40_1 transmits the operation response message to the M2M App 10_11 (step S2707).

### <5.29. Operation Instruction Procedure (the Mobile Node)>

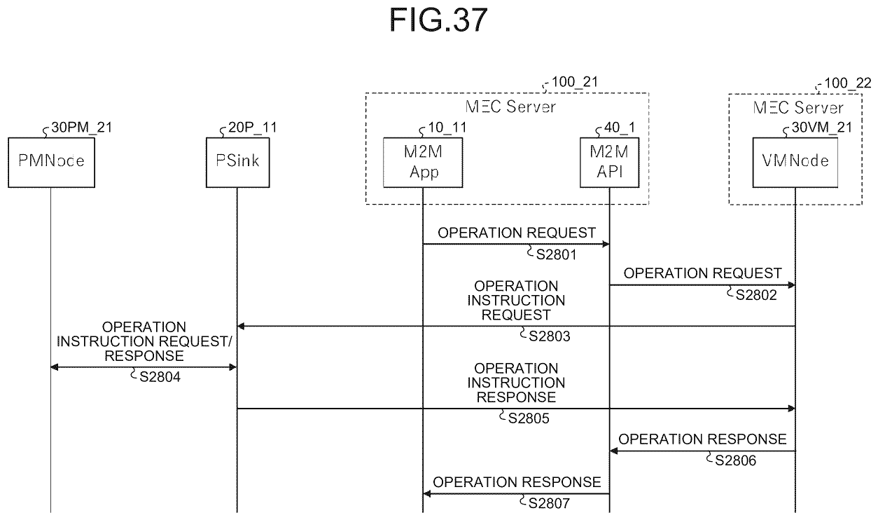

FIG. 37 is a sequence chart illustrating another example of the operation instruction procedure according to the embodiment of the present disclosure. FIG. 37 illustrates a procedure in which the M2M App 10_11 designates the VMNode 30VM_21 and instructs an operation. Note that the VMNode 30VM_21 is a virtual module corresponding to the PMNode 30PM_11 in which a server other than the MEC Server 100_21 on which the M2M App 10_11 operates is the Home MEC Server.

The M2M App 10_11 transmits an operation request message to the M2M API 40_1 (step S2801). Table 117 is a table illustrating the operation request message. Table 117 illustrates an example of the operation request message transmitted to the M2M API 40_1 by the M2M App 10_11 according to the embodiment of the present disclosure.

TABLE 117
Operation request message

Type = Operation request
VNID = Id_VMN#21
Action = Act_Name
Param = Act_Param

The operation request message can be the same as the message illustrated in Table 113 except that, for example, an operation instruction target is the VMNode 30VM_21. Note that the operation request message illustrated here is an example. The M2M App 10_11 can transmit an operation request message including information other than the information illustrated in Table 117 to the M2M API 40_1.

When receiving the operation request message, the M2M API 40_1 transmits the operation request message to the VMNode 30VM_21 (step S2802).

When receiving the operation request message, the VMNode 30VM_21 transmits an operation instruction request message to the PSink 20P_11 (step S2803). The operation instruction request message can be the same as the message illustrated in Table 114.

When receiving the operation instruction request message, the PSink 20P_11 exchanges an operation instruction request/response with the PMNode 30PM_21 (step S2804). Specifically, when receiving the operation instruction request message, the PSink 20P_11 transmits the operation instruction request message to the PMNode 30PM_21.

When receiving the operation instruction request message, the PMNode 30PM_21 performs an operation as instructed and transmits an operation instruction response message to the PSink 20P_11. The operation instruction response message can be the same as the message illustrated in Table 115.

When receiving the operation instruction response message, the PSink 20P_11 transmits the operation instruction response message to the VMNode 30VM_21 (step S2805).

When receiving the operation instruction response message, the VMNode 30VM_21 transmits an operation response message to the M2M API 40_1 (step S2806).

Table 118 is a table illustrating the operation response message. Table 118 illustrates an example of the operation response message transmitted to the M2M API 40_1 by the VMNode 30VM_21 according to the embodiment of the present disclosure.

TABLE 118
Operation response message

Type = Operation response
VNID = Id_VMN#21
Status = OK

The operation response message can be the same as the message illustrated in Table 116 except that, for example, an operation instruction target is the VMNode 30VM_21. Note that the operation response message illustrated here is an example. The VMNode 30VM_21 can transmit an operation response message including information other than the information illustrated in Table 118 to the M2M API 40_1.

When receiving the operation response message, the M2M API 40_1 transmits the operation response message to the M2M App 10_11 (step S2807).

As explained above, the M2M App 10_11 according to the present embodiment can instruct, in the same procedure as the procedure for the fixed node, the mobile node to perform an operation. As explained above, the M2M App 10_11 according to the present embodiment can more easily instruct the mobile node to perform an operation.

### 6. Other Embodiments

The embodiment explained above indicates an example. Various changes and applications of the embodiment are possible.

For example, a control device that controls the information processing device 100, the communication device 200, and the wireless communication device 300 in the embodiment explained above may be implemented by a dedicated computer system or may be implemented by a general-purpose computer system.

For example, a communication program for executing the operation explained above is distributed by being stored in a computer-readable recording medium such as an optical disk, a semiconductor memory, a magnetic tape, or a flexible disk. Then, for example, the control device is configured by installing the program in a computer and executing the processing explained above. At this time, the control device may be a device (for example, a personal computer) outside a transmission device and a reception device. The control device may be a device (for example, the control units 130, 250, and 350) inside the transmission device or the reception device.

The communication program explained above may be stored in a disk device included in a server device on a network such as the Internet to make it possible to download the communication program to a computer. The functions explained above may be implemented by cooperation of an OS (Operating System) and application software. In this case, a portion other than the OS may be stored in a medium and distributed or the portion other than the OS may be stored in the server device to make it possible to download the portion to the computer.

Among the kinds of processing explained in the embodiment, all or a part of the processing explained as being automatically performed can be manually performed or all or a part of the processing explained as being manually performed can be automatically performed by a publicly-known method. Besides, the processing procedures, the specific names, and the information including the various data and parameters explained in the above document and illustrated in the drawings can be optionally changed except when specifically noted otherwise. For example, the various kinds of information illustrated in the drawings and the tables are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing processing contents to contradict one another. Furthermore, the order of the steps illustrated in the flowcharts and the sequence charts in the embodiment explained above can be changed as appropriate.

For example, the present embodiment can be implemented as any configuration configuring a device or a system, for example, a processor functioning as a system LSI (Large Scale Integration) or the like, a module using a plurality of processors or the like, a unit using a plurality of modules or the like, a set obtained by further adding other functions to the unit, and the like (that is, a configuration of a part of the device).

Note that, in the present embodiments, the system means a set of a plurality of components (devices, modules (components), and the like). It does not matter whether all the components are present in the same housing. Therefore, both of a plurality of devices housed in separate housings and connected via a network and one device in which a plurality of modules are housed in one housing are systems.

For example, the present embodiment can adopt a configuration of cloud computing in which one function is shared and processed by a plurality of devices in cooperation via a network.

### 7. Conclusion

Although the embodiment of the present disclosure is explained above, the technical scope of the present disclosure is not limited to the embodiment per se, and various modifications can be made without departing from the gist of the present disclosure. Components in different embodiments and modifications may be combined as appropriate.

The effects in the embodiments described in the present specification are only illustrations and are not limited. Other effects may be present.

Note that the present technique can also take the following configurations.

(1)

An information processing method in which an information processing device executes an M2M application for performing M2M communication with a physical node, the information processing method comprising
communicating with at least one of a virtual node and a virtual point by the information processing device, wherein
the virtual node is a node in which at least one of a function of the physical node that is a communication partner of the M2M communication and a function of reinforcing the physical node is implemented as a software module, and
the virtual point is a point in which a function of a physical sink that performs wireless communication with the physical node, a function of reinforcing the physical sink, and an installation place of the physical sink are implemented as software modules.
   (2)

The information processing method according to (1), wherein the information processing device is one of a cloud device and an MEC device.

(3)

The information processing method according to (1) or (2), wherein
one of a cloud device and an MEC device functions as the information processing device and executes the M2M application according to an instruction from a management device, and
the management device determines, according to at least one of a calculation load of the M2M application and a communication delay with the physical node that performs the M2M communication, a device that executes the M2M application.
   (4)

The information processing method according to any one of (1) to (3), wherein
the physical node has at least one of a sensor function and an actuator function, and
the M2M application executes, by the M2M communication, at least one of control of the function and acquisition of a measurement result by the function.
   (5)

The information processing method according to any one of (1) to (4), wherein
the physical node is a mobile node, a physical position of which moves, and performs the wireless communication with the physical sink corresponding to the physical position, and
the M2M application communicates with at least one of the virtual node corresponding to the physical node and the virtual point corresponding to the virtual node irrespective of the physical position of the physical node to perform the M2M communication with the physical node.
   (6)

The information processing method according to (5), wherein the mobile node shares a session key with the virtual point corresponding to the physical sink that performs the wireless communication with the mobile node.

(7)

The information processing method according to (5) or (6), wherein
when a wireless link with the mobile node is disconnected, the physical sink that performs the wireless communication with the mobile node notifies disconnection of the wireless link to the virtual point obtained by virtualizing the physical sink, and
the virtual point that receives notification of the disconnection of the wireless link deletes a session key shared with the mobile node.
   (8)

The information processing method according to any one of (5) to (7), wherein the virtual point corresponding to the physical sink that performs the wireless communication with the mobile node notifies the virtual node obtained by virtualizing the mobile node that the virtual point has been connected to the mobile node.

(9)

The information processing method according to any one of (5) to (8), wherein
the mobile node notifies sensing data to the physical sink,
the physical sink notifies the sensing data to the corresponding virtual point,
the virtual point stores the sensing data in a database of an MEC server that operates as the virtual point,
the virtual point notifies the sensing data to the virtual node corresponding to the mobile node, and
the virtual node stores the sensing data in a database of an MEC server that operates as the virtual node.
   (10)

The information processing method according to any one of (1) to (9), wherein, when the M2M application performs the M2M communication with the physical node that satisfies a predetermined condition, at least one of the virtual node obtained by virtualizing the physical node and the virtual point corresponding to the virtual node determines whether the physical node satisfies the predetermined condition.

(11)

The information processing method according to any one of (1) to (10), wherein
the M2M application communicates with the physical node using at least one of an M2M API, a lower API in a lower level than the M2M API, and a device API in a level lower than the lower API,
the lower API is used in at least one of communication between the M2M API and at least one of the virtual node and the virtual point and communication between the virtual node and the virtual point, and
the device API is used in communication between the virtual node and the physical node.
   (12)

An information processing method in which an M2M application and a physical node perform M2M communication, the information processing method comprising:
communicating with a virtual node via a physical sink by the physical node; and
communicating with at least one of a virtual point and the M2M application by the virtual node, wherein
the virtual node is a node in which at least one of a function of the physical node and a function of reinforcing the physical node is implemented as a software module, and
the virtual point is a point in which a function of the physical sink that performs wireless communication with the physical node, a function of reinforcing the physical sink, and an installation place of the physical sink are implemented as software modules.
   (13)

An information processing method in which an M2M application and a physical sink perform M2M communication, the information processing method comprising:
communicating with at least one of a physical node and a virtual point by the physical sink; and
communicating with at least one of a virtual node and the M2M application by the virtual point, wherein
the virtual node is a node in which at least one of a function of the physical node and a function of reinforcing the physical node is implemented as a software module, and
the virtual point is a point in which a function of the physical sink that performs wireless communication with the physical node, a function of reinforcing the physical sink, and an installation place of the physical sink are implemented as software modules.
   (14)

An information processing device that executes an M2M application for performing M2M communication with a physical node,
the information processing device comprising
a control unit that communicates with at least one of a virtual node and a virtual point, wherein
the virtual node is a node in which at least one of a function of the physical node that is a communication partner of the M2M communication and a function of reinforcing the physical node is implemented as a software module, and
the virtual point is a point in which a function of a physical sink that performs wireless communication with the physical node, a function of reinforcing the physical sink, and an installation place of the physical sink are implemented as software modules.
   (15)

The information processing device according to (14), wherein
the physical node is a mobile node, a physical position of which moves, and performs the wireless communication with the physical sink corresponding to the physical position, and
the M2M application communicates with at least one of the virtual node corresponding to the physical node and the virtual point corresponding to the virtual node irrespective of the physical position of the physical node to perform the M2M communication with the physical node.
   (16)

The information processing device according to (15), wherein the mobile node shares a session key with the virtual point corresponding to the physical sink that performs the wireless communication with the mobile node.

(17)

The information processing device according to (15) or (16), wherein
when a wireless link with the mobile node is disconnected, the physical sink that performs the wireless communication with the mobile node notifies disconnection of the wireless link to the virtual point obtained by virtualizing the physical sink, and
the virtual point that receives notification of the disconnection of the wireless link deletes a session key shared with the mobile node.
   (18)

The information processing device according to any one of (15) to (17), wherein the virtual point corresponding to the physical sink that performs the wireless communication with the mobile node notifies the virtual node obtained by virtualizing the mobile node that the virtual point has been connected to the mobile node.

(19)

The information processing device according to any one of (15) to (18), wherein
the mobile node notifies sensing data to the physical sink,
the physical sink notifies the sensing data to the corresponding virtual point,
the virtual point stores the sensing data in a database of an MEC server that operates as the virtual point,
the virtual point notifies the sensing data to the virtual node corresponding to the mobile node, and
the virtual node stores the sensing data in a database of an MEC server that operates as the virtual node.
   (20)

The information processing device according to any one of (14) to (19), wherein, when the M2M application performs the M2M communication with the physical node that satisfies a predetermined condition, at least one of the virtual node obtained by virtualizing the physical node and the virtual point corresponding to the virtual node determines whether the physical node satisfies the predetermined condition.

### REFERENCE SIGNS LIST

10 M2M APPLICATION
20P PHYSICAL SINK
20V VIRTUAL POINT
30 NODE
100 INFORMATION PROCESSING DEVICE
110 COMMUNICATION UNIT
120, 240, 340 STORAGE UNIT
130, 250, 350 CONTROL UNIT
200 COMMUNICATION DEVICE
210, 310 ANTENNA UNIT
220, 320 WIRELESS COMMUNICATION UNIT
230 NETWORK COMMUNICATION UNIT
300 WIRELESS COMMUNICATION DEVICE
330 SENSOR UNIT
350 CONTROL UNIT

1. An information processing method in which an information processing device executes an M2M application for performing M2M communication with a physical node, the information processing method comprising
communicating with at least one of a virtual node and a virtual point by the information processing device, wherein
the virtual node is a node in which at least one of a function of the physical node that is a communication partner of the M2M communication and a function of reinforcing the physical node is implemented as a software module, and
the virtual point is a point in which a function of a physical sink that performs wireless communication with the physical node, a function of reinforcing the physical sink, and an installation place of the physical sink are implemented as software modules.

2. The information processing method according to claim 1, wherein the information processing device is one of a cloud device and an MEC device.

3. The information processing method according to claim 1, wherein
one of a cloud device and an MEC device functions as the information processing device and executes the M2M application according to an instruction from a management device, and
the management device determines, according to at least one of a calculation load of the M2M application and a communication delay with the physical node that performs the M2M communication, a device that executes the M2M application.

4. The information processing method according to claim 1, wherein
the physical node has at least one of a sensor function and an actuator function, and
the M2M application executes, by the M2M communication, at least one of control of the function and acquisition of a measurement result by the function.

5. The information processing method according to claim 1, wherein
the physical node is a mobile node, a physical position of which moves, and performs the wireless communication with the physical sink corresponding to the physical position, and
the M2M application communicates with at least one of the virtual node corresponding to the physical node and the virtual point corresponding to the virtual node irrespective of the physical position of the physical node to perform the M2M communication with the physical node.

6. The information processing method according to claim 5, wherein the mobile node shares a session key with the virtual point corresponding to the physical sink that performs the wireless communication with the mobile node.

7. The information processing method according to claim 5, wherein
when a wireless link with the mobile node is disconnected, the physical sink that performs the wireless communication with the mobile node notifies disconnection of the wireless link to the virtual point obtained by virtualizing the physical sink, and
the virtual point that receives notification of the disconnection of the wireless link deletes a session key shared with the mobile node.

8. The information processing method according to claim 5, wherein the virtual point corresponding to the physical sink that performs the wireless communication with the mobile node notifies the virtual node obtained by virtualizing the mobile node that the virtual point has been connected to the mobile node.

9. The information processing method according to claim 5, wherein
the mobile node notifies sensing data to the physical sink,
the physical sink notifies the sensing data to the corresponding virtual point,
the virtual point stores the sensing data in a database of an MEC server that operates as the virtual point,
the virtual point notifies the sensing data to the virtual node corresponding to the mobile node, and
the virtual node stores the sensing data in a database of an MEC server that operates as the virtual node.

10. The information processing method according to claim 1, wherein, when the M2M application performs the M2M communication with the physical node that satisfies a predetermined condition, at least one of the virtual node obtained by virtualizing the physical node and the virtual point corresponding to the virtual node determines whether the physical node satisfies the predetermined condition.

11. The information processing method according to claim 1, wherein
the M2M application communicates with the physical node using at least one of an M2M API, a lower API in a lower level than the M2M API, and a device API in a level lower than the lower API,
the lower API is used in at least one of communication between the M2M API and at least one of the virtual node and the virtual point and communication between the virtual node and the virtual point, and
the device API is used in communication between the virtual node and the physical node.

12. An information processing method in which an M2M application and a physical node perform M2M communication, the information processing method comprising:
communicating with a virtual node via a physical sink by the physical node; and
communicating with at least one of a virtual point and the M2M application by the virtual node, wherein
the virtual node is a node in which at least one of a function of the physical node and a function of reinforcing the physical node is implemented as a software module, and
the virtual point is a point in which a function of the physical sink that performs wireless communication with the physical node, a function of reinforcing the physical sink, and an installation place of the physical sink are implemented as software modules.

13. An information processing method in which an M2M application and a physical sink perform M2M communication, the information processing method comprising:
communicating with at least one of a physical node and a virtual point by the physical sink; and
communicating with at least one of a virtual node and the M2M application by the virtual point, wherein
the virtual node is a node in which at least one of a function of the physical node and a function of reinforcing the physical node is implemented as a software module, and
the virtual point is a point in which a function of the physical sink that performs wireless communication with the physical node, a function of reinforcing the physical sink, and an installation place of the physical sink are implemented as software modules.

14. An information processing device that executes an M2M application for performing M2M communication with a physical node,
the information processing device comprising
a control unit that communicates with at least one of a virtual node and a virtual point, wherein
the virtual node is a node in which at least one of a function of the physical node that is a communication partner of the M2M communication and a function of reinforcing the physical node is implemented as a software module, and
the virtual point is a point in which a function of a physical sink that performs wireless communication with the physical node, a function of reinforcing the physical sink, and an installation place of the physical sink are implemented as software modules.

15. The information processing device according to claim 14, wherein
the physical node is a mobile node, a physical position of which moves, and performs the wireless communication with the physical sink corresponding to the physical position, and
the M2M application communicates with at least one of the virtual node corresponding to the physical node and the virtual point corresponding to the virtual node irrespective of the physical position of the physical node to perform the M2M communication with the physical node.

16. The information processing device according to claim 15, wherein the mobile node shares a session key with the virtual point corresponding to the physical sink that performs the wireless communication with the mobile node.

17. The information processing device according to claim 15, wherein
when a wireless link with the mobile node is disconnected, the physical sink that performs the wireless communication with the mobile node notifies disconnection of the wireless link to the virtual point obtained by virtualizing the physical sink, and
the virtual point that receives notification of the disconnection of the wireless link deletes a session key shared with the mobile node.

18. The information processing device according to claim 15, wherein the virtual point corresponding to the physical sink that performs the wireless communication with the mobile node notifies the virtual node obtained by virtualizing the mobile node that the virtual point has been connected to the mobile node.

19. The information processing device according to claim 15, wherein
the mobile node notifies sensing data to the physical sink,
the physical sink notifies the sensing data to the corresponding virtual point,
the virtual point stores the sensing data in a database of an MEC server that operates as the virtual point,
the virtual point notifies the sensing data to the virtual node corresponding to the mobile node, and
the virtual node stores the sensing data in a database of an MEC server that operates as the virtual node.

20. The information processing device according to claim 14, wherein, when the M2M application performs the M2M communication with the physical node that satisfies a predetermined condition, at least one of the virtual node obtained by virtualizing the physical node and the virtual point corresponding to the virtual node determines whether the physical node satisfies the predetermined condition.
